(19) United States
(12) Patent Application Publication
(10) Pub. No.: US 2025/0176548 A1
(43) Pub. Date: Jun. 5, 2025

(54) POLYMERIC IMIDAZOLIUM COMPOUNDS FOR ENHANCING THE ACTIVITY OF ANTIMICROBIAL AGENTS

(71) Applicant: BASF SE, Ludwigshafen am Rhein (DE)

(72) Inventors: Menno HAZENKAMP, Grenzach-Wyhlen (DE); Juergen WIETHAN, Grenzach-Wyhlen (DE); Sonja MAYER, Grenzach-Wyhlen (DE)

(73) Assignee: BASF SE, Ludwigshafen am Rhein (DE)

(21) Appl. No.: 18/844,557

(22) PCT Filed: Mar. 8, 2023
(86) PCT No.: PCT/EP2023/055910

§ 371 Date: Sep. 6, 2024

(30) Foreign Application Priority Data
Mar. 9, 2022 (EP) 22161090.0

(51) Int. Cl. A01N 43/50; A01N 25/10; A01N 33/12

(52) U.S. Cl. CPC A01N 43/50; A01N 25/10; A01N 33/12

(57) ABSTRACT

The present invention relates to the use of antimicrobial agents of the formula (I) or (II) wherein the variables are defined in the claims and the description, in combination with polymeric ionic compounds comprising imidazolium groups for combatting microbes, to the use of a polymeric ionic compound comprising imidazolium groups for enhancing the antimicrobial activity of an antimicrobial agent of the formula (I) or (II), and to compositions comprising these compounds.

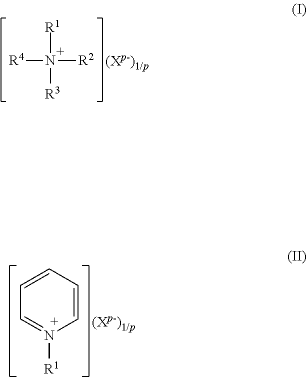

The present invention relates to the use of antimicrobial agents of the formula (I) or (II) as defined below in combination with polymeric ionic compounds comprising imidazolium groups for combatting microbes, to the use of a polymeric ionic compound comprising imidazolium groups for enhancing the antimicrobial activity of an antimicrobial agent of the formula (I) or (II) as defined below, and to compositions comprising these compounds.

Antimicrobial agents are chemicals which are used to prevent or reduce microbiological contamination. They are used, for example, as or in disinfectants or sanitizers for hard or soft surfaces or areas or for the disinfection or cleaning of human or animal skin, mucosa or keratinous body parts on a homecare level as well as in industrial or institutional settings. Examples for products, materials and formulations containing antimicrobial agents are homecare compositions and articles, compositions and articles for cleaning or disinfecting in industrial or institutional settings, clean-in-place products, personal care compositions and articles, cleaning or disinfecting compositions for agricultural set-ups, process water and the like.

However, some established antimicrobial agents have been found to cause health risks. For instance, formaldehyde-releasing antimicrobials have lost acceptance because formaldehyde is classified as carcinogenic, mutagenic and as having reproductive toxicity. Halogenated organic antimicrobials, too, have lost ground because they exhibit a certain level of toxic effects, especially when combined with certain other ingredients.

Antimicrobials which are not or at least less hazardous, like quaternary ammonium salts, are not sufficiently effective under certain circumstances and need to be used in rather high concentrations to achieve an acceptable antimicrobial effect. In many applications, high concentrations are however not acceptable; for instance because of formulation issues or malodour or because beyond a certain concentration these products become hazardous, too. Moreover, under certain circumstances even high concentrations fail to give the desired effect.

Altogether it is desirable to reduce the amount of antimicrobials, since intrinsically all of them pose a certain, albeit small, health or environmental risk (otherwise they wouldn't have an antimicrobial effect), but at the same time the desired antimicrobial effect should not be compromised.

Accordingly, there is a need to improve the effect of antimicrobials, so that they can be applied in low or at least in reasonable concentrations.

WO 2012/127009, WO 2017/025433 A1 and EP 3510867 A1 relate to polymeric compounds comprising imidazolium groups which have antimicrobial properties. It is casually mentioned that the imidazolium polymers can be combined with further antimicrobial agents; an advantageous effect of such a combination, e.g. an over-additive antimicrobial activity, is however neither mentioned nor shown.

### SUMMARY OF THE INVENTION

The object of the present invention is to improve the effect of certain antimicrobials.

Another object is to provide a composition with an improved antimicrobial, specifically disinfecting, effect.

The inventors of the present invention found that imidazolium polymers as defined below improve the antimicrobial effect of certain antimicrobials with quaternary nitrogen atoms and that the combined use of said imidazolium polymers and said antimicrobials has an over-additive effect, thus allowing to reduce the overall concentration of antimicrobials in the target application without compromising the desired antimicrobial effect.

The present invention therefore relates to the use of a polymeric ionic compound comprising imidazolium groups, obtainable by reacting
i) at least one α-dicarbonyl compound;
ii) at least one aldehyde;
iii) at least one amino compound having at least two primary amino groups;
iv) at least one protic acid; and
v) optionally an amino compound having only one primary amino group;
and optionally subjecting the reaction product to an anion exchange;
where in the components i) and ii) the aldehyde carbonyl groups may also be present as hemiacetal or acetal and the ketone carbonyl groups may also be present as hemiketal or ketal;
where the polymeric ionic compound comprises from 4 to 150 imidazolium groups;
for enhancing the antimicrobial activity of an antimicrobial agent of the formula (I) or (II), in particular for over additively or synergistically enhancing the antimicrobial activity of an antimicrobial agent of the formula (I) or (II),

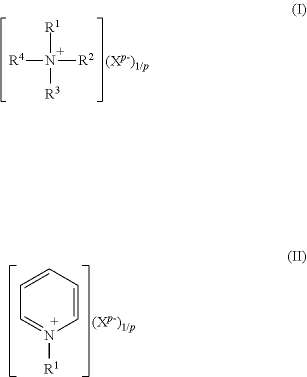

wherein
R¹ is an aliphatic, aromatic or mixed aliphatic-aromatic radical with 6 to 26 carbon atoms, where the radical may be substituted by one or more halogen atoms, where the aliphatic radical and the aliphatic moiety in the mixed aliphatic-aromatic radical may be interrupted by one or more non-adjacent ether groups —O—, ester groups —C(═O)O— and/or amide groups —N(R⁵)—; and/or the aliphatic and the aromatic moiety in the mixed aliphatic-aromatic radical may be bound to each other via an ether group —O—, an ester group —C(═O)O— or an amide group —N(R⁵)—;
R², R³ and R⁴, independently of each other, are C₁-C₄-alkyl or independently have one of the meanings given above for R¹;
R⁵ is hydrogen or C₁-C₄-alkyl; and
X^{p-}is a p-valent anion; and p is 1, 2 or 3.

The invention relates also to the use of a mixture comprising the polymeric ionic compound comprising imidazolium groups and the antimicrobial agent of the formula (I) or (II) as defined above for combatting microbes.

In a specific embodiment, the uses of the invention do not encompass the therapeutic treatment of the human or animal body.

The invention relates furthermore to a method for combatting harmful microorganisms or for protecting or ridding human beings, animals, materials, spaces or processes from the effects of said harmful microorganisms, which method comprises bringing the harmful microorganisms, their habitat or the human being, animal, material, area or space which is to be protected or rid from the harmful microorganisms into contact with a composition comprising at least a polymeric ionic compound comprising imidazolium groups as defined above and at least one an antimicrobial agent of the formula (I) or (II), or employing said composition in said process.

The invention also relates to a method for achieving an antimicrobial effect, especially an antibacterial and/or antifungal effect, on a hard surface, by contacting said surface with a liquid formulation comprising at least a polymeric ionic compound comprising imidazolium groups as defined above and at least one an antimicrobial agent of the formula (I) or (II).

In a specific embodiment, the methods of the invention do not encompass the therapeutic treatment of the human or animal body.

The invention relates moreover to a composition comprising
(a) a polymeric ionic compound comprising imidazolium groups as defined above, where however no amino compound having only one primary amino group is reacted; and
(b) an antimicrobial agent of the formula (I) or (II) as defined above, or a mixture of different compounds (1) and/or (II);
where the overall weight ratio of the polymeric ionic compound comprising imidazolium groups and the antimicrobial agent of the formula (I) or (II) is in the range of from 100:1 to 1:100, preferably from 50:1 to 1:50, more preferably from 1:1 to 1:50, in particular from 1:1 to 1:30, more particularly from 1:2 to 1:20.

### DETAILED DESCRIPTION OF THE INVENTION

### Definitions

An antimicrobial agent or short antimicrobial is an agent that combats or controls microbes. Unless specified otherwise, in terms of the present invention, the expressions “microbicide” and “biocide” are used as synonyms for antimicrobials.

Microbes in the terms of the present invention are undesired harmful microorganisms and comprise bacteria (including mycoplasma), fungi (including yeasts and molds), microscopic algae, protozoans, spores thereof and, despite the fact that they are generally not considered as living beings, also viruses and prions. “Harmful” means that the microorganism have an unwanted presence or a detrimental effect on humans, their activities or the products they use or produce, or on animals, materials, plants or the environment.

An antimicrobial effect encompasses a disinfecting as well as a preservative effect. Preservative or preserving effect in terms of the present invention means that the material or product as such comprising an antimicrobial agent is protected against deterioration by microbial attack. As a consequence, the thusly protected material or product has for example a longer storage stability. Disinfecting effect in terms of the present invention means that the composition comprising an antimicrobial agent exerts its antimicrobial effect on a product or material or area or space or living being treated with and different from this composition. An example of a disinfecting application is a disinfectant or sanitizer composition which exerts its biocidal effect on materials or products treated therewith. The disinfecting effect has to be fast, since microbes on or in the treated materials or products have to be eliminated or reduced within seconds or minutes, whereas the preservative effect is a long-term effect, since it has to prevail throughout the shelf-life of the product, which can be years. Many antimicrobials have both a preservative and a disinfecting effect, the prevalence depending partly on the concentration of the antimicrobial in the composition, but also on the nature of the antimicrobial.

In the present invention, the antimicrobial effect is preferably a disinfecting effect.

In terms of the present invention, the polymeric ionic compound comprising imidazolium groups is also termed short imidazolium polymer.

The organic moieties mentioned below are—like the term halogen—collective terms for individual listings of the individual group members. The prefix COₙ-Cₘ indicates in each case the possible number of carbon atoms in the group.

The term halogen denotes in each case fluorine, bromine, chlorine or iodine, in particular fluorine, chlorine or bromine.

The term “alkyl” as used herein and in the alkyl moieties of alkoxy, alkylsulfonic acid or alkylsulfate refers to saturated straight-chain (linear) or branched hydrocarbon radicals having 1 or 2 (“C₁-C₂-alkyl”), 1 to 4 (“C₁-C₄-alkyl”), 1 to 6 (“C₁-C₆-alkyl”), 1 to 8 (“C₁-C₅-alkyl”), 1 to 10 (“C₁-C₁₀-alkyl”), 1 to 20 (“C₁-C₂₀-alkyl”), 6 to 20 (“C₆-C₂₀-alkyl”), 6 to 26 (“C₆-C₂₆-alkyl”), 8 to 12 (“C₈-C₁₂-alkyl”), 8 to 20 (“C₅-C₂₀-alkyl”) or 10 to 18 (“C₁₀-C₁₃-alkyl”) carbon atoms. C₁-C₂-Alkyl denotes a saturated linear or branched aliphatic radical with 1 or 2 carbon atoms. Examples are methyl and ethyl. C₁-C₄-Alkyl denotes a saturated linear or branched aliphatic radical with 1 to 4 carbon atoms. Examples are methyl, ethyl, n-propyl, isopropyl, n-butyl, sec-butyl, isobutyl and tert-butyl. C₁-C₆-Alkyl denotes a saturated linear or branched aliphatic radical with 1 to 6 carbon atoms. Examples are, in addition to those mentioned for C₁-C₄-alkyl, n-pentyl, 1-methylbutyl, 2-methylbutyl, 3-methylbutyl, 2,2-dimethylpropyl, 1-ethylpropyl, 1,1-dimethylpropyl, 1,2-dimethylpropyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl and 1-ethyl-2-methylpropyl. C₁-C₅-Alkyl denotes a saturated linear or branched aliphatic radical with 1 to 8 carbon atoms. Examples are, in addition to those mentioned for C₁-C₆-alkyl, n-heptyl, structural isomers thereof, n-octyl, 2-ethylhexyl and other structural isomers thereof. C₁-C₁₀-Alkyl denotes a saturated linear or branched aliphatic radical with 1 to 10 carbon atoms. Examples are, in addition to those mentioned for C₁-C₅-alkyl, n-nonyl, n-decyl, 2-propylheptyl and (other) structural isomers thereof. C₁-C₂₀-Alkyl denotes a saturated linear or branched aliphatic radical with 1 to 20 carbon atoms. Examples are, in addition to those mentioned for C₁-C₁₀-alkyl, n-undecyl, n-dodecyl, n-tridecyl, n-tetradecyl, n-pentadecyl, n-hexadecyl, n-heptadecyl, n-octadecyl, n-nonadecyl, n-eicosyl and structural isomers thereof. C₁-C₁₀-Alkyl denotes a saturated linear or branched aliphatic radical with 10 to 18 carbon atoms. Examples are n-decyl, 2-propylheptyl, n-undecyl, n-dodecyl, n-tridecyl, n-tetradecyl, n-pentadecyl, n-hexadecyl, n-heptadecyl, n-octadecyl and (other) structural isomers thereof. C₈-C₁₂-Alkyl denotes a saturated linear or branched aliphatic radical with 8 to 12 carbon atoms. Examples are, n-octyl, 2-ethylhexyl, n-nonyl, n-decyl, 2-propylheptyl, n-undecyl, n-dodecyl and (other) structural isomers thereof. C₅-C₂₀-Alkyl denotes a saturated linear or branched aliphatic radical with 8 to 20 carbon atoms. Examples are, in addition to those mentioned for C₈-C₁₂-alkyl, n-tridecyl, n-tetradecyl, n-pentadecyl, n-hexadecyl, n-heptadecyl, n-octadecyl, n-nonedecyl, eicosyl and structural isomers thereof. C₆-C₂₀-Alkyl denotes a saturated linear or branched aliphatic radical with 6 to 20 carbon atoms. Examples are, in addition to those mentioned for C₈-C₂₀alkyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl and structural isomers thereof. C₆-C₂₆-Alkyl denotes a saturated linear or branched aliphatic radical with 6 to 26 carbon atoms. Examples are, in addition to those mentioned for C₆-C₂₀-alkyl, henicosyl, docosyl, trocosyl, tetracoxyl, pemtacosyl, hexacosyl and structural isomers thereof.

The term “haloalkyl” as used herein (and in the haloalkyl moieties of other groups comprising a haloalkyl group, e.g. haloalkoxy) denotes in each case a straight-chain or branched alkyl group wherein the hydrogen atoms of this group are partially or totally replaced with halogen atoms. C₁-C₄-Haloalkyl is a straight-chain or branched alkyl group having 1 to 4 carbon atoms, as defined above, wherein the hydrogen atoms of this group are partially or totally replaced with halogen atoms. Examples are fluoromethyl, difluoromethyl, trifluoromethyl, chloromethyl, dichloromethyl, trichloromethyl, chlorofluoromethyl, dichlorofluoromethyl, chlorodifluoromethyl, bromomethyl, 1-fluoroethyl, 2-fluoroethyl, 2,2-difluoroethyl, 2,2,2-trifluoroethyl, pentafluoroethyl, 1-chloroethyl, 2-chloroethyl, 2,2,-dichloroethyl, 2,2,2-trichloroethyl, 2-chloro-2-fluoroethyl, 2-chloro-2,2-difluoroethyl, 2,2-dichloro-2-fluoroethyl, 1-bromoethyl, 1-fluoropropyl, 2-fluoropropyl, 3-fluoropropyl, 3,3-difluoropropyl, 3,3,3-trifluoropropyl, heptafluoropropyl, 1,1,1-trifluoroprop-2-yl, 3-chloropropyl, and the like. C₁-C₆-Haloalkyl is a straight-chain or branched alkyl group having 1 to 6 carbon atoms, as defined above, wherein the hydrogen atoms of this group are partially or totally replaced with halogen atoms. C₆-C₂₀-Haloalkyl is a straight-chain or branched alkyl group having 6 to 20 carbon atoms, as defined above, wherein the hydrogen atoms of this group are partially or totally replaced with halogen atoms.

Strictly speaking, the term “alkenyl” indicates monounsaturated (i.e. containing one C—C double bond) straight-chain or branched aliphatic hydrocarbon radicals. In terms of the present invention, the term “alkenyl” however also encompasses polyunsaturated straight-chain or branched aliphatic hydrocarbon radicals having 2 (alkadienyl), 3 (alkatrienyl) or more (alkapolyenyl)C—C double bonds. Examples for C₂-C₂₄-alkenyl in the strict sense (just one C—C double bond) are ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, 1-ethyl-2-methyl-2-propenyl, 1-heptenyl, 2-heptenyl, 3-heptenyl, 4-heptenyl, 5-heptenyl, 6-heptenyl, 1-octenyl, 2-octenyl, 3-octenyl, 4-octenyl, 5-octenyl, 6-octenyl, 7-octenyl, 1-nonenyl, 2-nonenyl, 3-nonenyl, 4-nonenyl, 5-nonenyl, 6-nonenyl, 7-nonenyl, 8-nonenyl, 1-decenyl, 2-decenyl, 3-decenyl, 4-decenyl, 5-decenyl, 6-decenyl, 7-decenyl, 8-decenyl, 9-decenyl, 1-undecenyl, 2-undecenyl, 3-undecenyl, 4-undecenyl, 5-undecenyl, 6-undecenyl, 7-undecenyl, 8-undecenyl, 9-undecenyl, 10-undecenyl, 1-, 2-, 3-, 4-, 5-, 6-, 7-, 8-, 9-, 10- and 11-dodecenyl, 1-, 2-, 3-, 4-, 5-, 6-, 7-, 8-, 9-, 10-, 11- and 12-tridecenyl, 1-, 2-, 3-, 4-, 5-, 6-, 7-, 8-, 9-, 10-, 11-, 12- and 13-tetradecenyl, 1-, 2-, 3-, 4-, 5-, 6-, 7-, 8-, 9-, 10-, 11-, 12-, 13- and 14-pentadecenyl, 1-, 2-, 3-, 4-, 5-, 6-, 7-, 8-, 9-, 10-, 11-, 12-, 13-, 14- and 15-hexadecenyl, 1-, 2-, 3-, 4-, 5-, 6-, 7-, 8-, 9-, 10-, 11-, 12-, 13-, 14-, 15- and 16-heptadecenyl, 1-, 2-, 3-, 4-, 5-, 6-, 7-, 8-, 9-, 10-, 11-, 12-, 13-, 14-, 15-, 16- and 17-octadecenyl, the nonadecenyl, the eicosenyl, the henicosenyls, the docosenyls, the tricosenyls, the tetracosenyls and the structural isomers thereof. Alkadienyls have at least 4 carbon atoms and 2 C—C double bonds. Examples are buta-1,3-dien-1-yl, buta-1,3-dien-2-yl, penta-1,3-dien-1-yl, penta-1,3-dien-2-yl, penta-1,3-dien-3-yl, penta-1,3-dien-4-yl, penta-1,3-dien-5-yl, penta-1,4-dien-1-yl, penta-1,4-dien-2-yl, penta-1,4-dien-3-yl, and the higher homologues with up to 24 carbon atoms. Alkatrienyls have at least 6 carbon atoms and 3 C—C double bonds. Examples are 1,3,5-hexatrien-1-yl, 1,3,5-hexatrien-2-yl, 1,3,5-hexatrien-3-yl, 1,3,5-heptatrien-1-yl, 1,3,5-heptatrien-2-yl, 1,3,5-heptatrien-3-yl, 1,3,5-heptatrien-4-yl, 1,3,5-heptatrien-5-yl, 1,3,5-heptatrien-6-yl, 1,3,5-heptatrien-7-yl, and the higher homologues with up to 24 carbon atoms.

The term “cycloalkyl” as used herein (and in the cycloalkyl moieties of other groups comprising a cycloalkyl group, e.g. cycloalkoxy and thio denotes in each case a mono- or bicyclic, saturated cycloaliphatic radical having usually from 3 to 8 carbon atoms (=C₃-C₅-cycloalkyl), preferably 3 to 6 carbon atoms (=C₃-C₆-cycloalkyl), 3 to 5 carbon atoms (=C₃-C₅-cycloalkyl) or 3 to 4 carbon atoms (=C₃-C₄-cycloalkyl) as (only) ring members. Examples of monocyclic saturated cycloaliphatic radicals having 3 or 4 carbon atoms are cyclopropyl and cyclobutyl. Examples of monocyclic saturated cycloaliphatic radicals having 3 to 5 carbon atoms are cyclopropyl, cyclobutyl and cyclopentyl. Examples of monocyclic saturated cycloaliphatic radicals having 3 to 6 carbon atoms are cyclopropyl, cyclobutyl, cyclopentyl and cyclohexyl. Examples of monocyclic saturated cycloaliphatic radicals having 3 to 8 carbon atoms are cyclopropyl, cyclobutyl, cyclopentyl, cyclohexyl, cycloheptyl and cyclooctyl. Examples of bicyclic radicals having 6 to 8 carbon atoms comprise bicyclo[2.1.1]hexyl, bicyclo[2.2.1]heptyl, bicyclo[3.1.1]heptyl, bicyclo[2.2.1]heptyl, bicyclo[2.2.2]octyl and bicyclo[3.2.1]octyl.

The term “alkoxy” as used herein denotes in each case a straight-chain or branched alkyl group which is bound to the remainder of the molecule via an oxygen atom. C₁-C₂₀-Alkoxy is a straight-chain or branched alkyl group having 1 to 20 carbon atoms, as defined above, which is bound to the remainder of the molecule via an oxygen atom. Examples are methoxy, ethoxy, n-propoxy, 1-methylethoxy (isopropoxy), butoxy, 1-methylpropoxy (sec-butoxy), 2-methylpropoxy (isobutoxy), 1,1-dimethylethoxy (tert-butoxy), pentoxy, 1-methylbutoxy, 2-methylbutoxy, 3-methylbutoxy, 1,1-dimethylpropoxy, 1,2-dimethylpropoxy, 2,2-dimethylpropoxy, 1-ethylpropoxy, hexoxy, 1-methylpentoxy, 2-methylpentoxy, 3-methylpentoxy, 4-methylpentoxy, 1,1-dimethylbutoxy, 1,2-dimethylbutoxy, 1,3-dimethylbutoxy, 2,2-dimethylbutoxy, 2,3-dimethylbutoxy, 3,3-dimethylbutoxy, 1-ethylbutoxy, 2-ethylbutoxy, 1,1,2-trimethylpropoxy, 1,2,2-trimethylpropoxy, 1-ethyl-1-methylpropoxy, 1-ethyl-2-methylpropoxy, n-heptoxy, n-octoxy, 2-ethylhexoxy, n-nonoxy, n-decoxy, 2-propylheptoxy, n-undecoxy, n-dodecoxy, n-tridecoxy, n-tetradecoxy, n-pentadecoxy, n-hexadecoxy, n-heptadecoxy, n-octadecoxy, n-nonadecoxy, n-eicosoxy and (other) structural isomers thereof. C₆-C₂₀-Alkoxy is a straight-chain or branched alkyl group having 6 to 20 carbon atoms, as defined above, which is bound to the remainder of the molecule via an oxygen atom. Examples are hexoxy, 1-methylpentoxy, 2-methylpentoxy, 3-methylpentoxy, 4-methylpentoxy, 1,1-dimethylbutoxy, 1,2-dimethylbutoxy, 1,3-dimethylbutoxy, 2,2-dimethylbutoxy, 2,3-dimethylbutoxy, 3,3-dimethylbutoxy, 1-ethylbutoxy, 2-ethylbutoxy, 1,1,2-trimethylpropoxy, 1,2,2-trimethylpropoxy, 1-ethyl-1-methylpropoxy, 1-ethyl-2-methylpropoxy, n-heptoxy, n-octoxy, 2-ethylhexoxy, n-nonoxy, n-decoxy, 2-propylheptoxy, n-undecoxy, n-dodecoxy, n-tridecoxy, n-tetradecoxy, n-pentadecoxy, n-hexadecoxy, n-heptadecoxy, n-octadecoxy, n-nonadecoxy, n-eicosoxy and (other) structural isomers thereof.

The term “haloalkoxy” as used herein denotes in each case a straight-chain or branched haloalkyl group which is bound to the remainder of the molecule via an oxygen atom. C₁-C₆-Haloalkoxy is a straight-chain or branched haloalkyl group having 1 to 6 carbon atoms, as defined above, which is bound to the remainder of the molecule via an oxygen atom. Examples are OCH₂F, OCHF₂, OCF₃, OCH₂C₁, OCHCl₂, OCCl₃, chlorofluoromethoxy, dichlorofluoromethoxy, chlorodifluoromethoxy, 2-fluoroethoxy, 2-chloroethoxy, 2-bromoethoxy, 2-iodoethoxy, 2,2-difluoroethoxy, 2,2,2-trifluoroethoxy, 2-chloro-2-fluoroethoxy, 2-chloro-2,2-difluoroethoxy, 2,2-dichloro-2-fluoroethoxy, 2,2,2-trichloroethoxy, OC₂F₅, 2-fluoropropoxy, 3-fluoropropoxy, 2,2-difluoropropoxy, 2,3-difluoropropoxy, 2-chloropropoxy, 3-chloropropoxy, 2,3-dichloropropoxy, 2-bromopropoxy, 3-bromopropoxy, 3,3,3-trifluoropropoxy, 3,3,3-trichloropropoxy, OCH₂—C₂F₅, OCF₂—C₂F₅, 1-(CH₂F)-2-fluoroethoxy, 1-(CH₂C₁)-2-chloroethoxy or 1-(CH₂Br)-2-bromoethoxy. C₁-C₆-Haloalkoxy is additionally, for example, 4-fluorobutoxy, 4-chlorobutoxy, 4-bromobutoxy, nonafluorobutoxy, 5-fluoropentoxy, 5-chloropentoxy, 5-brompentoxy, 5-iodopentoxy, undecafluoropentoxy, 6-fluorohexoxy, 6-chlorohexoxy, 6-bromohexoxy, 6-iodohexoxy or dodecafluorohexoxy. C₆-C₂₀-Haloalkoxy is a straight-chain or branched haloalkyl group having 6 to 20 carbon atoms, as defined above, which is bound to the remainder of the molecule via an oxygen atom.

The term “cycloalkoxy” denotes a cycloalkyl group, as defined above, attached via an oxygen atom to the remainder of the molecule. C₃-C₅-Cycloalkoxy is a C₃-C₈ cycloalkyl group, as defined above, attached via an oxygen atom to the remainder of the molecule. Examples are cyclopropoxy, cyclobutoxy, cyclopentoxy, cyclohexoxy, cycloheptoxy and cyclooctoxy.

The term “alkylthio” (also alkylsulfanyl or “alkyl-S”) as used herein denotes in each case a straight-chain or branched alkyl group as defined above which is bound to the remainder of the molecule via a sulfur atom. atom. C₁-C₂₀-Alkylthio is a straight-chain or branched alkyl group having 1 to 20 carbon atoms, as defined above, which is bound to the remainder of the molecule via a sulfur atom. Examples are methylthio, ethylthio, n-propylthio, 1-methylethylthio (isopropylthio), butylthio, 1-methylpropylthio (sec-butylthio), 2-methylpropylthio (isobutylthio), 1,1-dimethylethylthio (tert-butylthio), pentylthio, 1-methylbutylthio, 2-methylbutylthio, 3-methylbutylthio, 1,1-dimethylpropylthio, 1,2-dimethylpropylthio, 2,2-dimethylpropylthio, 1-ethylpropylthio, hexylthio, 1-methylpentylthio, 2-methylpentylthio, 3-methylpentylthio, 4-methylpentylthio, 1,1-dimethylbutylthio, 1,2-dimethylbutylthio, 1,3-dimethylbutylthio, 2,2-dimethylbutylthio, 2,3-dimethylbutylthio, 3,3-dimethylbutylthio, 1-ethylbutylthio, 2-ethylbutylthio, 1,1,2-trimethylpropylthio, 1,2,2-trimethylpropylthio, 1-ethyl-1-methylpropylthio, 1-ethyl-2-methylpropylthio and the higher homologs.

The term “cycloalkylthio” denotes a cycloalkyl group, as defined above, attached via a sulfur atom to the remainder of the molecule. C₃-C₅-Cycloalkylthio is a C₃-C₈-cycloalkyl group, as defined above, attached via a sulfur atom to the remainder of the molecule. Examples are cyclopropylthio, cyclobutylthio, cyclopentylthio, cyclohexylthio, cycloheptylthio and cyclooctylthio.

Alkylene is a linear or branched divalent alkanediyl radical. C₂-C₈-Alkylene is a linear or branched divalent alkyl radical having 2 to 8 carbon atoms. Examples are —CH₂CH₂—, —CH₂CH₂CH₂—, —CH(CH₃)CH₂—, —CH₂CH(CH₃)—, —C(CH₃)₂—, —CH₂CH₂CH₂CH₂—, —CH(CH₃)CH₂CH₂—, —CH₂CH₂CH(CH₃)—, —C(CH₃)₂CH₂—, —CH₂C(CH₃)₂—, —(CH₂)₅—, —(CH₂)₆—, —(CH₂)₇—, —(CH₂)₈—, and positional isomers thereof. Linear C₂-C₈-alkylene is —CH₂CH₂—, —CH₂CH₂CH₂—, —CH₂CH₂CH₂CH₂—, —(CH₂)₅—, —(CH₂)₆—, —(CH₂)₇— or —(CH₂)₈—.

Aryl denotes a carboaromatic ring (system). Examples for C₆-C₁₀-aryl are phenyl and naphthyl.

Aryloxy denotes a carboaromatic ring (system) attached via an oxygen atom to the remainder of the molecule. Examples for C₆-C₁₀-aryloxy are phenoxy and naphthyloxy.

Arylthio denotes a carboaromatic ring (system) attached via a sulfur atom to the remainder of the molecule. Examples for C₆-C₁₀-arylthio are phenylthio and naphthylthio.

Tolyl is a phenyl ring substituted by a methyl group and bound to the remainder of the molecule via a carbon atom of the phenyl ring.

Phenyl-C₁-C₄-alkyl is a C₁-C₄-alkyl group, as defined above, in which one hydrogen atom is replaced by a phenyl ring (phenyl-C₁-C₄-alkyl is thus bound to the remainder of the molecule via a carbon atom of the alkyl group). Examples are benzyl, 1-phenylethyl, 2-phenylethyl, 1-phenylpropyl, 2-phenylpropyl, 3-phenylpropyl, 2-phenyl-2-propyl and the like.

Alkanol is an alkyl group in which one hydrogen atom is replaced by a hydroxyl group. C₁-C₁₀-Alkanol is a C₁-C₁₀-alkyl group in which one hydrogen atom is replaced by a hydroxyl group. Examples are methanol, ethanol, n-propanol, isopropanol, n-butanol, sec-butanol, isobutanol, tert-butanol, 1-pentanol, 1-hexanol, 1-heptanol, 1-octanol, 2-ethylhexan-1-ol, 1-nonanol, 1-decanol, 2-propylheptan-1-ol and (other) structural isomers thereof. C₂-C₃-Alkanol is ethanol, n-propanol or isopropanol.

Unless specified otherwise, where the amounts or concentrations of components are given as “ppm”, this corresponds to 1 g of component per 1,000,000 g of reference substance or composition (or 1 mg/kg). Alternatively expressed, 1 ppm corresponds to 0.0001% by weight (104% by weight), relative to the total weight of the reference substance or composition. Generally, the total weight of the respective composition is the reference. If the unit “ppm” is used to define the concentration of a component in water, given the density of water as close to 1 g/l, 1 ppm can also be understood as 1 g of the component per 1 m³ of water (or 1 mg/I).

### Embodiments (E.x) of the Invention

General and preferred embodiments E.x are summarized in the following, nonexhaustive list. Further preferred embodiments become apparent from the paragraphs following this list.
E.1. The use of a polymeric ionic compound comprising imidazolium groups, obtainable by reacting
   i) at least one α-dicarbonyl compound;
   ii) at least one aldehyde;
   iii) at least one amino compound having at least two primary amino groups;
   iv) at least one protic acid; and
   v) optionally an amino compound having only one primary amino group;
   and optionally subjecting the reaction product to an anion exchange;
   where in the components i) and ii) the aldehyde carbonyl groups may also be present as hemiacetal or acetal and the ketone carbonyl groups may also be present as hemiketal or ketal;
   where the polymeric ionic compound comprises from 4 to 150 imidazolium groups;
   for enhancing the antimicrobial activity of an antimicrobial agent of the formula (I) or (II)

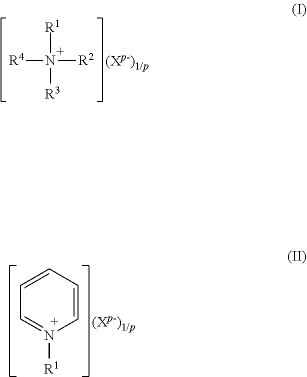

wherein
R¹ is an aliphatic, aromatic or mixed aliphatic-aromatic radical with 6 to 26 carbon atoms, where the radical may be substituted by one or more halogen atoms, where the aliphatic radical and the aliphatic moiety in the mixed aliphatic-aromatic radical may be interrupted by one or more non-adjacent ether groups —O—, ester groups —C(═O)O— and/or amide groups —N(R⁵)—; and/or the aliphatic and the aromatic moiety in the mixed aliphatic-aromatic radical may be bound to each other via an ether group —O—, an ester group —C(═O)O— or an amide group —N(R⁵)—;
R², R³ and R⁴, independently of each other, are C₁-C₄-alkyl or independently have one of the meanings given above for R¹;
R⁵ is hydrogen or C₁-C₄-alkyl; and
X^{p-}is a p-valent anion; and
p is 1, 2 or 3.
E.2. The use according to embodiment E.1, for enhancing the disinfecting activity of the antimicrobial agent.
E.3. The use of a mixture comprising the polymeric ionic compound comprising imidazolium groups and the antimicrobial agent of the formula (I) or (II) as defined in embodiment E.1 for combatting microbes.
E.4. The use according to embodiment E.3, as a disinfectant.
E.5. The use according to any of the preceding embodiments, where the polymeric ionic compound comprising imidazolium groups and the antimicrobial agent of the formula (I) or (II) are used in synergistically effective amounts.
E.6. The use according to any of the preceding embodiments, where for obtaining the polymeric ionic compound comprising imidazolium groups, no amino compound having only one primary amino group is reacted (i.e. component (v) is not reacted) (nor is the polymer formed by the reaction of components i) to iv) subjected to any other reaction which would lead to end-capped polymers, such as the reaction with an alkylating agent).
E.7. The use according to any of the preceding embodiments, where the polymeric ionic compound comprising imidazolium groups is obtainable by reacting
   i) glyoxal or a hemiacetal or acetal thereof;
   ii) formaldehyde (or a formaldehyde source);
   iii) an aliphatic diamine of the formula H₂N-A-NH₂, wherein A is C₂-C₈-alkylene; and
   iv) at least one protic acid;
   and optionally subjecting the reaction product to an anion exchange.
E.8. The use according to any of the preceding embodiments, where the protic acid is selected from the group consisting of R—C(═O)OH, where R is hydrogen, C₁-C₁₀-alkyl or C₁-C₄-haloalkyl; sulfuric acid; hydrogensulfate salts; C₁-C₄-alkylsulfuric acid; nitric acid; phosphoric acid; dihydrogenphosphate salts; R—S(═O)₂OH, where R is C₁-C₅-alkyl, C₁-C₄-haloalkyl, phenyl or tolyl; HCl; HBr and HI.
E.9. The use according to embodiment E.8, where the protic acid is R—C(═O)OH.
E.10. The use according to embodiment E.9, where R is C₁-C₁₀-alkyl.
E.11. The use according to embodiment E.10, where R is C₁-C₄-alkyl.
E.12. The use according to embodiment E.11, where the protic acid is acetic acid (i.e. R is methyl).
E.13. The use according to any of embodiments E.7 to E.12, where the polymeric ionic compound comprising imidazolium groups is of the formula (III)

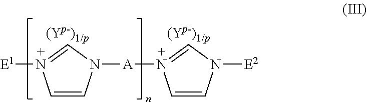

wherein
A is C₂-C₈-alkylene;
E¹ is -A-NH₂ or -A-N H₃⁺(Y^{p-})_{1/p};
E² is hydrogen, -A-NH₂ or -A-NH₃⁺(Y^{p-})₁p;
Y^{p-}is a p-valent anion;
n is from 5 to 100; and
p is 1, 2 or 3.
E.14. The use according to embodiment E.13, where n is from 10 to 75.
E.15. The use according to embodiment E.14, where n is from 15 to 60.
E.16. The use according to any of embodiments E.7 to E.15, where A is —(CH₂)ₘ-, where m is 2 to 8.
E.17. The use according to embodiment E.16, where m is 4 to 8.
E.18. The use according to embodiment E.17, where m is 6.
E.19. The use according to any of embodiments E.13 to E.18, where Y^{p-}is selected from the group consisting of R—C(═O)O—, where R is hydrogen, C₁-C₁₀-alkyl or C₁-C₄-haloalkyl; hydrogensulfate; sulfate, C₁-C₄-alkylsulfate; nitrate; dihydrogenphosphate; hydrogenphosphate, phosphate; R—S(═O)₂O—, where R is C₁-C₈-alkyl, C₁-C₄-haloalkyl, phenyl or tolyl; Cl⁻; Br⁻ and I⁻.
E.20. The use according to embodiment E.19, where Y^{p-}is R—C(═O)O—.
E.21. The use according to embodiment E.20, where R is C₁-C₁₀-alkyl.
E.22. The use according to embodiment E.21, where R is C₁-C₄-alkyl.
E.23. The use according to embodiment E.22, where Y^{p-}is acetate (i.e. R is methyl).
E.24. The use according to any of the preceding embodiments, where the imidazolium polymers have a weight average molecular weight M_{w} of from 2,000 to 200,000.
E.25. The use according to embodiment E.24, where the imidazolium polymers have a weight average molecular weight M_{w} of from 10,000 to 100,000.
E.26. The use according to embodiment E.25, where the imidazolium polymers have a weight average molecular weight M_{w} of from 10,000 to 80,000 g/mol.
E.27. The use according to embodiment E.26, where the imidazolium polymers have a weight average molecular weight M_{w} of from 20,000 to 80,000.
E.28. The use according to embodiment E.27, where the imidazolium polymers have a weight average molecular weight M_{w} of from 20,000 to 60,000 g/mol, preferably from 30,000 to 50,000 g/mol.
E.29. The use according to any of the preceding embodiments, where the imidazolium polymers have a number average molecular weight Mₙ of from 300 to 100,000.
E.30. The use according to embodiment E.29, where the imidazolium polymers have a number average molecular weight Mₙ of from 1,000 to 50,000.
E.31. The use according to embodiment E.30, where the imidazolium polymers have a number average molecular weight Mₙ of from 1,000 to 20,000.
E.32. The use according to embodiment E.31, where the imidazolium polymers have a number average molecular weight Mₙ of from 1,000 to 10,000.
E.33. The use according to embodiment E.32, where the imidazolium polymers have a number average molecular weight Mₙ of from 2,000 to 8,000 g/mol, preferably from 4,000 to 7,000 g/mol.
E.34. The use according to any of the preceding embodiments, where the imidazolium polymers have a polydispersity M_{w}/Mₙ of from 1.5 to 25, preferably from 2 to 15, in particular from 2 to 10, specifically from 5 to 10.
E.35. The use according to any of the preceding embodiments, where the cation portion of the compound of the formula (I) or (II) has a molecular weight of at least 165.
E.36. The use according to any of the preceding embodiments, where in compounds (1) and (II)
   R¹ is C₆-C₂₆-alkyl, phenyl-C₁-C₄-alkyl, phenyl substituted with a C₆-C₂₀-alkyl, C₆-C₂₀-haloalkyl, C₆-C₂₀-alkoxy or C₆-C₂₀-haloalkoxy group; benzyl substituted with a C₆-C₂₀-alkyl, C₆-C₂₀-haloalkyl, C₆-C₂₀-alkoxy or C₆-C₂₀-haloalkoxy group; octyl-phenyl-O—CH₂CH₂—O—CH₂CH₂—; and C₁₁H₂₃—C(═O)—O—CH₂CH₂—NH—C(═O)—CH₂—;
   R² has independently one of the meanings given above for R¹;
   R³ and R⁴, independently of each other, are C₁-C₄-alkyl; and
   X^{p-}is a halide, sulfate or methosulfate anion.
E.37. The use according to any of the preceding embodiments, where the antimicrobial agent is a compound of the formula (I).
E.38. The use according to any of embodiments E.36 and E.37, where the antimicrobial agent is a compound of the formula (I), wherein
   R¹ is C₅-C₂₀-alkyl or octyl-phenyl-O—CH₂CH₂—O—CH₂CH₂—;
   R² is benzyl;
   R³ and R⁴ are methyl; and
   X^{p-}is a halide anion.
E.39. The use according to embodiment E.38, where R¹ is C₅-C₂₀-alkyl; and X^{p-}is chloride.
E.40. The use according to embodiment E.39, where R¹ is C₁₀-C₁₃-alkyl; e.g. C₁₀-C₁₄-alkyl.
E.41. The use according to any of embodiments E.36 and E.37, where the antimicrobial agent is a compound of the formula (I), wherein
   R¹ and R², independently of each other, are C₅-C₂₀-alkyl;
   R³ and R⁴ are methyl; and
   X^{p-}is a halide anion.
E.42. The use according to embodiment E.41, where R¹ and R², independently of each other, are C₈-C₁₂-alkyl; and X^{p-}is chloride.
E.43. The use according to any of the preceding embodiments, where the polymeric ionic compound comprising imidazolium groups and the antimicrobial agent of the formula (I) or (II) are used in an overall weight ratio of from 100:1 to 1:100.
E.44. The use according to embodiment E.43, where the polymeric ionic compound comprising imidazolium groups and the antimicrobial agent of the formula (I) or (II) are used in an overall weight ratio of from 1:1 to 1:100.
E.45. The use according to embodiment E.43, where the polymeric ionic compound comprising imidazolium groups and the antimicrobial agent of the formula (I) or (II) are used in an overall weight ratio of from 50:1 to 1:50.
E.46. The use according to embodiment E.45, where the polymeric ionic compound comprising imidazolium groups and the antimicrobial agent of the formula (I) or (II) are used in an overall weight ratio of from 1:1 to 1:50.
E.47. The use according to embodiment E.46, where the polymeric ionic compound comprising imidazolium groups and the antimicrobial agent of the formula (I) or (II) are used in an overall weight ratio of from 1:2 to 1:50
E.48. The use according to embodiment E.46, where the polymeric ionic compound comprising imidazolium groups and the antimicrobial agent of the formula (I) or (II) are used in an overall weight ratio of from 1:1 to 1:30.
E.49. The use according to embodiment E.48, where the polymeric ionic compound comprising imidazolium groups and the antimicrobial agent of the formula (I) or (II) are used in an overall weight ratio of from 1:2 to 1:30.
E.50. The use according to embodiment E.49, where the polymeric ionic compound comprising imidazolium groups and the antimicrobial agent of the formula (I) or (II) are used in an overall weight ratio of from 1:2 to 1:20.
E.51. The use according to embodiment E.50, where the polymeric ionic compound comprising imidazolium groups and the antimicrobial agent of the formula (I) or (II) are used in an overall weight ratio of from 1:3 to 1:20.
E.52. The use according to any of embodiments E.1, E.2 and E.5 to E. 51, of a polymeric ionic compound comprising imidazolium groups as defined in any of embodiments E.7 to E.34, for enhancing the antimicrobial, preferably the disinfecting, activity of an antimicrobial agent of the formula (I) wherein R¹ is C₁₀-C₁₃-alkyl, R² is benzyl, R³ and R⁴ are methyl, and X^{p-}is chloride; or R¹ and R², independently of each other, are C₈-C₁₂-alkyl, R³ and R⁴ are methyl, and X^{p-}is a halide anion, preferably chloride.
E.53. The use according to any of the preceding embodiments, where
   the polymeric ionic compound comprising imidazolium groups is as defined in any of embodiments E.7 to E.34;
   the antimicrobial agent is a compound of the formula (I), wherein R¹ is C₁₀-C₁₃-alkyl, R² is benzyl, R³ and R⁴ are methyl, and X^{p-}is chloride; or R¹ and R², independently of each other, are C₈-C₁₂-alkyl, R³ and R⁴ are methyl, and X^{p-}is a halide anion, preferably chloride; and
   the polymeric ionic compound comprising imidazolium groups and the antimicrobial agent of the formula (I) are used in an overall weight ratio of from 1:1 to 1:30, preferably from 1:2 to 1:20.
E.54. The use according to any of embodiments E.52 or E.53, where the polymeric ionic compound comprising imidazolium groups is of the formula (III) as defined in embodiment E.13, wherein A is —(CH₂)ₘ—, where m is 4 to 8, and specifically 6; E¹ is -A-N H₂ or -A-NH₃⁺(Y^{p-})_{1/p}, E² is hydrogen, -A-N H₂ or -A-NH₃⁺(Y^{p-})_{1/p}; Y^{p-} is a p-valent anion, where p is 1, 2 or 3, and is preferably acetate; and n is from 15 to 60.
E.55. The use according to any of embodiments E.1, E.2 and E.5 to E.54, for enhancing the bactericidal activity of the compounds of the formula (I) or (II), preferably for enhancing the bactericidal activity of the compounds of the formula (I) or (II) against Escherichia coli or Salmonella enterica.
E.56. The use according to any of embodiments E.3 to E.54, for combatting bacteria, preferably Escherichia coli or Salmonella enterica.
E.57. The use according to any of the preceding embodiments, in a composition selected from the group consisting of dilutable concentrates or ready-to-use compositions for disinfecting or sanitizing hard or soft surfaces, spaces, areas, process water, human or animal skin or keratinous material, or the oral cavity of humans or animals.
E.58. The use according to embodiment E.57, where the composition is selected from the group consisting of homecare compositions, compositions for cleaning or disinfecting in industrial or institutional settings or areas, including agricultural environments; compositions for cleaning or disinfecting animals, and personal care compositions.
E.59. Composition comprising
   (a) a polymeric ionic compound comprising imidazolium groups as defined in any of embodiments E.1 and E.6 to E.34, where however no amino compound having only one primary amino group is reacted (where the polymeric ionic compound is not end-capped by any means); and
   (b) an antimicrobial agent of the formula (I) or (II) as defined in any of embodiments E.1 and E.35 to E.42, or a mixture of different compounds (1) and/or (II);
   where the overall weight ratio of the polymeric ionic compound comprising imidazolium groups and the antimicrobial agent of the formula (I) or (II) is in the range of from 100:1 to 1:100.
E.60. The composition according to embodiment E.59, where the overall weight ratio of the polymeric ionic compound comprising imidazolium groups and the antimicrobial agent of the formula (I) or (II) is in the range of from 1:1 to 1:100.
E.61. The composition according to embodiment E.59, where the overall weight ratio of the polymeric ionic compound comprising imidazolium groups and the antimicrobial agent of the formula (I) or (II) is in the range of from 50:1 to 1:50.
E.62. The composition according to embodiment E.61, where the overall weight ratio of the polymeric ionic compound comprising imidazolium groups and the antimicrobial agent of the formula (I) or (II) is in the range of from 1:1 to 1:50.
E.63. The composition according to embodiment E.62, where the overall weight ratio of the polymeric ionic compound comprising imidazolium groups and the antimicrobial agent of the formula (I) or (II) is in the range of from 1:2 to 1:50.
E.64. The composition according to embodiment E.62, where the overall weight ratio of the polymeric ionic compound comprising imidazolium groups and the antimicrobial agent of the formula (I) or (II) is in the range of from 1:1 to 1:30.
E.65. The composition according to embodiment E.64, where the overall weight ratio of the polymeric ionic compound comprising imidazolium groups and the antimicrobial agent of the formula (I) or (II) is in the range of from 1:2 to 1:30.
E.66. The composition according to embodiment E.65, where the overall weight ratio of the polymeric ionic compound comprising imidazolium groups and the antimicrobial agent of the formula (I) or (II) is in the range of from 1:2 to 1:20.
E.67. The composition according to embodiment E.66, where the overall weight ratio of the polymeric ionic compound comprising imidazolium groups and the antimicrobial agent of the formula (I) or (II) is in the range of from 1:3 to 1:20.
E.68. The composition according to any of embodiment E.59 to E.67, where the polymeric ionic compound comprising imidazolium groups and the antimicrobial agent of the formula (I) or (II) are contained in synergistically effective amounts.
E.69. The composition according to any of embodiments E.59 to E.68, comprising
   (a) as polymeric ionic compound comprising imidazolium groups a polymeric ionic compound comprising imidazolium groups as defined in embodiments E.7 to E.34;
   (b) as antimicrobial agent of the formula (I) or (II) an antimicrobial agent of the formula (I), wherein R¹ is C₁₀-C₁₃-alkyl, R² is benzyl, R³ and R⁴ are methyl, and X^{p-}is chloride; or R¹ and R², independently of each other, are C₈-C₁₂-alkyl, R³ and R⁴ are methyl, and X^{p-}is a halide anion, preferably chloride;
   where the polymeric ionic compound comprising imidazolium groups and the antimicrobial agent of the formula (I) are present in an overall weight ratio of from 1:1 to 1:30, preferably from 1:2 to 1:20.
E.70. The composition according to embodiment E.69, where the polymeric ionic compound comprising imidazolium groups is of the formula (III) as defined in embodiment E.13, wherein A is —(CH₂)ₘ—, where m is 4 to 8, and specifically 6; E¹ is -AN-H₂ or -A-NH₃⁺(Y^{p-})_{1/p}, E² is hydrogen, -A-NH₂ or -A-NH₃⁺(Y^{p-})_{1/p}; Y^{p-} is a p-valent anion, where p is 1, 2 or 3, and is preferably acetate; and n is from 15 to 60.
E.71. The composition according to any of embodiment E.59 to E.70, which is selected from the group consisting of dilutable concentrates or ready-to-use compositions for disinfecting or sanitizing hard or soft surfaces, spaces, areas, process water, human or animal skin or keratinous material, or the oral cavity of humans or animals.
E.72. The composition according to embodiment E.71, where the composition is selected from the group consisting of homecare compositions, compositions for cleaning or disinfecting in industrial or institutional settings or areas, including agricultural environments; compositions for cleaning or disinfecting animals, and personal care compositions.
E.73. The composition according to any embodiments E.59 to E.72, comprising
   (a) 0.0001 to 90% by weight, relative to the total weight of the composition, of the polymeric ionic compound comprising imidazolium groups;
   (b) 0.0001 to 90% by weight, relative to the total weight of the composition, of the antimicrobial agent;
   (c) 0 to 60% by weight, relative to the total weight of the composition, of one or more surfactants;
   (d) 0 to 99.9998% by weight, relative to the total weight of the composition, of at least one C₂-C₃-alkanol;
   (e) 0 to 20% by weight, relative to the total weight of the composition, of at least one organic solvent different from component (d);
   (f) 0 to 20% by weight, relative to the total weight of the composition, of at least one sequestrant;
   (g) 0 to 50% by weight, relative to the total weight of the composition, of one or more further additives; and
   (h) 0 to 99.9998% by weight, relative to the total weight of the composition, of water;
   where components (a) to (h) add to 100% by weight; where at least one of components (c) to (h) is comprised.
E.74. The composition according to embodiment E.73, which is a disinfectant or sanitizer concentrate, comprising
   (a) 0.01 to 80% by weight, relative to the total weight of the composition, of the polymeric ionic compound comprising imidazolium groups;
   (b) 0.1 to 80% by weight, relative to the total weight of the composition, of the antimicrobial agent;
   (c) 0 to 20% by weight, relative to the total weight of the composition, of one or more surfactants;
   (d) 0 to 20% by weight, relative to the total weight of the composition, of one or more C₂-C₃-alkanols;
   (e) 0 to 20% by weight, relative to the total weight of the composition, of at least one organic solvent different from component (d);
   (f) 0 to 20% by weight, relative to the total weight of the composition, of at least one sequestrant;
   (g) 0 to 20% by weight, relative to the total weight of the composition, of at least one further additive; and
   (h) 10 to 99.89% by weight, relative to the total weight of the composition, of water;
   where components (a) to (h) add to 100% by weight.
E.75. The composition according to embodiment E.73, which is a disinfectant or sanitizer ready-to-use composition, comprising
   (a) 0.0001 to 7% by weight, relative to the total weight of the composition, of the polymeric ionic compound comprising imidazolium groups;
   (b) 0.0001 to 7% by weight, relative to the total weight of the composition, of the antimicrobial agent;
   (c) 0 to 20% by weight, relative to the total weight of the composition, of one or more surfactants;
   (d) 0 to 60% by weight, relative to the total weight of the composition, of at least one C₂-C₃-alkanol;
   (e) 0 to 10% by weight, relative to the total weight of the composition, of at least one organic solvent different from component (d);
   (f) 0 to 10% by weight, relative to the total weight of the composition, of at least one sequestrant;
   (g) 0 to 10% by weight, relative to the total weight of the composition, of a further additive; and
   (h) 9.9998 to 99.9998% by weight, relative to the total weight of the composition, of water;
   where components (a) to (h) add to 100% by weight.
E.76. The composition according to any of embodiments E.59 to E.73 and E.75, comprising the polymeric ionic compound comprising imidazolium groups in an amount of 0.0001 to 0.002% by weight (1 to 20 ppm), relative to the total weight of the composition, and the antimicrobial agent of the formula (I) or (II) in an amount of 0.0005 to 0.05% by weight (5 to 500 ppm), relative to the total weight of the composition.
E.77. The composition according to embodiment E.76, comprising the polymeric ionic compound comprising imidazolium groups in an amount of 0.0001 to 0.001% by weight (1 to 10 ppm), relative to the total weight of the composition, and the antimicrobial agent of the formula (I) or (II) in an amount of 0.0005 to 0.008% by weight (5 to 80 ppm), relative to the total weight of the composition.
E.78. The composition according to any of embodiments E.59 to E.73 and E.75 to E.77, comprising
   (a) 0.0001 to 0.001% by weight (1 to 10 ppm), relative to the total weight of the composition, of a polymeric ionic compound comprising imidazolium groups is as defined in embodiments E.7 to E.34;
   (b) 0.0005 to 0.008% by weight (5 to 80 ppm), relative to the total weight of the composition, of an antimicrobial agent of the formula (I), wherein R¹ is C₁₀-C₁₃-alkyl, R² is benzyl, R³ and R⁴ are methyl, and X^{p-}is chloride; or R¹ and R², independently of each other, are C₈-C₁₂-alkyl, R³ and R⁴ are methyl, and X^{p-}is a halide anion, preferably chloride;
   where the polymeric ionic compound comprising imidazolium groups and the antimicrobial agent of the formula (I) are used in an overall weight ratio of from 1:1 to 1:30, preferably from 1:2 to 1:20.
E.79. The composition according to embodiment E.78, comprising
   (a) 0.0001 to 0.001% by weight (1 to 10 ppm), relative to the total weight of the composition, of a polymeric ionic compound of the formula (III) as defined in embodiment E.13, wherein A is —(CH₂)ₘ—, where m is 4 to 8, and specifically 6; E¹ is -A-NH₂ or -A-NH₃⁺(Y^{p-})_{1/p}, E² is hydrogen, -A-NH₂ or -A-NH₃⁺(Y^{p-})_{1/p}; Y^{p-}is a p-valent anion; p is 1, 2 or 3; and n is from 15 to 60;
   (b) 0.0005 to 0.008% by weight (5 to 80 ppm), relative to the total weight of the composition, of an antimicrobial agent of the formula (I), wherein R¹ is C₁₀-C₁₃-alkyl, R² is benzyl, R³ and R⁴ are methyl, and X^{p-}is chloride; or R¹ and R², independently of each other, are C₈-C₁₂-alkyl, R³ and R⁴ are methyl, and X^{p-}is a halide anion, preferably chloride;
   where the polymeric ionic compound comprising imidazolium groups and the antimicrobial agent of the formula (I) are used in an overall weight ratio of from 1:1 to 1:30, preferably from 1:2 to 1:20.
E.80. The composition according to embodiment E.79, comprising
   (a) 0.0001 to 0.001% by weight (1 to 10 ppm), relative to the total weight of the composition, of a polymeric ionic compound of the formula (III) as defined in embodiment E.13, wherein A is —(CH₂)ₘ—, where m is 4 to 8, and specifically 6; E¹ is -A-NH₂ or -A-NH₃⁺(Y^{p-})_{1/p}, E² is hydrogen, -A-NH₂ or -A-NH₃⁺(Y^{p-})_{1/p}; Y^{p-}is acetate; and n is from 15 to 60;
   (b) 0.0005 to 0.008% by weight (5 to 80 ppm), relative to the total weight of the composition, of an antimicrobial agent of the formula (I) as defined in claim 1, wherein R¹ is C₁₀-C₁₃-alkyl, R² is benzyl, R³ and R⁴ are methyl, and X^{p-}is chloride; or R¹ and R², independently of each other, are C₈-C₁₂-alkyl, R³ and R⁴ are methyl, and X^{p-}is chloride;
   where the polymeric ionic compound comprising imidazolium groups and the antimicrobial agent of the formula (I) are used in an overall weight ratio of from 1:2 to 1:20.

Unless specified otherwise, the remarks to suitable and preferred imidazolium polymers, antimicrobial agents (I) and (II), weight ratios in which these are used and compositions in which these are used apply both to the uses and methods of the invention as well as to the composition of the invention.

The polymeric ionic compound comprising imidazolium groups (in the following also termed imidazolium polymer) is obtainable by reacting at least one α-dicarbonyl compound, at least one aldehyde, at least one amino compound having at least two primary amino groups and at least one protic acid. If end-capped imidazolium polymers are desired, to be more precise imidazolium polymer terminated with hydrocarbon groups, e.g. alkyl groups, also an amino compound having only one primary amino group (component v) is reacted. Preferably however, the imidazolium polymers are not end-capped, and thus no component v) is reacted.

### i) α-Dicarbonyl Compound

The α-dicarbonyl compound is preferably selected from compounds of the formula

R^{a}—CO—CO—R^{b}
wherein
R^{a} and R^{b}, independently of each other, are selected from the group consisting of hydrogen, C₁-C₂₀-alkyl, C₁-C₂₀-alkoxy, C₁-C₂₀-alkylthio, C₃-C₅-cycloalkyl, C₃-C₈-cycloalkoxy, C₃-C₅-cycloalkylthio, C₆-C₁₀-aryl, C₆-C₁₀-aryloxy and C₆-C₁₀-arylthio. Preferably, R^{a} and R^{b} are independently selected from hydrogen, C₁-C₂₀-alkyl, C₃-C₈-cycloalkyl and C₆-C₁₀-aryl. More preferably, the α-dicarbonyl compound is glyoxal (i.e. R^{a} and R^{b} are hydrogen).

The aldehyde or keto group of the compound i) can also be present as hemiacetal, acetal, hemiketal or ketal, preferably of a lower alcohol, in particular a C₁-C₁₀-alkanol.

In this case, the alcohol is eliminated in the condensation reaction forming the imidazolium compound.

Preferably, the compound i) is not employed in form of a hemiacetal, acetal, hemiketal or ketal.

### ii) Aldehyde

The aldehyde ii) is preferably selected from compounds of the formula

R^{c}—CHO
wherein
R^{c} is selected from the group consisting of hydrogen, C₁-C₂₀-alkyl, C₃-C₈-cycloalkyl, optionally substituted C₆-C₁₀-aryl and a radical of the formula —CH₂—{O—CH₂CH₂}ₓ—OR^{d}, wherein x is 1, 2, 3, 4, 5 or 6 and R^{d} is hydrogen or C₁-C₄-alkyl, and is more preferably selected from hydrogen, C₁-C₂₀-alkyl, a group —CH₂—[O—CH₂CH₂]ₓ—OR^{d}, wherein x is 1, 2, 3, 4, 5 or 6 and R^{d} is hydrogen or C₁-C₄-alkyl and phenyl which may be substituted by 1, 2, 3, 4 or 5 radicals selected from C₁-C₂₀-alkyl, C₁-C₆-haloalkyl, C₁-C₂₀-alkoxy, C₁-C₆-haloalkoxy and NR′R″, where R′ and R″ are, independently of each other, selected from hydrogen and C₁-C₆-alkyl.

Suitable aldehydes are e.g. formaldehyde, acetaldehyde, propionaldehyde, butanal, pentanal, hexanal, heptanal, octanal, nonanal, decanal, undecanal, dodecanal, tridecanal, tetradecanal and the higher homologs with up to 20 carbon atoms, benzaldehyde, substituted benzaldehydes, such as 2-, 3- or 4-methylbenzaldehyde, 2-, 3- or 4-trifluoromethylbenzaldehyde or 2-, 3- or 4-methoxybenzaldehyde, and aldehydes of formula CH(═O)—CH₂—[O—CH₂CH₂]ₓ—OR^{d}, wherein x is 1, 2, 3, 4, 5 or 6 and R^{d} is hydrogen or C₁-C₄-alkyl, derived from a polyethylene glycol or polythyleneglycol monoether of formula HOCH₂CH₂—[O—CH₂CH₂]ₓ—OR^{d}, wherein x is 1, 2, 3, 4, 5 or 6 and R^{d} is hydrogen or C₁-C₄-alkyl, in which one CH₂OH group in oxidized to a CHO group.

The aldehyde group of the aldehyde ii) can also be present as hemiacetal or acetal, preferably as hemiacetal or acetal of a lower alcohol, in particular a C₁-C₁₀-alkanol. In this case, the alcohol is eliminated in the condensation reaction forming the imidazolium compound.

The aldehyde group is preferably not present as hemiacetal or acetal.

Preferably, component ii) is a formaldehyde source. Thus, in particular R^{c} is hydrogen. Suitable formaldehyde sources are formaldehyde as such, formaldehyde oligomers (e.g. trioxane) and polymers of formaldehyde (e.g. paraformaldehyde). More preferably, component ii) is formaldehyde. In a suitable embodiment, the formaldehyde is employed as an aqueous solution (formalin solution).

iii) Amino Compound Having at Least Two Primary Amino Groups

The amino compound is preferably selected from compounds of the formula

A(NH₂)_{q}
wherein
q is an integer greater than or equal to 2, and
A is a q-valent organic radical.

In the above formula, q indicates the number of primary amino groups bound to the group A. q can assume very large values, e.g. m can be an integer from 2 to 10 000, in particular from 2 to 5000. Very high values of q are present, e.g. if the compound iii) comprises a nitrogen-comprising polymer.

If only amino compounds iii) of the above formula are employed wherein is 2 (diamines), the obtained imidazolium polymers are linear.

If at least one amino compound iii) of the above formula is employed wherein q is greater than 2, the obtained imidazolium polymers are branched.

In a preferred embodiment, q is 2.

In a preferred embodiment, component iii) is selected from amines of the following formula:

H₂N-A-NH₂.

A is preferably a divalent aliphatic radical, more preferably C₂-C₈-alkylene, even more preferably linear C₂-C₈-alkylene, i.e. —(CH₂)ₘ—, where m is 2 to 8, in particular linear C₄-C₈-alkylene, i.e. —(CH₂)ₘ—, where m is 4 to 8, specifically linear C₆-alkylene, i.e. —(CH₂)ₘ—, where m is 6. In this specific case, the amine is hexamethylenediamine.

### iv) Protic Acid

The anions of the imidazolium polymer are derived from the anions of the protic acid(s) employed as component iv). It is also possible to subject the imidazolium polymer to an anion exchange. This allows the preparation of imidazolium polymers with anions for which no corresponding stable protic acid exists. The anion exchange can be effected by known methods, e.g. transprotonation, reaction with a metal salt, ion exchange chromatography, electrolytically or by means of a combination of these measures.

The imidazolium polymer used in the present invention comprises anions that act as counterions to the imidazolium cations. The anions are selected from anions of the formula Y^{p-}, wherein p is the valency of the anion. The corresponding protic acid can be represented by the formula Y^{p-}(H⁺)ₚ.

In a first embodiment, the anions of the formula Y^{p-}are selected from anions of inorganic acids and low molecular weight organic acid. In this embodiment, p is preferably an integer from 1 to 6, more preferably an integer from 1 to 4, in particularly 1 or 2. In a special embodiment, p is 1.

In a second embodiment, the anions of the formula Y^{p-}are selected from anions of polymeric protic acids, e.g. polyacrylic acid. In this embodiment, p can assume very high values. Suitable polymeric protic acids comprise at least one ethylenically unsaturated organic acid in polymerized form. Preferred ethylenically unsaturated organic acid are selected from acrylic acid, methacrylic acid, maleic acid, fumaric acid, itaconic acid, etc. and mixtures thereof. Especially preferred are the homo- and copolymers of acrylic acid and/or methacrylic acid. Suitable polymeric protic acids are also the copolymers of at least one ethylenically unsaturated organic acid, preferably selected from acrylic acid methacrylic acid, maleic acid, fumaric acid, itaconic acid with at least one copolymerizable comonomer, e.g. selected from (meth)acrylates, vinyl esters or aromatic monomers such as styrene and mixtures thereof.

The anions of the imidazolium polymer (=anions of the formula Y^{p-}) and the anions of the corresponding protic acid (=Y^{p-}(H⁺)ₚ) are preferably selected from R—C(═O)O—, where R is hydrogen, C₁-C₁₀-alkyl or C₁-C₄-haloalkyl; hydrogensulfate, sulfate, C₁-C₄-alkylsulfate, nitrate, dihydrogenphosphate, hydrogenphosphate, phosphate, R—S(═O)₂O—, where R is C₁-C₅-alkyl, C₁-C₄-haloalkyl, phenyl or tolyl; Cl⁻, Br⁻ and I⁻. In R—C(═O)O—, R is preferably C₁-C₄-alkyl, more preferably C₁-C₂-alkyl. In R—S(═O)₂O—, R is preferably C₁-C₄-alkyl or p-tolyl, more preferably methyl or p-tolyl. Y^{p-}is more preferably R—C(═O)O—, where R is preferably C₁-C₄-alkyl, more preferably C₁-C₂-alkyl. Specifically, Y^{p-} is acetate (i.e. R is methyl).

The protic acid is thus preferably selected from the group consisting of R—C(═O)OH, where R is hydrogen, C₁-C₁₀-alkyl or C₁-C₄-haloalkyl; sulfuric acid, hydrogensulfate salts, C₁-C₄-alkylsulfuric acid, nitric acid, phosphoric acid, dihydrogenphosphate salts, R—S(═O)₂OH, where R is C₁-C₈-alkyl, C₁-C₄-haloalkyl, phenyl or tolyl; HCl, HBr and HI The protic acid is more preferably R—C(═O)OH, where R is preferably C₁-C₄-alkyl, more preferably C₁-C₂-alkyl; and is specifically acetic acid (i.e. R is methyl).

v) Optional Amino Compound with Just One Primary Amino Group

The compound having only one primary amino group leads to chain termination and then forms the end group of the polymer chain concerned. The higher the proportion of compounds having only one primary amino group, the lower the molecular weight of the imidazolium polymer. Based on 100 mol of amino compounds having at least two primary amino groups, it is possible, in a preferred embodiment, to use, for example, from 0 to 10 mol of compounds having only one primary group.

The compound having only one primary amino group does not contain any other amino group or any other functional group. Examples for suitable compounds having only one primary amino group are monoalkylamines, preference being given to C₈-C₁₂-alkylamines (RNH₂, where R is C₈-C₁₂-alkyl), such as octylamine, 2-ethylhexylamine, nonylamine, decylamine, 2-propylheptylamine, undecylamine, dodecylamine, tridecyl-amine, tetradecylamine, pentadecylamine, hexadecylamine, heptadecylamine, octadecylamine, nonadecylamine, eicosylamine and (other) structural isomers thereof.

Preferably however, component v) is not used. Nor is any other process step used which would lead to the formation of end-capped polymers. End-capped polymers in the terms of the present invention are imidazolium polymers which are not terminated by an imidazolium ring in which one of the ring nitrogen atoms is not substituted nor by a primary amino group —NH₂ or the corresponding ammonium group NH₃⁺(Y^{p-})_{1/p} (i.e. by terminal groups as they result from the reaction of components i) to iv)), but which are terminated by a hydrocarbon group, such as an alkyl group. Such end-capped polymers are generally obtained by the reaction of components i) to iv) in the presence of component v), or by subjecting the polymer obtained by the reaction of components i) to iv) to an alkylation reaction.

The imidazolium polymer is thus preferably a polymer terminated by an imidazolium ring in which one of the ring nitrogen atoms is not substituted (the other the ring nitrogen atom is bound to the polymer chain) and/or by a primary amino group —NH₂ or the corresponding ammonium group NH₃⁺(Y^{p-})_{1/p}.

In sum, the polymeric ionic compound comprising imidazolium groups is preferably obtainable by reacting
i) glyoxal or a hemiacetal or acetal thereof;
ii) formaldehyde (or another formaldehyde source);
iii) an aliphatic diamine of the formula H₂N-A-NH₂, wherein A is C₂-C₈-alkylene; and
iv) at least one protic acid;
and optionally subjecting the reaction product to an anion exchange.

The imidazolium polymers preferably have a weight average molecular weight M_{w} of from 2,000 to 200,000, more preferably from 10,000 to 100,000, in particular from 10,000 to 80,000 g/mol, more particularly from 20,000 to 80,000, even more particularly from 20,000 to 60,000 g/mol, and specifically from 30,000 to 50,000 g/mol.

The imidazolium polymers preferably have a number average molecular weight Mₙ of from 300 to 100,000, more preferably from 1,000 to 50,000, in particular from 1,000 to 20,000, more particularly from 1,000 to 10,000, even more particularly from 2,000 to 8,000 g/mol, and specifically from 4,000 to 7,000 g/mol.

The polydispersity M_{w}/Mₙ is preferably in the range of from 1.5 to 25, more preferably from 2 to 15, in particular from 2 to 10, specifically from 5 to 10.

The polymeric ionic compound comprises from 4 to 150 imidazolium groups, preferably from 5 to 100, more preferably from 10 to 75 and in particular from 15 to 60.

The polymeric ionic compound comprising imidazolium groups is preferably of the formula (III)

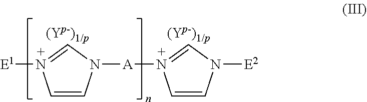

wherein
A is C₂-C₈-alkylene;
E¹ is -A-N H₂ or -A-N H₃⁺(Y^{p-})_{1/p};
E² is hydrogen, -A-NH₂ or -A-NH₃⁺(Y^{p-})₁p;
Y^{p-} is a p-valent anion;
n is from 5 to 100, preferably from 10 to 75 and in particular from 15 to 60; and
p is 1, 2 or 3.

A is preferably —(CH₂)ₘ—, where m is 2 to 8, preferably 4 to 8 and specifically 6.

Y^{p-} has preferably one of the preferred meanings described above in context with the protic acid; i.e. it is preferably selected from the group consisting of R—C(═O)O—, where R is hydrogen, C₁-C₁₀-alkyl or C₁-C₄-haloalkyl; hydrogensulfate, sulfate, C₁-C₄-alkylsulfate, nitrate, dihydrogenphosphate, hydrogenphosphate, phosphate, R—S(═O)₂O—, where R is C₁-C₅-alkyl, C₁-C₄-haloalkyl, phenyl or tolyl; Cl⁻, Br⁻ and I⁻. In R—C(═O)O—, R is preferably C₁-C₄-alkyl, more preferably C₁-C₂-alkyl. In R—S(═O)₂O—, R is preferably C₁-C₄-alkyl or p-tolyl, more preferably methyl or p-tolyl. Y^{p-} is more preferably R—C(═O)O—. In this context, R is preferably C₁-C₄-alkyl, more preferably C₁-C₂-alkyl. Specifically, Y^{p-} is acetate.

In compounds (I) and (II), the cation portion has preferably a molecular weight of at least 165.

In compounds (I) and (II), in the counter-anion is X^{p-}, p is the valency of the anion. p is preferably 1, 2 or 3. Examples for suitable anions are those mentioned above in context with Y^{p-}, and moreover also saccharinate. Preference is given to halide, sulfate, methosulfate and saccharinate, in particular to halide, sulfate and methosulfate. Specifically, X^{p-} is a halide anion, and more specifically chloride.

Preferably, in compounds (I) and (II),
R¹ is C₆-C₂₆-alkyl, phenyl-C₁-C₄-alkyl, phenyl substituted with a C₆-C₂₀-alkyl, C₆-C₂₀-haloalkyl, C₆-C₂₀-alkoxy or C₆-C₂₀-haloalkoxy group; benzyl substituted with a C₆-C₂₀-alkyl, C₆-C₂₀-haloalkyl, C₆-C₂₀-alkoxy or C₆-C₂₀-haloalkoxy group; octyl-phenyl-O—CH₂CH₂—O—CH₂CH₂—; and C₁₁H₂₃—C(═O)—O—CH₂CH₂—NH—C(═O)—CH₂—(C₁₁H₂₃ is undecyl);
R² has independently one of the meanings given above for R¹;
R³ and R⁴, independently of each other, are C₁-C₄-alkyl; and
X^{p-} is a halide, sulfate or methosulfate anion.

Preferably, the antimicrobial agent is a compound of the formula (I).

In a more preferred embodiment, the antimicrobial agent is a compound of the formula (I), wherein
R¹ is C₅-C₂₀-alkyl or octyl-phenyl-O—CH₂CH₂—O—CH₂CH₂—;
R² is benzyl;
R³ and R⁴ are methyl; and
X^{p-} is a halide anion.

Even more preferably, the antimicrobial agent is a compound of the formula (I), wherein
R¹ is C₈-C₁₈-alkyl;
R² is benzyl;
R³ and R⁴ are methyl; and
X^{p-} is chloride.

Such compounds wherein R¹ is alkyl, R² is benzyl, R³ and R⁴ are methyl and X^{p-} is chloride or mixtures thereof (i.e. mixtures of such compounds differing in their alkyl groups) are known as benzalkonium chloride (abbreviated as BZK, BKC, BAK, BAC) or as alkyldimethylbenzylammonium chloride (abbreviated as ADBAC).

In particular, the antimicrobial agent is a compound of the formula (I), wherein
R¹ is C₁₀-C₁₈-alkyl;
R² is benzyl;
R³ and R⁴ are methyl; and
X^{p-} is chloride.

Specifically, R¹ is C₁₂-C₁₈-alkyl; or is C₁₂-C₁₆-alkyl; or is C₁₂-C₁₄-alkyl.

Compounds (I) wherein R¹ is Cₓ-C_{y}-alkyl, R² is benzyl, R³ and R⁴ are methyl and X^{p-} is chloride are also abbreviated in the art as ADBAC (Cₓ-C_{y}) or BKC (Cₓ-C_{y}). Thus, for instance, compounds wherein R¹ is C₁₂-C₁₈-alkyl, R² is benzyl, R³ and R⁴ are methyl and X^{p-} is chloride are abbreviated in the art as ADBAC (C12-C18); compounds wherein R¹ is C12-C16-alkyl, R² is benzyl, R³ and R⁴ are methyl and X^{p-} is chloride are also abbreviated in the art as ADBAC (C12-C16) or BKC (C12-C16) and compounds wherein R¹ is C12-C14-alkyl, R² is benzyl, R³ and R⁴ are methyl and X^{p-} is chloride are also abbreviated in the art as ADBAC (C12-C14).

In another more preferred embodiment, the antimicrobial agent is a compound of the formula (I), wherein
R¹ and R², independently of each other, are C₈-C₂₀-alkyl; preferably C₈-C₁₂-alkyl;
R³ and R⁴ are methyl; and
X^{p-} is a halide anion, preferably chloride.

In another even more preferred embodiment, the antimicrobial agent is a compound of the formula (I), wherein
R¹ and R², independently of each other, are C₈-C₁₂-alkyl;
R³ and R⁴ are methyl; and
X^{p-} is chloride.

Specifically, R¹ and R² are both decyl. Compounds (I) wherein R¹ and R² are both decyl, R³ and R⁴ are methyl and X^{p-} is chloride are also abbreviated in the art as DDAC.

The polymeric ionic compound comprising imidazolium groups and the antimicrobial agent of the formula (I) or (II) are used in an overall weight ratio of preferably from 100:1 to 1:100, more preferably from 50:1 to 1:50, even more preferably from 1:1 to 1:50, in particular from 1:1 to 1:30, and more particularly from 1:2 to 1:20. Preferably, the (overall) amount of the imidazolium polymer does not exceed the (overall) amount of the antimicrobial agent of the formula (I) or (II). Thus, more preferably, the polymeric ionic compound comprising imidazolium groups and the antimicrobial agent of the formula (I) or (II) are used in an overall weight ratio of from 1:1 to 1:100, more preferably from 1:1 to 1:50, even more preferably from 1:2 to 1:50, in particular from 1:2 to 1:30, more particularly from 1:2 to 1:20 and specifically from 1:3 to 1:20.

Preferably, the polymeric ionic compound comprising imidazolium groups and the antimicrobial agent of the formula (I) or (II) are used in synergistically effective amounts; to be more precise in such amounts that a synergistic antimicrobial effect is obtained. This means that the antimicrobial effect of the combined use of imidazolium polymer and compound (1) or (II) is higher than would have been expected from the antimicrobial effects of the single components (used of course in the same amounts as in the combination). This becomes, for example, manifest in a higher reduction of microbes than the sum of the reductions obtained with the single components. Specifically, the polymeric ionic compound comprising imidazolium groups and the antimicrobial agent of the formula (I) or (II) are used in such amounts that a synergistic antibacterial effect, more specifically an antibacterial effect against gram-negative bacteria, e.g. of the family Enterobacteriaceae, even more specifically of the genus Escherichia (e.g. E. coli) or Salmonella (e.g. S. enterica) is obtained.

The polymeric ionic compound comprising imidazolium groups are principally known, e.g. from WO 2012/127009 A1, WO 2017/025433 A1 or EP3510867 A1, and can be prepared by the methods described therein. For obtaining end-capped polymers, the methods described in WO 2017/025433 A1 can be applied, i.e. the reaction is either carried out in the presence of a primary amine (component v)) or, after formation of the uncapped form, the polymer is subjected to an alkylation reaction; or both measures are taken.

Preferably however, as already explained above, component v) is not used; nor is any other process step used which would lead to the formation of end-capped polymers, i.e. of polymers which are not terminated by an imidazolium ring in which one of the ring nitrogen atoms is not substituted and/or by a primary amino group —NH₂ or the corresponding ammonium group NH₃⁺(Y^{p-})_{1/p} (i.e. by terminal groups as they result from the reaction of solely components i) to iv)), but by a hydrocarbon group, such as an alkyl group (this other process step which would lead to the formation of end-capped polymers is for example an alkylation step following the polymerization).

As said, the imidazolium polymer is preferably not end-capped, i.e. it is preferably a polymer terminated by an imidazolium ring in which one of the ring nitrogen atoms is not substituted (the other is bound to the polymer chain) and/or by a primary amino group —NH₂ or the corresponding ammonium group NH₃⁺(Y^{p-})_{1/p}.

Compounds (I) and (II) and methods for preparing them also known in the art; many of them are commercially available.

The combination of the imidazolium polymers and the compounds (1) and/or (II) is effective against a variety of harmful microorganisms, such as bacteria, fungi (including yeasts and molds), microscopic algae, protozoans, spores of the aforementioned microorganisms, viruses and prions. In particular they are effective against bacteria, specifically against gram-negative bacteria, e.g. of the family Enterobacteriaceae, more specifically of the genus Escherichia (e.g. E. coli) or Salmonella (e.g. S. enterica).

The combination of the imidazolium polymers and the compounds (1) and/or (II) is preferably used as disinfecting agent. Thus the imidazolium polymers are preferably used for enhancing the disinfecting activity of the antimicrobial agents (1) or (II).

The imidazolium polymers and the compounds (1) and/or (II) are preferably used in a composition which has an antimicrobial activity, such as sanitizers or disinfectants.

Sanitizers and disinfectants are agents or compositions containing agents which exert an antimicrobial effect (i.e. they destroy or inactivate microorganisms), the difference being the extent of the activity; disinfectants having a stronger antimicrobial effect than sanitizers. Moreover, sanitizers simultaneously clean, whereas disinfectants do not necessarily. Disinfectants (and sanitizers) are generally distinguished from other antimicrobial agents such as antibiotics, which destroy microorganisms within the body. In terms of the present invention, however, the term disinfectant (and sanitizer) also encompasses antiseptics, i.e. agents or compositions which destroy microorganisms on living tissue, e.g. on human skin (e.g. in form of hand disinfectants).

The compositions can be in the form of liquids or gels, or can be sprays or aerosols. They can also be solid, but preference is given to liquids, gels, sprays or aerosols. The composition can be a concentrate comprising the imidazolium polymer, the antimicrobial agent (1) and/or (II) and a carrier, such as a diluent, e.g. an organic solvent and/or water; or can be a dilutable concentrate (including refill concentrates), i.e. a composition which contains all ingredients, but in concentrated form and thus needs dilution (generally with water) before it is ready for use; or can be a ready-to-use-composition, i.e. a composition which is used as such and does not need any further dilution or addition of further substances.

Preferably, the composition is selected from the group consisting of dilutable concentrates or ready-to-use compositions for disinfecting or sanitizing hard or soft surfaces, spaces, areas, process water, human or animal skin or keratinous material, or the oral cavity of humans or animals. More preferably, the composition is selected from the group consisting of homecare compositions, compositions for cleaning or disinfecting in industrial or institutional settings or areas, including agricultural environments; compositions for cleaning or disinfecting animals, and personal care compositions.

Further formulation details are given below in context with the compositions of the invention.

### Compositions

The invention relates moreover to a composition comprising
(a) a polymeric ionic compound comprising imidazolium groups as defined above, where however no amino compound having only one primary amino group (component (v) is reacted; and
(b) an antimicrobial agent of the formula (I) or (II) as defined above, or a mixture of different compounds (1) and/or (II);
where the overall weight ratio of the polymeric ionic compound comprising imidazolium groups and the antimicrobial agent of the formula (I) or (II) is in the range of from 100:1 to 1:100, preferably from 50:1 to 1:50, more preferably from 1:1 to 1:50, in particular from 1:1 to 1:30, more particularly from 1:2 to 1:20.

Preferably, the (overall) amount of the imidazolium polymer (a) does not exceed the (overall) amount of the antimicrobial agent of the formula (I) or (II). Thus, more preferably, the polymeric ionic compound comprising imidazolium groups and the antimicrobial agent of the formula (I) or (II) are comprised in an overall weight ratio of from 1:1 to 1:100, more preferably from 1:1 to 1:50, even more preferably from 1:2 to 1:50, in particular from 1:2 to 1:30, more particularly from 1:2 to 1:20 and specifically from 1:3 to 1:20.

Preferably, the overall weight ratio of the polymeric ionic compound comprising imidazolium groups and the antimicrobial agent of the formula (I) or (II) is such that a synergistical effect can be obtained when the composition is applied. A synergistical effect means in the present case that the antimicrobial effect of the combined use of imidazolium polymer and compound (1) or (II) is higher than would have been expected from the antimicrobial effect of the single components (used of course in the same amounts as in the combination). This becomes, for example, manifest in a higher reduction of microbes than the sum of the reductions obtained with the single components. Preferably, this becomes manifest in a higher reduction of bacteria, specifically of gram-negative bacteria, e.g. of bacteria of the family Enterobacteriaceae, more specifically of the genus Escherichia (e.g. E. coli) or Salmonella (e.g. S. enterica), than the sum of the reductions obtained with the single components.

Preferred imidazolium polymers and antimicrobial agents of the formula (I) or (II) are described above.

The imidazolium polymer is not end-capped. This is achieved by not using component v) in the synthesis of the imidazolium polymer (a); nor applying any other process step which would lead to the formation of end-capped polymers, i.e. of polymers which are not terminated by an imidazolium ring in which one of the ring nitrogen atoms is not substituted and/or by a primary amino group —NH₂ or the corresponding ammonium group NH₃⁺(Y^{p-})_{1/p} (i.e. by terminal groups as they result from the reaction of components i) to iv)), but by a hydrocarbon group, such as an alkyl group.

The imidazolium polymer which is not end-capped is terminated by an imidazolium ring in which one of the ring nitrogen atoms is not substituted (the other is bound to the polymer chain) and/or by a primary amino group —NH₂ or the corresponding ammonium group NH₃⁺(Y^{p-})_{1/p}.

The composition of the invention has an antimicrobial activity, and is thus preferably a sanitizer or disinfectant composition.

As explained above, sanitizers and disinfectants are agents or compositions containing such agents which exert an antimicrobial effect (i.e. they destroy or inactivate microorganisms), the difference being the extent of the activity, disinfectants having a stronger antimicrobial effect than sanitizers. Moreover, sanitizers simultaneously clean (and thus generally contain a surfactant), whereas disinfectants do not necessarily. Disinfectants (and sanitizers) are generally distinguished from other antimicrobial agents such as antibiotics, which destroy microorganisms within the body. In terms of the present invention, however, the term disinfectant (and sanitizer) also encompasses antiseptics, i.e. agents or compositions which destroy microorganisms on living tissue, e.g. on human skin (e.g. in form of hand disinfectants).

The compositions can be in the form of liquids or gels, or can be sprays or aerosols. They can also be solid, but preference is given to liquids, gels, sprays or aerosols.

The composition can be a concentrate comprising the imidazolium polymer, the antimicrobial agent (I) and/or (II) and a carrier, such as a diluent, e.g. an organic solvent and/or water; or can be a dilutable concentrate (including refill concentrates), i.e. a composition which contains all ingredients, but in concentrated form and thus needs dilution (generally with water) before it is ready for use; or can be a ready-to-use-composition, i.e. a composition which is used as such and does not need any further dilution or addition of further substances.

Preferably, the composition is selected from the group consisting of dilutable concentrates or ready-to-use compositions for disinfecting or sanitizing hard or soft surfaces, spaces, areas, process water, human or animal skin or keratinous material, or the oral cavity of humans or animals. More preferably, the composition is selected from the group consisting of homecare compositions, compositions for cleaning or disinfecting in industrial or institutional settings or areas, including agricultural environments; compositions for cleaning or disinfecting animals, and personal care compositions.

Hard surfaces to be disinfected or sanitized include medical, e.g. surgical, instruments and appliances. Further examples for hard surfaces are given below. Soft surfaces include clothing and boots used in medical and agricultural environments. Further examples for soft surfaces are given below.

Spaces and areas to be disinfected or sanitized can be both inside and outside buildings. The terms include air to be disinfected or deodorized, like in disinfection and odor-control applications, such as waste bin deodorization/disinfection; treatment of the inner space of rental cars and campers for disinfection and deodorization, or room sprays.

Process water is for example process water used in food, feed, pharmaceutical or cosmetic industry (cooling and process water), pulp or paper production or wood treatment, cooling water towers, reservoirs or cycles, air washers, air conditioners and the like.

Human or animal keratinous material is for example hair, fur, feathers, scales, nails, claws, hooves, horns or beaks.

Homecare compositions are compositions used for cleaning or disinfection purposes in private households.

Compositions for cleaning or disinfecting in industrial or institutional settings or areas (also called industrial and institutional cleaning or I&I cleaning) are compositions used outside private households, e.g. in commercial areas, industrial facilities, hotels and gastronomy, institutions like schools, universities, hospitals or prisons, food or feed processing facilities, and also in agricultural environments, such as stables, barns, co-ops, milking installations and the like.

Homecare compositions and I&I compositions overlap largely, only that I&I compositions are adapted to the use on a larger scale or for more challenging demands and are thus often more aggressive (e.g. by being more concentrated and/or by having a distinctly higher or lower pH than the respective homecare composition) and/or are less “pleasant”, e.g. in the sense of odor or aspect or touch.

The present I&I compositions are also suitable for clean-in-place (CIP), which is a method of automated cleaning of the interior surfaces of pipes, vessels, equipments, filters and associated fittings and the like without major disassembly. CIP is often used in the food and beverage industry, like in breweries, in the dairy industry and in the soft-drink or juice-manufacturing industry, especially in facilities for processing liquid product streams, such as milk, juices and other beverages; but also in the cosmetic or pharmaceutical industry.

Examples for homecare and I&I compositions with a disinfecting action are surface cleaning compositions (also termed hard surface cleaners; for example glass, floor, tile, counter, bath(room), toilet bowl, sink, wash basin, kitchen, appliance and furniture cleaning compositions; all-purpose cleaners; sanitary cleaners), non-cosmetic deodorants (e.g. air and/or surface deodorants), disinfectants (for example spray air disinfectants, and spray, liquid and paste/gel surface disinfectants), surface protecting and/or polishing compositions, rug shampoos, compositions for wet wipes or pads (e.g. for cleaning the floor, furniture, bath room surfaces etc.) and laundry compositions (in liquid or gel form; for example laundry detergents, fabric softeners, rinsing compositions, bleacher compositions, stain remover compositions and the like).

Personal care compositions are used for cleaning, washing, disinfecting, nurturing, grooming, protecting or embellishing the human body (and thus also include cosmetics). Examples are creams, lotions, ointments, other o/w or w/o emulsions, liquid or gel-like soaps, shampoos, make-up and other decorative cosmetics, and compositions for wet wipes (e.g. for cleaning the nappy area). In the present case, the personal care compositions are preferably compositions for the antimicrobial treatment, deodorization or disinfection if the human skin, mucosa, hair or nails. Examples are hand or body disinfecting compositions or products in form of liquid, gel-form or solid hand soaps, hygienic hand rubs or surgical scrubs, disinfecting liquids, gels, sprays or wipes; disinfecting oral rinse (mouth wash) or spray, shampoos and the like.

Compositions for cleaning or disinfecting animals are e.g. compositions for the antimicrobial treatment, deodorization or disinfection if the skin, mucosa, hair, fur, feathers, scales, nails, claws, hooves, horns or beaks of animals. Like personal care compositions, they can be disinfecting compositions or products in form of liquid, gel-form or solid soaps, hygienic rubs or scrubs, disinfecting liquids, gels, sprays or wipes; disinfecting oral rinse or spray, shampoos and the like.

The hard or soft surface to be treated can be of various materials, such as ceramic, stone material, cement, glass, metal, including steel and other alloys, plastics, wood, composite materials, coated material or textiles, e.g. natural fibers, such as cotton, wool or silk, or synthetic fibers, such as polyesters, polyamides, polyolefins or polyurethanes, including foam materials, upholstery materials and carpets.

The compositions can be solid, semi-solid or gel-like, liquid (including spray) or an aerosol. They can be formulated in all types usual for the respective application, such as bars, powders, granulates, agglomerates, pastes, gels, solutions, emulsions, suspensions, etc. They can also be formulated as liquid composition imbibed in wipes or pads.

The compositions generally contain a carrier. In liquid, semi-solid or gel-like compositions, the carrier is or comprises a solvent, mostly water, an alkanol (generally a C₂-C₃-alkanol, i.e. ethanol, n-propanol and/or isopropanol; these generally also act as antimicrobials and/or as wetting agents to allow a better wetting or penetration of the treated substrate by the composition; this latter effect is particularly useful if no surfactant is contained in the composition), an organic solvent different therefrom (details to such further solvents are given below in context with component (e) of the preferred embodiments of the composition) or a mixture thereof. In solid, semi-solid or gel-like compositions, the carrier is or comprises a solid carrier. In solid soaps, the soap component (e.g. the solid salt of long-chained fatty acids) is generally also the carrier.

Depending on the targeted use, the compositions generally comprise further components. Examples are surfactants, pH adjusting agents, sequestrants, thickeners, antifreezing agents, antifoaming agents, colorants, perfumes or other antimicrobial agents.

Further details to such further components are given below in context with components (c) to (g) of the preferred embodiments of the composition.

In a preferred embodiment, the composition comprises
(a) 0.0001 to 90% by weight, relative to the total weight of the composition, of the polymeric ionic compound comprising imidazolium groups;
(b) 0.0001 to 90% by weight, relative to the total weight of the composition, of the antimicrobial agent (I) and/or (II);
(c) 0 to 60% by weight, relative to the total weight of the composition, of one or more surfactants;
(d) 0 to 99.9998% by weight, relative to the total weight of the composition, of at least one C₂-C₃-alkanol;
(e) 0 to 20% by weight, relative to the total weight of the composition, of at least one organic solvent different from component (d);
(f) 0 to 20% by weight, relative to the total weight of the composition, of at least one sequestrant;
(g) 0 to 50% by weight, relative to the total weight of the composition, of one or more further additives; and
(h) 0 to 99,9998% by weight, relative to the total weight of the composition, of water; where components (a) to (h) add to 100% by weight.

Preferably, at least one of components (c) to (h) is present. More preferably, at least component (h) is present. Even more preferably, at least component (c) and (h) is present.

Alternatively or additionally, the overall weight ratio of the polymeric ionic compound comprising imidazolium groups (a) and the antimicrobial agent (b) is preferably in the range of from 1:1 to 1:50, preferably from 1:1 to 1:30, more preferably from 1:2 to 1:20.

Surfactants (or surface-active compounds) (termed component (c) in the above and below embodiments) can be anionic, cationic, non-ionic or amphoteric (zwitterionic). Anionic, cationic, non-ionic and amphoteric surfactants are widely known in the art.

Anionic surfactants are, for example, of the sulfate, sulfonate or carboxylate type or mixed forms thereof. Examples are
alkyl sulfates (generally of the formula R—O—SO₃⁻M⁺, where R is a long-chained alkyl group, e.g. C₈-C₂₄-alkyl, and M⁺ is a cation equivalent, generally Na⁺, K⁺, NH₄⁺, mono-, di- or triethanolammonium); e.g. sodium lauryl sulfate;
alkyl ether sulfates (generally of the formula R—(CH₂CH₂—O)ₓ—O—SO₃⁻M⁺, where R is a long-chained alkyl group, e.g. C₅-C₂₄-alkyl, x is 1-10 and M⁺ is a cation equivalent, generally Na⁺, K⁺, NH₄⁺, mono-, di- or triethanolammonium); e.g. sodium laureth sulfate (SLES);
alkylbenzenesulfonates (generally of the formula R—(C₆H₄)—SO₃⁻M⁺, where R is a long-chained alkyl group, e.g. C₅-C₂₄-alkyl, and M⁺ is a cation equivalent, generally Na⁺, K⁺, NH₄⁺, mono-, di- or triethanolammonium); e.g. sodium dodecylbenzene sulfonate;
olefin sulfonates (generally of the formula R—SO₃⁻M⁺, where R is a long-chained monoolefin group, e.g. C₁₂-C₂₄-alkenyl, and M⁺ is a cation equivalent, generally Na⁺, K⁺, NH₄⁺, mono-, di- or triethanolammonium); e.g. sodium C₁₄/C₁₆-α-olefin sulfonate;
alkane sulfonates (generally of the formula R—SO₃⁻M⁺, where R is a long-chained alkyl group, e.g. C₅-C₂₄-alkyl, and M⁺ is a cation equivalent, generally Na⁺, K⁺, NH₄⁺, mono-, di- or triethanolammonium); e.g. alkali metal or ammonium C₁₃-C₁₇ paraffin sulfonate;
sulfated monoglycerides (generally of the formula R—COO⁻CH₂—CH(OH)—CH₂—O—SO₃-M⁺, where R is a long-chained alkyl group, e.g. C₅-C₂₄-alkyl, and M⁺ is a cation equivalent, generally Na⁺, K⁺, NH₄⁺, mono-, di- or triethanolammonium); e.g. sodium cocomonoglyceride sulfate;
alkyl sulfosuccinates, e.g. disodium N-octadecylsulfosuccinamate, diammonium lauryl sulfosuccinate, tetrasodium N-(1,2-dicarboxyethyl)-N-octadecylsulfosuccinate;
diamyl ester of sodium sulfosuccinic acid, dihexyl ester of sodium sulfosuccinic acid, or dioctyl ester of sodium sulfosuccinic acid;
acyl taurates, e.g. N-alkyltaurins, e.g. prepared by reacting dodecylamine with sodiumisethionate or N-acyltaurines obtained by the reaction of N-methyl taurine with fatty acids;
acyl isethionates (generally of the formula R—COO⁻CH₂CH₂—SO₃⁻M⁺, where R is a long-chained alkyl group, e.g. C₁₀-C₃₀-alkyl, and M⁺ is a cation equivalent, generally Na⁺, K⁺, NH₄⁺, mono-, di- or triethanolammonium); e.g. ammonium cocoyl isethionate, sodium cocoyl isethionate or sodium lauroyl isethionate;
alkyl glycerylether sulfonates (generally of the formula R—O—CH₂—CH(OH)—CH₂—SO₃-M⁺, where R is a long-chained alkyl group, e.g. C₈-C₂₄-alkyl, and M⁺ is a cation equivalent, generally Na⁺, K⁺, NH₄⁺, mono-, di- or triethanolammonium); e.g. coco-glyceryl ether sulfonate;
sulfonated fatty acids and sulfonate fatty acid methyl esters (generally of the formula R—CH(SO₃M⁺)—COOH and R—CH(SO₃M⁺)—COOCH₃, where R is a long-chained alkyl group, e.g. C₅-C₂₄-alkyl, and M⁺ is a cation equivalent, generally Na⁺, K⁺, NH₄⁺, mono-, di- or triethanolammonium); e.g. α-sulfonated coconut fatty acid or lauryl methyl ester;
acyl glutamates (generally of the formula R—CO—N(COOH)—CH₂CH₂—COO⁻M⁺, where R is a long-chained alkyl group, e.g. C₅-C₂₄-alkyl, and M⁺ is a cation equivalent, generally Na⁺, K⁺, NH₄⁺, mono-, di- or triethanolammonium); e.g. sodium lauroyl glutamate or sodium cocoyl glutamate;
acyl sarcosinates (generally of the formula R—CO—N(CH₃)—CH₂—COO⁻M⁺, where R is a long-chained alkyl group, e.g. C₅-C₂₄-alkyl, and M⁺ is a cation equivalent, generally Na⁺, K⁺, NH₄⁺, mono-, di- or triethanolammonium); e.g. sodium lauroyl sarcosinate, sodium cocoyl sarcosinate or ammonium lauroyl sarcosinate;
alkyl sulfoacetates,
fatty acid salts, generally derived from the saponification of oils or fats, e.g. from palm oil or tallow oil, and having from 8 to 24 carbon atoms in the alkyl/alkenyl moiety (thus containing, inter alia, oleate, linolate, palmitate, myristate, stearate etc.), where the counter cation is generally Na⁺, K⁺, NH₄⁺, mono-, di- or triethanolammonium;
alkyl and alkenyl ether carboxylates (generally of the formula R—(OCH₂CH₂)ₓ—OCH₂—COO⁻M⁺, where R is a long-chained alkyl or alkenyl group, e.g. C₅-C₂₄-alkyl or -alkenyl, x is 1 to 10 and M⁺ is a cation equivalent, generally Na⁺, K⁺, NH₄⁺, mono-, di- or triethanolammonium); e.g. sodium laureth carboxylate;
acylated peptides,
acyl lactylates (generally of the formula R—CO—[OCH(CH₃)—CO]x-COO⁻M⁺, where R is a long-chained alkyl or alkenyl group, e.g. C₅-C₂₄-alkyl or -alkenyl, x is 3 and M⁺ is a cation equivalent, generally Na⁺, K⁺, NH₄⁺, mono-, di- or triethanolammonium); e.g. sodium cocoyl lactylate.

Another class of suitable anionic surfactants are polyalkoxylate polycarboxylated surfactants, e.g. as described in U.S. Pat. No. 5,376,298, EP-A-0129328, WO 03/018733 U.S. Pat. No. 5,120,326. The polyalkoxylate polycarboxylated surfactant can be described by the formula R—O—(C₂H₄₀)ₓ—[CH(L)CH(L)]_{y}-[CH₂CH(CH₃)O)_{z}Q wherein R is a hydrophobic hydrocarbon group, preferably alkyl, containing from 6 to 16, preferably from 8 to 14 carbon atoms; x is a number from 0 to 60, preferably from 4 to 50, more preferably from 6 to 50; L is either a C₁-C₃ alkyl group or a group having the formula —CH(COO⁻)—CH₂(COO⁻), with at least one L group in each molecule being —CH(COO⁻)—CH₂(COO⁻); y is a number from 1 to 12, preferably from 2 to 10, more preferably from 3 to 8; z is a number from 0 to 20, preferably from 0 to 15, more preferably from 0 to 10; and Q is selected from the group consisting of H and sulfonate groups, the compound being rendered electrically neutral by the presence of cationic groups, preferably selected from the group consisting of sodium, potassium, and substituted ammonium, e.g. monoethanol ammonium, cations. Such polyalkoxylate polycarboxylate surfactants are commercially available under the Plurafac® brand of BASF, e.g. Plurafac® CS-10.

Cationic surfactants are, for example, ammonium salts such as C₈-C₁₆-dialkyldimethylammonium halides, dialkoxydimethylammonium halides or imidazolinium salts with a long-chain alkyl radical.

Non-ionic surfactants are typically the condensation products of one or more alkylene oxide, mostly ethylene oxide, with various reactive hydrogen-containing compounds having hydrophobic chains, for example with 8-24 carbon atoms, e.g. the condensation products of polyethyleneoxide with fatty alcohols, long chain branched alkyl alcohols, fatty acids, fatty amines, polyhydric alcohols or polypropylene oxide.

Suitable alkoxylated, advantageously ethoxylated, alcohols are especially alkoxylated, advantageously ethoxylated, primary alcohols having preferably 8 to 18 carbon atoms and an average of 1 to 20, preferably 1 to 12, mol of ethylene oxide (EO) per mole of alcohol, in which the alcohol radical may be linear or branched, in particular 2-methyl-branched, or may comprise linear and methyl-branched radicals in a mixture, as are typically present in oxo alcohol radicals. Also suitable are alkyl alcohols synthesized by the Guerbet process, for example, 2-ethylhexanol, 2-n-propylheptanol, 2-isopropyl-heptanol, 2-n-butyloctanol, and 2-n-pentylnonanol, preferred are 2-ethylhexanol, 2-n-propylheptanol, and 2-isopropyl-heptanol. More preference is given to 2-n-propylheptanol. Nonionic surfactants synthesized from this latter alcohol are marketed by BASF under the brand names Lutensol® XP and Lutensol® XL Other preferred ethoxylated alkyl alcohols have a higher degree of branching, especially ethoxylated alkyl alcohols available under the BASF brand names Lutensol® TO Lutensol® ON and Lutensol® TDA.

Suitable are also alcohol ethoxylates with linear radicals formed from alcohols of native origin having 12 to 18 carbon atoms, for example from coconut alcohol, palm alcohol, tallow fat alcohol or oleyl alcohol, and an average of 2 to 12 EO per mole of alcohol. The preferred ethoxylated alcohols include, for example, C₁₂-C₁₄-alcohols with 3 EO, 4 EO, 7 EO or 10 EO, C₉-C₁₁-alcohol with 4 EO or 7 EO or 10 EO, C₁₃-C₁₅-alcohols with 3 EO, 5 EO, 7 EO, 8 EO or 10 EO, C₁₂-C₁₈-alcohols with 3 EO, 5 EO, 7 EO or 10 EO and mixtures thereof, such as mixtures of C₁₂-C₁₄-alcohol with 3 EO and C₁₂-C₁₈-alcohol with 7 EO. The degrees of ethoxylation stated are statistical averages which, for a specific product, may be an integer or a fraction. Also suitable are alcohol ethoxylates which have a narrowed homolog distribution (narrow range ethoxylates, NRE). In addition to these alkoxylated alcohols, it is also possible to use fatty alcohols with more than 12 EO. Examples thereof are tallow fat alcohol with 14 EO, 25 EO or 30 EO. It is also possible to use alkoxylated alcohols which comprise EO and PO groups together in the molecule. In this case, it is possible to use block copolymers with EO-PO block units or PO-EO block units, but also EO-PO-EO copolymers or PO-EO-PO copolymers.

It will be appreciated that it is also possible to use mixed-alkoxylation nonionic surfactants in which EO and PO units are not in blockwise but in random distribution. Such products are obtainable by the simultaneous action of ethylene oxide and propylene oxide on fatty alcohols.

Suitable alkoxylated, preferably ethoxylated or ethoxylated and propoxylated, fatty acid alkyl esters preferably have 1 to 4 carbon atoms in the alkyl chain and are especially fatty acid methyl esters.

Non-ethoxylated non-ionic surfactants are for example sugar surfactants, glycerol monoethers, polyhydroxyamides (glucamide) or amine oxides.

Sugar surfactants are for example alkyl and/or alkenyl polyglycosides, sugar or alkyl sugar fatty acid esters, and fatty sugar amides.

Alkyl and/or alkenyl polyglycosides are nonionic surfactants with a carbohydrate as hydrophilic moiety and fatty alcohols or fatty acids as hydrophobic component. Examples are compounds of the formula

R—O-Gₚ,

where R is a long-chained alkyl or alkenyl group, mostly with 4-22 carbon atoms, G is an aldose or ketose moiety, mostly a glucose moiety, and p is from 1 to 10.

G is preferably derived from aldoses or ketoses having 5 or 6 carbon atoms. In one embodiment, component G is selected from the group of hexoses, preferably from the group consisting of allose, altrose, glucose, mannose, gulose, idose, galactose, talose, psicose, fructose, sorbose and tagatose, and is more preferably glucose. In another embodiment, component G is selected from the group of pentoses, preferably from the group consisting of ribulose, xylulose, ribose, arabinose, xylose and lyxose, and more preferably from xylose and arabinose.

The index number p in the above formula gives the degree of polymerization (DP), and is a number between 1 and 10. In one embodiment p is of from 1.1 to 3.0.

R can be linear or branched. For instance, the radical R is derived from linear primary alcohols, e.g. fatty alcohols, or from branched primary alcohols, in particular so-called oxo alcohols. Examples for R derived from linear primary alcohols are n-octyl, n-nonyl, n-decyl, n-undecyl, n-dodecyl, n-tridecyl, n-tetradecyl, n-pentadecly, n-heptadecyl or n-octadecyl. Examples for R derived from branched primary alcohols are isoamyl, iso-hexyl, isoheptyl, 2-ethylhexyl and 2-propylheptyl.

It is also possible to use mixtures of different alkyl and/or alkenyl polyglycosides Thus, all combinations of the various aldoses or ketoses with all possible alkyl- and/or alkenyl radicals can be used.

Commercially available alkyl and/or alkenyl polyglycosides are for example products sold under the PLANATAREN® and PLANTACARE® brands from Henkel, e.g. PLANTAREN 1200, PLANTAREN 1300, PLANTAREN 2000, PLANTACARE 2000, PLANTACARE 818, PLANTACARE 1200; products sold under the TRITON® CG brand from Seppic, e.g. TRITON CG 110 (or ORAMIX CG 110) and TRITON CG 312 (or ORAMIX NS 10); the product sold as LUTENSOL® GD 70 from BASF SE; the products sold under the Glucopon® brand from BASF SE, e.g. Glucopon 100 DK, Glucopon215 UP, Glucopon 225 DK, Glucopon 425 N/HH, Glucopon GD 70, Glucopon 50 G, Glucopon 600 CSUP or Glucopon 650 EC; and the product Plantatex® LLE from BASF SE.

Sugar or alkyl sugar fatty acid esters are sugar or alkyl sugar C₄-C₂₂ fatty acid esters among which there may be mentioned in particular: (C₁-C₄)alkyl glucoside esters such as methyl glucoside monostearate, e.g. the product sold under the name GRILLOCOSE® IS by Grillowerke; methyl glucoside sesquistearate, e.g. the product sold under the name GLUCATE SS by Amerchol; 6-ethylglucoside decanoate, e.g. the product sold under the name BIOSURF 10 by Novo; the mixture of mono- and dicocoate (82/7) of 6-ethylglucoside, e.g. the product sold under the name BIOSURF® COCO by Novo; the mixture of mono- and dilaurate (84/8) of 6-ethylglucoside, e.g. the product sold under the name BIOSURF® 12 by Novo; the butyl glucoside C₁₂-C₁₈ fatty acid monoesters, such as butyl glucoside monococoate, e.g. the product sold under the names REWOPOL® V3101 or REWOSAN® V3101 and polyoxyethylenated butyl glucoside monococoate with 3 moles of ethylene oxide, e.g. the product sold under the name REWOPOL® V3122 by Rewo; glucose esters, such as 6-O-hexadecanoyl-[alpha]-D-glucose, 6-O-octanoyl-D-glucose, 6-O-oleyl-D-glucose, 6-O-linoleyl-D-glucose, which can be prepared, for example, from the corresponding acid chloride and D-glucose; sucrose monoesters such as sucrose monolaurate, e.g. the product sold under the name GRILLOTEN® LES 65, and sucrose monococoate sold under the name GRILLOTEN® LES 65K sold by the company Grillo-Werke.

The fatty sugar amides are compounds comprising at least one amide function and including at least one sugar or sugar derivative portion and at least one fatty chain; such compounds may, for example, result from the action of a fatty acid or a fatty acid derivative on the amine function of an amino sugar, or from the action of a fatty amine on a sugar comprising a carboxylic acid function (free or in lactone form) or carboxylic acid-derived function or alternatively a carbonyl function, and optionally in the presence of suitable co-reagents. Examples are N-substituted aldonamides polyhydroxylated fatty acid amides or mixtures thereof.

The N-substituted aldonamides are for example N-substituted lactobionamides, N-substituted maltobionamides, N-substituted cellobionamides, N-substituted mellibiona-mides and N-substituted gentiobionamides such as N-alkyllactobionamides, N-alkylmaltobionamides, N-alkylcellobionamides, N-alkylmellibionamides or N-alkylgentiobionamides which are mono- or disubstituted with a saturated or unsaturated, linear or branched, aliphatic hydrocarbon group which may contain heteroatoms preferably having up to 36 carbon atoms, more preferably up to 24 carbon atoms and still more particularly from 8 to 18 (for example methyl, ethyl, amyl, hexyl, heptyl, nonyl, decyl, undecyl, dodecyl, tridecyl, tetradecyl, pentadecyl, hexadecyl, heptadecyl, octadecyl; allyl, undecenyl, oleyl, linoleyl, propenyl, heptenyl), with an aromatic hydrocarbon group (for example benzyl, aniline, substituted benzyl, phenylethyl, phenoxyethyl, vinylbenzyl) or cycloaliphatic groups (for example cyclopentyl, cyclohexyl);
N-lactobionylamino acid esters where the amino acid may denote in particular: alanine, valine, glycine, lysine, leucine, arginine, aspartic acid, glutamic acid, threonine, serine, cysteine, histidine, tyrosine, methionine or which may be chosen, for example, from [beta]-alanine, sarcosine, gamma-aminobutyric acid, ornithine, citrulline or their equivalents; the said N-lactobionylamino acid esters being monosubstituted with a group of formula —(CH₂)ₙ—C(═O)—OR, where R is an aliphatic hydrocarbon group which may contain up to 36 carbon atoms and n is an integer greater than 1, as well as the corresponding N-maltobionylamino acid esters, the N-mellibionylamino acid esters, the N-cellobionylamino acid esters and the N-gentiobionylamino acid esters;
N-(alkyloxy)alkyllactobionamides which are mono- or disubstituted with a group —(CH₂)ₙ—OR′, where R′ is an aliphatic, aromatic or cycloaliphatic hydrocarbon group;
N-(polyalkyloxy)alkyllactobionamides,
N-(polyalkyloxy)alkylmaltobionamides,
N-(polyalkyloxy)alkylcellobionamides,
N-(polyalkyloxy)alkylmellibionamides or
N-(polyalkyloxy)alkylgentiobionamides which are mono- or disubstituted with a group —R′—(OR′)nR′R″ where R′ is an alkylene group such as ethylene, propylene or mixtures thereof, n is an integer greater than 1, R″ is a lactobionamide, maltobionamide, cellobionamide, mellibionamide or gentiobionamide group.

Examples for polyhydroxylated fatty amides are compounds of the formula

T-C(═O)—N(V)—W

where T denotes a C₅-C₃₁ hydrocarbon group, preferably a C₇-C₁₅ linear alkyl or alkenyl chain; V denotes hydrogen, a C₁-C₄ hydrocarbon radical, 2-hydroxyethyl, 2-hydroxypropyl or mixtures thereof, preferably a C₁-C₄ alkyl such as methyl, ethyl, propyl, isopropyl, N-butyl and more particularly methyl; and W denotes a polyhydroxy hydrocarbon-containing group having a linear hydrocarbon chain with at least 3 hydroxyl groups directly attached to the chain, or an alkoxylated derivative of the said group (preferably ethoxylated or propoxylated).

W is preferably a reducing sugar derivative obtained by reductive amination reaction and more preferably a glycityl group. Glucose, maltose, lactose, galactose, mannose and xylose may be mentioned among the reducing sugars. Preferably, W is chosen from the groups of the following formulae: —(CH₂)—(CHOH)ₙ—CH₂OH; —CH—(CH₂OH)—(CHOH)ₙ₋₁—CH₂OH; and —CH₂—(CHOH)₂(CHOR′) (CHOH)—CH₂OH, in which n is an integer ranging from 3 to 5, and R′ is hydrogen, a cyclic or aliphatic monosaccharide or one of its alkoxylated derivatives. A glycityl group in which n is 4, and in particular the group —(CH₂)—(CHOH)₄—CH₂OH, is preferred. The group T-C(═O)—N— may be for example cocamide, stearamide, oleamide, lauramide, myristiramide, capricamide, palmitamide, tallow amide.

Non-ionic surfactants of the amine oxide type are generally of the formula R^{a}R^{b}R^{c}N⁺—O—, where R^{a} is a long-chained alkyl group, e.g. C₁₀-C₁₃-alkyl, preferably C₁₂-C₁₆-alkyl, and R^{b} and R^{c} are short-chained alkyl or hydroxyalkyl groups, such as methyl, ethyl or 2-hydroxyethyl. A specific example is lauryldimethylamine oxide. Moreover, the long-chained alkyl group can be derived from native sources (oils or fats), resulting in mixtures of such amine oxides, for example N-cocoalkyl-N,N-dimethylamine oxide and N-tallowalkyl-N,N-dihydroxyethylamine oxide.

Amphoteric surfactants are, for example, derivatives of secondary or tertiary amines, for example C₆-C₁₈-alkyl betaines (e.g. cocoamidopropyl betaine; disodium cocoamphodiacetate (DSCADA)) or C₆-C₁₈-alkyl sulfobetaines, or amine oxides such as alkyl-dimethylamine oxides.

C₂-C₃-Alkanols [component (d)] are ethanol, n-propanol and isopropanol. Mixtures thereof are also suitable.

The organic solvents different from component (d) [component (e)] generally serve for providing a stable composition, especially if the composition is a concentrate containing high amounts of organic matter. Generally, the imidazolium polymers are soluble in most protic solvents and swellable in most aprotic polar solvents, whereas they are neither in most nonpolar solvents. Compounds (I) and (II) are also soluble in most protic and aprotic polar solvents and not soluble in most nonpolar solvents.

Suitable solvents are thus polar protic or polar aprotic. Examples for suitable solvents (e) are alkanols different from C₂-C₃-alkanols, such as n-butanol or tert-butanol; C₂-C₈-alkanediols; C₁-C₅-alkylmonoethers of C₂-C₈-alkanediols; diglycols, C₁—C-alkylmonoethers of diglycols, polyetherpolyols; C₁-C₅-alkylmonoethers of polyetherpolyols; amino alcohols, such as ethanolamine, diethanolamine and triethanolamine; cyclic ethers, e.g. tetrahydrofuran or 1,4-dioxane; ketones, such as acetone and methyl ethyl ketone; aliphatic esters, e.g. ethyl acetate; carboxamides, e.g. formamide, N,N-dimethylformamide (DMF) or N,N-dimethylacetamide; dimethyl sulfoxide (DMSO); acetonitrile; 5-, 6- or 7-membered cyclic carbonates which may be substituted by one or more C₁-C₁₂-alkyl groups; 5-, 6- or 7-membered lactones which may be substituted by one or more C₁-C₁₂-alkyl groups; and halogenated alkanes, e.g. dichloromethane, chloroform or dichloroethane.

C₂-C₈-Alkanediols are compounds HO-A-OH, where A is linear or branched C₂-C₈-alkanediyl (or C₂-C₈-alkylene), where the two OH groups are not geminally bound (i.e. are not bound to the same carbon atom). Examples are ethylene glycol (1,2-ethanediol), propylene glycol (1,2-propanediol), 1,3-propanediol, 1,2-butanediol, 1,4-butanediol, 1,2-pentanediol, 1,5-pentanediol, 1,2-hexanediol, 1,6-hexanediol, 1,2-heptanediol, 1,2-octanediol and the like.

C₁-C₈-Alkylmonoethers of C₂-C₈-alkanediols are compounds RO-A-OH, where A is as defined for the alkanediols above and R is C₁-C₈-alkyl. Examples are ethylene glycol monomethyl ether, ethylene glycol monoethyl ether, ethylene glycol mono-n-propyl ether, ethylene glycol monoisopropyl ether, ethylene glycol mono-n-butyl ether (butyl glycol), ethylene glycol mono-sec-butyl ether, ethylene glycol mono-isobutyl ether, ethylene glycol mono-tert-butyl ether, ethylene glycol monopentyl ether, ethylene glycol monohexyl ether, ethylene glycol monoheptyl ether, ethylene glycol monooctyl ether, propylene glycol monomethyl ether, propylene glycol monoethyl ether, propylene glycol mono-n-propyl ether, propylene glycol monoisopropyl ether, propylene glycol mono-n-butyl ether, propylene glycol mono-sec-butyl ether, propylene glycol mono-isobutyl ether, propylene glycol mono-tert-butyl ether, propylene glycol monopentyl ether, propylene glycol monohexyl ether, propylene glycol monoheptyl ether, propylene glycol monooctyl ether, 1,3-propanediol monomethyl ether, 1,3-propanediol monoethyl ether, 1,3-propanediol mono-n-propyl ether, 1,3-propanediol monoisopropyl ether, 1,3-propanediol mono-n-butyl ether, 1,3-propanediol mono-sec-butyl ether, 1,3-propanediol mono-isobutyl ether, 1,3-propanediol mono-tert-butyl ether, 1,3-propanediol monopentyl ether, 1,3-propanediol monohexyl ether, 1,3-propanediol monoheptyl ether, 1,3-propanediol monooctyl ether and the like.

Diglycols are compounds HO-A-O-A-OH, where A is linear or branched C₂-C₈-alkanediyl (or C₂-C₈-alkylene), generally C₂-C₃-alkanediyl. Examples are diethylene glycol (A=CH₂CH₂) and dipropylene glycol (A=CH(CH₃)CH₂ or CH₂CH(CH₃); mostly used in form of the isomeric mixture of the three isomers

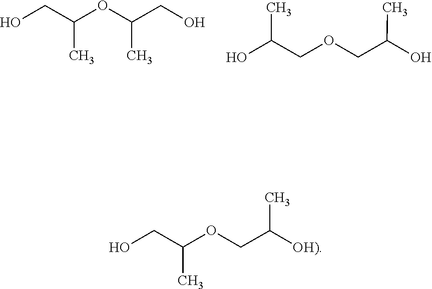

C₁-C₈-Alkylmonoethers of diglycols are compounds RO-A-O-A-OH, where A is as defined for the diglycols above and R is C₁-C₈-alkyl. Examples are diethyleneglycol monomethyl ether, diethyleneglycol monoethyl ether, diethyleneglycol mono-n-propyl ether, diethyleneglycol monoisopropyl ether, diethyleneglycol mono-n-butyl ether (butyldiglycol), diethylene glycol mono-sec-butyl ether, diethylene glycol mono-isobutyl ether, diethylene glycol mono-tert-butyl ether, diethylene glycol monopentyl ether, diethylene glycol monohexyl ether, diethylene glycol monoheptyl ether, diethylene glycol monooctyl ether, dipropylene glycol monomethyl ether, dipropylene glycol monoethyl ether, dipropylene glycol mono-n-propyl ether, dipropylene glycol monoisopropyl ether, dipropylene glycol mono-n-butyl ether, dipropylene glycol mono-sec-butyl ether, dipropylene glycol mono-isobutyl ether, dipropylene glycol mono-tert-butyl ether, dipropylene glycol monopentyl ether, dipropylene glycol monohexyl ether, dipropylene glycol monoheptyl ether, and dipropylene glycol monooctyl ether.

Polyetherpolyols are formally the etherification products of alkanediols and thus compounds HO-A-[O-A]ₙ—OH, where each A is independently an alkylene group, generally a C₂-C₃-alkylene group, such as 1,2-ethylene, 1,2-propylene or 1,3-propylene, and n is from 1 to 100. Examples are polyethylene glycol, generally with a molecular weight of from 106 to ca. 4500, and polypropyleneglycol, generally with a molecular weight of from 134 to ca. 6000.

C₁-C₈-Alkylmonoethers of polyetherpolyols are compounds RO-A-[O-A]ₙ—OH, where A and n are as defined for the polyetherpolyols above and R is C₁-C₈-alkyl. Examples are polyethylene glycol monomethyl ether, polyethylene glycol monoethyl ether, polyethylene glycol mono-n-propyl ether, polyethylene glycol mono-n-butyl ether, and the like.

Examples for 5-, 6- or 7-membered lactones which may be substituted by one or more C₁-C₁₂-alkyl groups are γ-butyrolactone, γ-valerolactone, γ-octalactone, γ-nonalactone, δ-valerolactone, δ-decanolactone, δ-dodecanolactone and ε-caprolactone which may carry one or more C₁-C₁₂-alkyl substituents.

Examples for 5-, 6- or 7-membered cyclic carbonates which may be substituted by one or more C₁-C₁₂-alkyl groups are ethylene carbonate, propylene carbonate and butylene carbonate which may carry one or more C₁-C₁₂-alkyl substituents.

Among the above solvents, preference is given to C₂-C₈-alkanediols and C₁-C₈-alkylmonoethers of C₂-C₈-alkanediols. More preference is given to C₂-C₄-alkanediols, in particular ethylene glycol and propylene glycol, C₁-C₄-alkylmonoethers of a C₂-C₃-alkanediol, such as the C₁-C₄-alkylmonoethers of ethylene glycol or propylene glycol, specific examples being ethylene glycol monomethyl ether, ethylene glycol monoethyl ether, ethylene glycol mono-n-propyl ether, ethylene glycol mono-n-butyl ether (also termed butylglyol), propylene glycol monomethyl ether, propylene glycol monoethyl ether, propylene glycol mono-n-propyl ether, and propylene glycol mono-n-butyl ether; and mixtures thereof.

Sequestrants [components (f)], also termed builders, structural substances, framework substances, complexing agents, chelators, chelating agents or softeners, bind alkaline earth metals and other water-soluble metal salts without precipitating. They help to break up soil, disperse soil components, help to detach soil and in some cases them-selves have a washing effect. Many of the sequestrants listed below are multi-functional, meaning that the substances have additional functions, such as a dispersing activity.

Suitable sequestrants may be either organic or inorganic in nature. Examples are aluminosilicates, carbonates, phosphates and polyphosphates, polycarboxylic acids, poly-carboxylates, hydroxycarboxylic acids, phosphonic acids, e.g. hydroxyalkylphosphonic acids, phosphonates, aminopolycarboxylic acids and salts thereof, and polymeric compounds containing carboxylic acid groups and salts thereof.

Suitable inorganic sequestrants are, for example, crystalline or amorphous aluminosilicates with ion-exchanging properties, such as zeolites. Crystalline silicates suitable as sequestrants are, for example, disilicates or sheet silicates, e.g. δ-Na₂Si₂O₅ or β-Na₂Si₂O₅(SKS 6 or SKS 7). Suitable inorganic sequestrant substances based on carbonate are carbonates and hydrogencarbonates. These can be used in the form of their alkali metal, alkaline earth metal or ammonium salts. Customary phosphates used as inorganic sequestrants are alkali metal orthophosphates and/or polyphosphates, for example pentasodium triphosphate.

Suitable organic sequestrants are, for example, C₄-C₃₀-di-, -tri- and -tetracarboxylic acids, for example succinic acid, propanetricarboxylic acid, butanetetracarboxylic acid, cyclopentanetetracarboxylic acid, and alkyl- and alkenylsuccinic acids with C₂-C₂₀-alkyl or -alkenyl radicals. Suitable organic sequestrants are also hydroxycarboxylic acids and polyhydroxycarboxylic acids (sugar acids). These include C₄-C₂₀-hydroxycarboxylic acids, for example malic acid, tartaric acid, glutonic acid, mucic acid, lactic acid, glutaric acid, citric acid, tartronic acid, glucoheptonic acid, lactobionic acid, and sucrose-mono-, -di- and -tricarboxylic acid. Among these, preference is given to citric acid and salts thereof. Another class are carboxylated fructans. Fructans are polymers of fructose molecules. They are built up of fructose residues, normally with a sucrose unit (i.e. a glucose-fructose disaccharide) at what would otherwise be the reducing terminus. The linkage of the fructose residues normally occurs at one of the two primary hydroxyls (OH-1 or OH-6). In inulin, the fructosyl residues are linked by β-2,1-linkages. In levan and phlein, the fructosyl residues are linked by β-2,6-linkages. The graminin type contains both β-2,1-linkages and β-2,6-linkages. Preferably, the carboxylated fructans are derived from inulin. Particular examples are carboxymethylinulin and carboxyethyl-inulin. Suitable carboxylated fructans are described in EP 3561032 A1 and WO 2010/106077.

Suitable organic sequestrants are also phosphonic acids, for example hydroxyalkylphosphonic acids or aminophosphonic acids, and the salts thereof. These include, for example, phosphonobutanetricarboxylic acid (2-phosphinobutane-1,2,4-tricarboxylic acid; PBTC), aminotris-methylenephosphonic acid (N[CH₂PO(OH)₂]3), aminotris(methylenephosphonate), sodium salt (ATMP; N[CH₂PO(ONa)₂]₃), ethylenediaminetetra(methylenephosphonic acid) (EDTMPA), hexamethylenediamine(tetramethylenephosphonic acid), hexamethylenediamine(tetramethylenephosphonate), potassium salt (C₁₀H₍₂₈₋ₓ₎N₂KₓO₁₂P₄ (x=6)), bis(hexamethylene)triamine(pentamethylene-phosphonic acid) ((HO₂)POCH₂N[(CH₂)₂N[CH₂PO(OH)₂]₂]₂), diethylenetriamine-penta-(methylenephosphonic acid) (DTPMP; (HO)₂POCH₂N[CH₂CH₂N[CH₂PO(OH)₂]₂]₂), diethylenetriaminepenta(methylenephosphonate), sodium salt (C₉H₍₂₈₋ₓ₎N₃NaₓO₁₅P₅ (x=7)); tetramethylene-triamine-pentaphosphonic acid, hydroxyethylamine diphosphonic acid, 2-hydroxyethyliminobis(methylenephosphonic acid) (HOCH₂CH₂N[CH₂PO(OH)₂]₂), morpholinomethanediphosphonic acid, 1-hydroxy-C₁-to C₁₀-alkyl-1,1-diphosphonic acids such as 1-hydroxyethane-1,1-diphosphonic acid (HEDP; CH₂C(OH)[PO(OH)₂]₂). Suitable organic sequestrants are moreover polyaspartic acids. Polyaspartic acid include salts of polyaspartic acids. Salt forming cations may be monovalent or multivalent, examples being sodium, potassium, magnesium, calcium, ammonium, and the ammonium salt of mono-, di- and triethanolamine. Such polymers may be co-polymers, in particular of (a) L- or D-aspartic acid (preferably L-aspartic acid), (b) a carboxylic acid and (c) a diamone or an amino alcohol. Such co-polymers generally comprise 70-95 mol % of (a), 5-30 mol % of (b) and 2-20 mol % of (c). The molar ratio of the carboxyl-containing compound (b) to the diamine or amino alcohol (c) is preferably between 5:1 and 1:1.5 or between 3:1 and 1:1.2, and more preferably between 3:1 and 1:1 or 2:1 and 1:1. Suitable organic sequestrants are additionally aminopolycarboxylic acids, such as nitrilotriacetic acid (NTA), nitrilomonoacetic dipropionic acid, nitrilotripropionic acid, β-alaninediacetic acid (β-ADA), ethylenediaminetetraacetic acid (EDTA), diethylenetriaminepentaacetic acid (DTPA), 1,3-propylenediaminetetraacetic acid, 1,2-propylenediaminetetraacetic acid, N-(alkyl)ethylenediaminetriacetic acid, N-(hydroxyalkyl)ethylenediaminetriacetic acid, ethylenediaminetriacetic acid, cyclohexylene-1,2-diaminetetraacetic acid, iminodisuccinic acid, ethylenediaminedisuccinic acid, serinediacetic acid, isoserinediacetic acid, L-asparaginediacetic acid, L-glutaminediacetic acid, methylglycinediacetic acid (MGDA), and the salts of the aforementioned aminopolycarboxylic acids. Suitable organic sequestrants are additionally polymeric compounds containing carboxylic acid groups, such as acrylic acid homopolymers. The term “acrylic acid homopolymer” also comprises polymers in which some or all of the carboxylic acid groups are present in neutralized form. Suitable polymeric compounds containing carboxylic acid groups are also oligomaleic acids. Suitable polymeric compounds containing carboxylic acid groups are also terpolymers of unsaturated C₄-C₈-dicarboxylic acids. Suitable unsaturated C₄-C₈-dicarboxylic acids in this context are, for example, maleic acid (or maleic anhydride), fumaric acid, itaconic acid, aconitic acid, mesaconic acid, methylenemalonic acid and citraconic acid. Suitable polymeric compounds containing carboxylic acid groups are also homopolymers of the monoethylenically unsaturated C₃-C₈-monocarboxylic acids, for example acrylic acid, methacrylic acid, crotonic acid, 2-ethylacrylic acid, 2-phenylacrylic acid, cinnamic acid, vinylacetic acid and sorbic acid, copolymers of dicarboxylic acids, for example of maleic acid and acrylic acid; terpolymers of maleic acid, acrylic acid and a vinyl ester of a C₁-C₃-carboxylic acid; and copolymers of maleic acid with C₂-C₈-olefins.

Further additives [component (g)] are for example pH adjusting agents (pH modifiers), thickeners, antifreezing agents, antifoaming agents, colorants, perfumes and other antimicrobial agents [i.e. different from components (a) and (b)].

Depending on the desired pH of the composition, pH adjusting agents (pH modifiers) are acids or bases. The pH can also be adjusted by buffering systems.

The acids can be inorganic or organic. Suitable inorganic acids are for example sulfuric acid, hydrochloric acid and phosphoric acid, where sulfuric acid is generally preferred.

Suitable organic acids are for example aliphatic, saturated non-substituted C₁-C₆-mono-, di- and tri-carboxylic acids such as formic acid, acetic acid, propanoic acid, oxalic acid, succinic acid, glutaric acid and adipic acid; aliphatic, saturated C₁-C₆-mono-, di- and tri-carboxylic acids carrying one or more OH groups, such as glycolic acid, lactic acid, tartric acid and citric acid; aliphatic, unsaturated C₁-C₆-mono-, di- and tri-carboxylic acids such as sorbic acid; aromatic carboxylic acids, such as benzoic acid, salicylic acid and mandelic acid; and sulfonic acids, such as methanesulfonic acid or toluenesulfonic acid. The organic acids mainly serve for adapting the pH of the composition, but some of them, e.g. the di- and tricarboxylic acids, can also act as sequestrants.

Suitable bases are in particular inorganic bases, such as the carbonates mentioned in context with the sequestrant, e.g. sodium or potassium carbonate; further ammonium carbonate, alkali metal and earth alkaline metal bicarbonates, such as sodium hydrogencarbonate or potassium hydrogencarbonate, alkali metal and earth alkaline metal hydroxides, such as NaOH or KOH, or ammonium hydroxide. Organic bases can also be used; examples are alkanolamines, such as monoethanolamine, triethanolamine or aminomethylpropanol, or guanidine derivatives, such as 1,1,3,3-tetramethylguanidine or triazabicyclodecene.

Suitable buffering agents are the typical systems, such as hydrogenphosphate/dihydrogenphosphate buffer, carbonate/hydrogencarbonate buffer, acetic acid/acetate buffer or Tris buffer. Moreover, most of the above acids which are weak and the anion of which is not a strong salt also have buffering capacity.

The thickeners serve to impart the desired viscosity to the composition of the invention.

Any known thickener (rheology modifier) is suitable in principle, provided that it does not exert any adverse effect on the efficacy of the composition. Suitable thickeners may either be of natural origin or of synthetic nature.

Thickeners of natural origin are mostly derived from polysaccharides. Examples are xanthan, gellan gum, carob flour, guar flour or gum, carrageenan, agar, tragacanth, gum arabic, alginates, modified starches such as hydroxyethyl starch, starch phosphate esters or starch acetates, dextrins, pectins and cellulose derivatives, such as carboxymethylcellulose, hydroxyethylcellulose, hydrophobically modified hydroxyethyl cellulose, hydroxypropylcellulose, hydroxypropylmethylcellulose, methylcellulose and the like. Further examples are bacterial cellulose, meaning any type of cellulose produced via fermentation of a bacteria of the genus Acetobacter such as CELLULON® (CPKelco U.S.) and including materials referred to as microfibrillated cellulose or reticulated bacterial cellulose; and non-bacterial cellulose, e.g. cellulosic fibers extracted from vegetables, fruits or wood, e.g. Avicel® from FMC, Citri-Fi from Fiberstar or Beta-fib from Cosun. Thickeners of natural origin are also inorganic thickeners, such as polysilicic acids and clay minerals, for example sheet silicates, and also the silicates mentioned for the builders.

Examples of synthetic thickeners are polyacrylic and polymethacrylic compounds, such as (partly) crosslinked homopolymers of acrylic acid, for example homopolymers of acrylic acid which have been crosslinked with an allyl ether of sucrose or pentaerythritol, or with propylene (carbomers), for example the Carbopol® brands from BF Goodrich (e.g. Carbopol® 676, 940, 941, 934 and the like) or the Polygel® brands from 3V Sigma (e.g. Polygel® DA), copolymers of ethylenically unsaturated mono- or dicarboxylic acids, for example terpolymers of acrylic acid, methacrylic acid or maleic acid with methyl acrylate or ethyl acrylate and a (meth)acrylate which derives from long-chain ethoxylated alcohols, for example the Acusol® brands from Rohm & Haas (e.g. Acusol® 820 or 1206A), copolymers of two or more monomers which are selected from acrylic acid, methacrylic acid and the C₁-C₄-alkyl esters thereof, for example copolymers of methacrylic acid, butyl acrylate and methyl methacrylate or of butyl acrylate and methyl methacrylate, for example the Aculyn® and Acusol® brands from Rohm & Haas (e.g. Aculyn® 22, 28 or 33 and Acusol® 810, 823 and 830), or crosslinked high molecular weight acrylic acid copolymers, for example copolymers of C₁₀-C₃₀-alkyl acrylates with one or more comonomers selected from acrylic acid, methacrylic acid and the C₁-C₄-alkyl esters thereof, said copolymers having been crosslinked with an allyl ether of sucrose or pentaerythritol (e.g. Carbopol® ETD 2623, Carbopol® 1382 or Carbopol® AQUA 30 from Rohm & Haas). Another preferred substance group is the Rheovis® brands from BASF, e.g. Rheovis® AT 120.

Examples for suitable antifreezing agents are ethylene glycol, propylene glycol, urea and glycerine.

Examples for suitable antifoaming agents are silicones, long-chain alcohols and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Fragrances can be of natural or synthetic origin; their nature is in general not critical.

Other antimicrobial agents [i.e. different from components (a) and (b)] are for example (alternative names in brackets; numbers: Chemical Abstracts Registry) chlorobenzene derivatives of the following formula

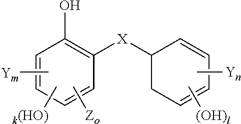

where X is O, S or CH₂, Y is Cl or Br, Z is SO₂H, NO₂ or C₁-C₄-alkyl, k, l and o are 0 or 1 and m and n are 0, 1, 2 or 3;
where the compound is preferably diclosan or triclosan;
(benzothiazol-2-ylthio)methyl thiocyanate (TCMTB) 21564-17-0; (benzyloxy)methanol 14548-60-8; (ethylenedioxy)dimethanol (reaction product of ethylene glycol with paraformaldehyde (EGForm)) 3586-55-8; α,α′,α″-trimethyl-1,3,5-triazine-1,3,5(2H,4H,6H)-triethanol (HPT) 25254-50-6; 1,2-benzisothiazol-3(2H)-one (BIT) 2634-33-5; 1,3-bis(hydroxymethyl)-5,5-dimethylimidazolidine-2,4-dione (DMDMH) 6440-58-0; 1-[2-(allyloxy)-2-(2,4-dichlorophenyl)ethyl]-1H-imidazole (imazalil) 35554-44-0; 1-[[2-(2,4-dichlorophenyl)-4-propyl-1,3-dioxolan-2-yl]methyl]-1H-1,2,4-triazole (propiconazole) 60207-90-1; 2,2-dibromo-2-cyanoacetamide (DBNPA) 10222-01-2; 2,2′,2″-(hexahydro-1,3,5-triazine-1,3,5-triyl)triethanol (HHT) 4719-04-4; 2,2′-dithiobis[N-methylbenzamide](DTBMA) 2527-58-4; 2-bromo-2-(bromomethyl)pentanedinitrile (DBDCB) 35691-65-7; 2-butanone, peroxide 1338-23-4; 2-butyl-benzo[d]isothiazol-3-one (BBIT) 4299-07-4; 2-methyl-2H-isothiazol-3-one (MIT) 2682-20-4; 2-octyl-2H-isothiazol-3-one (OIT) 26530-20-1; 2-phenoxyethanol 122-99-6; 2-thiazol-4-yl-1H-benzoimidazole (thiabendazole) 148-79-8; 3,3′-methylenebis[5-methyloxazolidine](oxazolidin/MBO) 66204-44-2; 3-(4-isopropylphenyl)-1,1-dimethylurea/Isoproturon 34123-59-6; 3-iodo-2-propynylbutylcarbamate (IPBC) 55406-53-6; 4,5-dichloro-2-octylisothiazol-3(2H)-one (4,5-dichloro-2-octyl-2H-isothiazol-3-one (DCOIT)) 64359-81-5; 5-chloro-2-(4-chlorphenoxy)phenol (DCPP) 3380-30-1; 6-(phthalimido)peroxyhexanoic acid (PAP) 128275-31-0; 7a-ethyldihydro-1H,3H,5H-oxazolo[3,4-c]oxazole (EDHO) 7747-35-5; acrolein 107-02-8; active chlorine: manufactured by the reaction of hypochlorous acid and sodium hypohlorite produced in situ; allyl isothiocyanate 57-06-7; amines, C10-16-alkyldimethyl, N-oxides 70592-80-2; amines, N-C12-C14 (even-numbered)-alkyl-trimethylenedi-, reaction products with chloroacetic acid (Ampholyt 20) 139734-65-9; ammonium bromide 12124-97-9; ammonium sulphate 7783-20-2; azoxystrobin 131860-33-8; benzoic acid 65-85-0; biphenyl-2-ol 90-43-7; bis(1-hydroxy-1H-pyridine-2-thionato-O,S)copper (Copper pyrithione) 14915-37-8; bromine chloride 13863-41-7; bromoacetic acid 79-08-3; bromochloro-5,5-dimethylimidazolidine-2,4-dione (BCDMH/bromochlorodimethylhydantoin) 32718-18-6; bronopol 52-51-7, calcium hydroxide (Ca dihydroxide/caustic lime/hydrated lime/slaked lime) 1305-62-0; calcium hypochlorite 7778-54-3; calcium magnesium oxide/dolomitic lime 37247-91-9; calcium magnesium tetrahydroxide (Ca Mg hydroxide/hydrated dolomitic lime) 39445-23-3; calcium oxide (lime/burnt lime/quicklime) 1305-78-8; carbendazim 10605-21-7; cetylpyridinium chloride 123-03-5; chloramin B 127-52-6; chlorine 7782-50-5; chlorine dioxide 10049-04-4; chlorocresol 59-50-7; cinnamaldehyde/3-phenyl-propen-2-al (cinnamic aldehyde) 104-55-2; cis-1-(3-chloroallyl)-3,5,7-triaza-1-azoniaadamantane chloride (cis CTAC) 51229-78-8; citric acid 77-92-9; clorophene (chlorophene) 120-32-1; copper 7440-50-8; copper sulphate pentahydrate 7758-99-8; copper thiocyanate 1111-67-7; cyanamide 420-04-2; D-gluconic acid, compound with N,N″-bis(4-chlorophenyl)-3,12-diimino-2,4,11,13-tetraazatetradecanediamidine(2:1) (CHDG) 18472-51-0; decanoic acid 334-48-5; dichloro-N-[(dimethylamino)sulphonyl]-fluoro-N-(ptolyl)methanesulphenamide (tolylfluanid) 731-27-1; dicopper oxide 1317-39-1; dimethyloctadecyl[3-(trimethoxysilyl)propyl]ammonium chloride 27668-52-6; dimethyltetradecyl[3-(trimethoxysilyl)propyl]ammonium chloride 41591-87-1; disodium peroxodisulphate/sodium persulphate 7775-27-1; diuron 330-54-1; dodecylguanidine monohydrochloride 13590-97-1; ethylene oxide 75-21-8; fludioxonil 131341-86-1; formaldehyde 50-00-0; formic acid 64-18-6; glutaral (glutaraldehyde) 111-30-8; glycolic acid 79-14-1; glyoxal 107-22-2; hexa-2,4-dienoic acid (sorbic acid) 110-44-1; hydrochloric acid; hydrogen peroxide 7722-84-1; iodine 7553-56-2; L-(+)-lactic acid 79-33-4; magnesium monoperoxyphthalate hexahydrate (MMPP) 84665-66-7; MBIT 2527-66-4; mecetronium ethyl sulphate (MES) 3006-10-8; medetomidine 86347-14-0; metam-sodium 137-42-8; methenamine 3-chloroallylochloride (CTAC) 4080-31-3; methylene dithiocyanate 6317-18-6; mixture of 5-chloro-2-methyl-2H-isothiazol-3-one (EINECS 247-500-7) and 2-methyl-2H-isothiazol-3-one (EINECS 220-239-6) (mixture of CMIT/MIT) 55965-84-9; monohydrochloride of polymer of N′,N′-1,6-hexanediylbis[N′-cyanoguanidine](EINECS 240-032-4) and hexamethylenediamine (EINECS 204-679-6)/polyhexamethylene biguanide (monomer:1,5-bis(trimethylen)-guanylguanidinium monohydrochloride) (PHMB) 27083-27-8; monolinuron 1746-81-2; N,N′-methylenebismorpholine (MBM) 5625-90-1; N-(3-aminopropyl)-N-dodecylpropane-1,3-diamine (diamine) 2372-82-9; N-(Dichlorofluoromethylthio)-N′,N′-dimethyl-N-phenylsulfamide (dichlofluanid) 1085-98-9; N-(trichloromethylthio)phthalimide (folpet) 133-07-3; nonanoic acid (pelargonic acid) 112-05-0; N′-tert-butyl-N-cyclopropyl-6-(methylthio)-1,3,5-triazine-2,4-diamine (cybutryne) 28159-98-0; octanoic acid 124-07-2; ozone 10028-15-6; p-[(diiodomethyl)sulphonyl]toluene 20018-09-1; pentapotassium bis(peroxymonosulphate) bis(sulphate) 70693-62-8; peracetic acid 79-21-0; peroxyoctanoic acid 33734-57-5; poly(oxy-1,2-ethanediyl),alpha-[2-(didecylmethylammonio)ethyl]-omega-hydroxy-, propanoate (salt) (Bardap 26) 94667-33-1; polymer of N-methylmethanamine (EINECS 204-697-4 with (chloromethyl) oxirane (EINECS 203-439-8)/polymeric quaternary ammonium chloride (PQ polymer) 25988-97-0; polyvinylpyrrolidone iodine 25655-41-8; potassium (E,E)-hexa-2,4-dienoate (potassium sorbate) 24634-61-5; potassium 2-biphenylate 13707-65-8; potassium dimethyldithiocarbamate 128-03-0; pyridine-2-thiol 1-oxide, sodium salt (sodium pyrithione) 3811-73-2; pyrithione zinc (zinc pyrithione) 13463-41-7; reaction mass of titanium dioxide and silver chloride; reaction products of 5,5-dimethylhydantoin, 5-ethyl-5-methylhydantoin with bromine and chlorine (DCDMH); reaction products of: glutamic acid and N—(C12-C14-alkyl)propylenediamine (glucoprotamin) 164907-72-6; salicylic acid 69-72-7; silver 7440-22-4; silver adsorbed on silicon dioxide; silver copper zeolite 130328-19-7; silver nitrate 7761-88-8; silver phosphate glass 308069-39-8; silver sodium hydrogen zirconium phosphate 265647-11-8; silver zeolite; silver zinc zeolite 130328-20-0; sodium 2-biphenylate 132-27-4; sodium bromide 7647-15-6; sodium dichloroisocyanurate dihydrate 51580-86-0; sodium dimethyldithiocarbamate 128-04-1; sodium hypochlorite 7681-52-9; sodium metabisulfite 7681-57-4; sodium N-(hydroxymethyl)glycinate 70161-44-3; sodium p-chloro-m-cresolate 15733-22-9; sulphur dioxide 7446-09-5; symclosene 87-90-1; tebuconazole 107534-96-3; terbutryn 886-50-0; tetrachlorodecaoxide complex (TCDO) 92047-76-2; tetrahydro-1,3,4,6-tetrakis(hydroxymethyl)imidazo[4,5-d]imidazole-2,5 (1H,3H)-dione (TMAD) 5395-50-6; tetrahydro-3,5-dimethyl-1,3,5-thiadia-zine-2-thione (dazomet) 533-74-4; tetrakis(hydroxymethyl)phosphonium sulphate (2:1) (THPS) 55566-30-8; thiram 137-26-8; tosylchloramide sodium (tosylchloramide sodium-chloramin T) 127-65-1; tralopyril 122454-29-9; triclosan 3380-34-5; troclosene sodium 2893-78-9; zineb 12122-67-7.

Also of importance are pyrithiones, dimethyldimethylol hydantoin, methylchloroisothiazolinone/methylisothiazolinone, sodium sulfite, sodium bisulfite, imidazolidinyl urea, diazolidinyl urea, benzyl alcohol, iodopropenyl butylcarbamate, chloroacetamide, methanamine, methyldibromonitrile, glutaronitrile (1,2-dibromo-2,4-dicyanobutane), 5-bromo-5-nitro-1,3-dioxane, phenethyl alcohol, o-phenylphenol/s, for example, commonly encountered compounds such as farnesol, perfumes, quaternary compounds, triclocarban, biguanides such as poly-(hexamethylene biguanide) hydrochloride, phenoxypropanol, and the like.

Another class of antibacterial agents, which can additionally be used, are the so-called “natural” antibacterial actives, referred to as natural essential oils.

Yet another class of antibacterial agents are antibacterial metal salts. This class generally includes salts of metals in groups 3b-7b, 8 and 3a-5a. Specifically are the salts of aluminum, zirconium, zinc, silver, gold, copper, lanthanum, tin, mercury, bismuth, selenium, strontium, scandium, yttrium, cerium, praseodymiun, neodymium, promethum, samarium, europium, gadolinium, terbium, dysprosium, holmium, erbium, thulium, ytterbium, lutetium and mixtures thereof.

In a preferred embodiment, the composition is a disinfectant or sanitizer concentrate, comprising
(a) 0.01 to 80% by weight, relative to the total weight of the composition, of the polymeric ionic compound comprising imidazolium groups;
(b) 0.1 to 80% by weight, relative to the total weight of the composition, of the antimicrobial agent (I) and/or (II);
(c) 0 to 20% by weight, relative to the total weight of the composition, of one or more surfactants;
(d) 0 to 20% by weight, relative to the total weight of the composition, of one or more C₂-C₃-alkanols;
(e) 0 to 20% by weight, relative to the total weight of the composition, of at least one organic solvent different from component (d);
(f) 0 to 20% by weight, relative to the total weight of the composition, of at least one sequestrant;
(g) 0 to 20% by weight, relative to the total weight of the composition, of at least one further additive; and
(h) 10 to 99.89% by weight, relative to the total weight of the composition, of water;
where components (a) to (h) add to 100% by weight.

Preferably, at least one of components (c) to (g) is present. More preferably, at least component (c) is present.

Alternatively or additionally, the overall weight ratio of the polymeric ionic compound comprising imidazolium groups (a) and the antimicrobial agent (b) is preferably in the range of from 1:1 to 1:50, more preferably from 1:1 to 1:30, even more preferably from 1:2 to 1:20.

More preferably, the composition is a disinfectant or sanitizer concentrate, comprising
(a) 1 to 30% by weight, relative to the total weight of the composition, of the polymeric ionic compound comprising imidazolium groups;
(b) 1 to 45% by weight, relative to the total weight of the composition, of the antimicrobial agent (1) and/or (II);
(c) 0 to 15% by weight, relative to the total weight of the composition, of one or more surfactants;
(d) 0 to 20% by weight, relative to the total weight of the composition, of one or more C₂-C₃-alkanols;
(e) 0 to 20% by weight, relative to the total weight of the composition, of at least one organic solvent different from component (d);
(f) 0 to 5% by weight, relative to the total weight of the composition, of at least one sequestrant;
(g) 0 to 20% by weight, relative to the total weight of the composition, of at least one further additive; and
(h) 10 to 98% by weight, relative to the total weight of the composition, of water; where components (a) to (h) add to 100% by weight.

Preferably, at least one of components (c) to (g) is present. More preferably, at least component (c) is present.

Alternatively or additionally, the overall weight ratio of the polymeric ionic compound comprising imidazolium groups (a) and the antimicrobial agent (b) is preferably in the range of from 1:1 to 1:50, more preferably from 1:1 to 1:30, even more preferably from 1:2 to 1:20.

Even more preferably, the composition is a disinfectant or sanitizer concentrate, comprising
(a) 2 to 20% by weight, relative to the total weight of the composition, of the polymeric ionic compound comprising imidazolium groups;
(b) 2 to 20% by weight, relative to the total weight of the composition, of the antimicrobial agent (1) and/or (II);
(c) 0 to 15% by weight, relative to the total weight of the composition, of one or more surfactants;
(d) 0 to 20% by weight, relative to the total weight of the composition, of one or more C₂-C₃-alkanols;
(e) 0 to 20% by weight, relative to the total weight of the composition, of at least one organic solvent different from component (d);
(f) 0 to 5% by weight, relative to the total weight of the composition, of at least one sequestrant;
(g) 0 to 20% by weight, relative to the total weight of the composition, of at least one further additive; and
(h) 10 to 96% by weight, relative to the total weight of the composition, of water;
where components (a) to (h) add to 100% by weight.

Preferably, at least one of components (c) to (g) is present. More preferably, at least component (c) is present.

Alternatively or additionally, the overall weight ratio of the polymeric ionic compound comprising imidazolium groups (a) and the antimicrobial agent (b) is preferably in the range of from 1:1 to 1:50, more preferably from 1:1 to 1:30, even more preferably from 1:2 to 1:20.

In particular, the composition is a disinfectant or sanitizer concentrate, comprising
(a) 2 to 10% by weight, relative to the total weight of the composition, of the polymeric ionic compound comprising imidazolium groups;
(b) 2 to 15% by weight, relative to the total weight of the composition, of the antimicrobial agent (1) and/or (II);
(c) 0 to 10% by weight, in particular 5 to 10% by weight, relative to the total weight of the composition, of one or more surfactants;
(d) 0 to 20% by weight, relative to the total weight of the composition, of one or more C₂-C₃-alkanols;
(e) 0 to 20% by weight, relative to the total weight of the composition, of at least one organic solvent different from component (d);
(f) 0 to 5% by weight, relative to the total weight of the composition, of at least one sequestrant;
(g) 0 to 20% by weight, relative to the total weight of the composition, of at least one further additive; and
(h) 10 to 96% by weight, relative to the total weight of the composition, of water;
where components (a) to (h) add to 100% by weight.

Preferably, at least one of components (c) to (g) is present. More preferably, at least component (c) is present

Alternatively or additionally, the overall weight ratio of the polymeric ionic compound comprising imidazolium groups (a) and the antimicrobial agent (b) is preferably in the range of from 1:1 to 1:50, more preferably from 1:1 to 1:30, even more preferably from 1:2 to 1:20.

In another preferred embodiment, the composition is a disinfectant or sanitizer ready-to-use composition, comprising
(a) 0.0001 (=1 ppm) to 7% by weight, relative to the total weight of the composition, of the polymeric ionic compound comprising imidazolium groups;
(b) 0.0001(=1 ppm) to 7% by weight, relative to the total weight of the composition, of the antimicrobial agent (I) and/or (II);
(c) 0 to 20% by weight, relative to the total weight of the composition, of one or more surfactants;
(d) 0 to 60% by weight, relative to the total weight of the composition, of at least one C₂-C₃-alkanol;
(e) 0 to 10% by weight, relative to the total weight of the composition, of at least one organic solvent different from component (d);
(f) 0 to 10% by weight, relative to the total weight of the composition, of at least one sequestrant;
(g) 0 to 10% by weight, relative to the total weight of the composition, of a further additive; and
(h) 10 to 99.9998% by weight, relative to the total weight of the composition, of water;
where components (a) to (h) add to 100% by weight.

Preferably, at least one of components (c) to (g) is present. More preferably, at least component (c) is present

Alternatively or additionally, the overall weight ratio of the polymeric ionic compound comprising imidazolium groups (a) and the antimicrobial agent (b) is preferably in the range of from 1:1 to 1:50, more preferably from 1:1 to 1:30, even more preferably from 1:2 to 1:20.

More preferably, the composition is a disinfectant or sanitizer ready-to-use composition, comprising
(a) 0.0001 (=1 ppm) to 5% by weight, relative to the total weight of the composition, of the polymeric ionic compound comprising imidazolium groups;
(b) 0.0001 (=1 ppm) to 5% by weight, relative to the total weight of the composition, of the antimicrobial agent (1) and/or (II);
(c) 0 to 5% by weight, relative to the total weight of the composition, of one or more surfactants;
(d) 0 to 60% by weight, relative to the total weight of the composition, of at least one C₂-C₃-alkanol;
(e) 0 to 5% by weight, relative to the total weight of the composition, of at least one organic solvent different from component (d);
(f) 0 to 5% by weight, relative to the total weight of the composition, of at least one sequestrant;
(g) 0 to 5% by weight, relative to the total weight of the composition, of a further additive; and
(h) ad 100% by weight, but at least 30% by weight relative to the total weight of the composition, of water.

Preferably, at least one of components (c) to (g) is present. More preferably, at least component (c) is present

Alternatively or additionally, the overall weight ratio of the polymeric ionic compound comprising imidazolium groups (a) and the antimicrobial agent (b) is preferably in the range of from 1:1 to 1:50, more preferably from 1:1 to 1:30, even more preferably from 1:2 to 1:20.

Even more preferably, the composition is a disinfectant or sanitizer ready-to-use composition, comprising
(a) 0.0001 (=1 ppm) to 1% by weight, relative to the total weight of the composition, of the polymeric ionic compound comprising imidazolium groups;
(b) 0.0005 (=5 ppm) to 5% by weight, relative to the total weight of the composition, of the antimicrobial agent (1) and/or (II);
(c) 0 to 5% by weight, relative to the total weight of the composition, of one or more surfactants;
(d) 0 to 10% by weight, relative to the total weight of the composition, of at least one C₂-C₃-alkanol;
(e) 0 to 5% by weight, relative to the total weight of the composition, of at least one organic solvent different from component (d);
(f) 0 to 5% by weight, relative to the total weight of the composition, of at least one sequestrant;
(g) 0 to 5% by weight, relative to the total weight of the composition, of a further additive; and
(h) ad 100% by weight, but at least 30% by weight, relative to the total weight of the composition, of water.

Preferably, at least one of components (c) to (g) is present. More preferably, at least component (c) is present

Alternatively or additionally, the overall weight ratio of the polymeric ionic compound comprising imidazolium groups (a) and the antimicrobial agent (b) is preferably in the range of from 1:1 to 1:50, more preferably from 1:1 to 1:30, even more preferably from 1:2 to 1:20.

In particular, the composition is a disinfectant or sanitizer ready-to-use composition, comprising
(a) 0.0001 (=1 ppm) to 0.1% by weight, relative to the total weight of the composition, of the polymeric ionic compound comprising imidazolium groups;
(b) 0.0005 (=5 ppm) to 0.5% by weight, relative to the total weight of the composition, of the antimicrobial agent (I) and/or (II);
(c) 0.005 (=50 ppm) to 5% by weight, relative to the total weight of the composition, of one or more surfactants;
(d) 0 to 5% by weight, relative to the total weight of the composition, of at least one C₂-C₃-alkanol;
(e) 0 to 5% by weight, relative to the total weight of the composition, of at least one organic solvent different from component (d);
(f) 0 to 2% by weight, relative to the total weight of the composition, of at least one sequestrant;
(g) 0 to 2% by weight, relative to the total weight of the composition, of a further additive; and
(h) ad 100% by weight, but at least 30% by weight, relative to the total weight of the composition, of water.

Preferably, at least one of components (c) to (g) is present. More preferably, at least component (c) is present

Alternatively or additionally, the overall weight ratio of the polymeric ionic compound comprising imidazolium groups (a) and the antimicrobial agent (b) is preferably in the range of from 1:1 to 1:50, more preferably from 1:1 to 1:30, even more preferably from 1:2 to 1:20.

Specifically, the composition is a disinfectant or sanitizer ready-to-use composition, comprising
(a) 1 to 20 ppm, relative to the total weight of the composition, of the polymeric ionic compound comprising imidazolium groups;
(b) 5 to 500 ppm, preferably 5 to 100 ppm, relative to the total weight of the composition, of the antimicrobial agent (1) and/or (II);
(c) 0.005 to 3% by weight, relative to the total weight of the composition, of one or more surfactants;
(d) 0 to 5% by weight, relative to the total weight of the composition, of at least one C₂-C₃-alkanol;
(e) 0 to 5% by weight, relative to the total weight of the composition, of at least one organic solvent different from component (d);
(f) 0 to 2% by weight, relative to the total weight of the composition, of at least one sequestrant;
(g) 0 to 2% by weight, relative to the total weight of the composition, of a further additive; and
(h) ad 100% by weight, but at least 30% by weight, relative to the total weight of the composition, of water.

Preferably, the overall weight ratio of the polymeric ionic compound comprising imidazolium groups (a) and the antimicrobial agent (b) is preferably in the range of from 1:1 to 1:50, more preferably from 1:1 to 1:30, even more preferably from 1:2 to 1:20.

More specifically, the composition is a disinfectant or sanitizer ready-to-use composition, comprising
(a) 1 to 10 ppm, relative to the total weight of the composition, of the polymeric ionic compound comprising imidazolium groups;
(b) 5 to 80 ppm, relative to the total weight of the composition, of the antimicrobial agent (1) and/or (II);
(c) 0.005 to 3% by weight, relative to the total weight of the composition, of one or more surfactants;
(d) 0 to 5% by weight, relative to the total weight of the composition, of at least one C₂-C₃-alkanol;
(e) 0 to 5% by weight, relative to the total weight of the composition, of at least one organic solvent different from component (d);
(f) 0 to 2% by weight, relative to the total weight of the composition, of at least one sequestrant;
(g) 0 to 2% by weight, relative to the total weight of the composition, of a further additive; and
(h) ad 100% by weight, but at least 30% by weight, relative to the total weight of the composition, of water.

Preferably, the overall weight ratio of the polymeric ionic compound comprising imidazolium groups (a) and the antimicrobial agent (b) is preferably in the range of from 1:1 to 1:50, more preferably from 1:1 to 1:30, even more preferably from 1:2 to 1:20.

In another specific embodiment, the composition is a disinfectant or sanitizer ready-to-use composition, comprising
(a) 1 to 20 ppm, relative to the total weight of the composition, of the polymeric ionic compound comprising imidazolium groups;
(b) 5 to 500 ppm, preferably 5 to 100 ppm, relative to the total weight of the composition, of the antimicrobial agent (I) and/or (II);
(c) 0 to 5% by weight, relative to the total weight of the composition, of one or more surfactants;
(d) 0 to 10% by weight, relative to the total weight of the composition, of at least one C₂-C₃-alkanol;
(e) 0 to 5% by weight, relative to the total weight of the composition, of at least one organic solvent different from component (d);
(f) 0 to 5% by weight, relative to the total weight of the composition, of at least one sequestrant;
(g) 0 to 5% by weight, relative to the total weight of the composition, of a further additive; and
(h) ad 100% by weight, but at least 30% by weight, relative to the total weight of the composition, of water.

Preferably, at least one of components (c) to (g) is present. More preferably, at least component (c) is present

Alternatively or additionally, the overall weight ratio of the polymeric ionic compound comprising imidazolium groups (a) and the antimicrobial agent (b) is preferably in the range of from 1:1 to 1:50, more preferably from 1:1 to 1:30, even more preferably from 1:2 to 1:20.

In another more specific embodiment, the composition is a disinfectant or sanitizer ready-to-use composition, comprising
(a) 1 to 10 ppm, relative to the total weight of the composition, of the polymeric ionic compound comprising imidazolium groups;
(b) 5 to 80 ppm, relative to the total weight of the composition, of the antimicrobial agent (I) and/or (II);
(c) 0 to 5% by weight, relative to the total weight of the composition, of one or more surfactants;
(d) 0 to 10% by weight, relative to the total weight of the composition, of at least one C₂-C₃-alkanol;
(e) 0 to 5% by weight, relative to the total weight of the composition, of at least one organic solvent different from component (d);
(f) 0 to 5% by weight, relative to the total weight of the composition, of at least one sequestrant;
(g) 0 to 5% by weight, relative to the total weight of the composition, of a further additive; and
(h) ad 100% by weight, but at least 30% by weight, relative to the total weight of the composition, of water.

Preferably, at least one of components (c) to (g) is present. More preferably, at least component (c) is present

Alternatively or additionally, the overall weight ratio of the polymeric ionic compound comprising imidazolium groups (a) and the antimicrobial agent (b) is preferably in the range of from 1:1 to 1:50, more preferably from 1:1 to 1:30, even more preferably from 1:2 to 1:20.

Specifically, the above-described specific and more specific disinfectant or sanitizer ready-to-use compositions comprise
(a) 0.0001 to 0.001% by weight (1 to 10 ppm), relative to the total weight of the composition, of a polymeric ionic compound comprising imidazolium groups obtainable by reacting
   i) glyoxal or a hemiacetal or acetal thereof;
   ii) formaldehyde;
   iii) an aliphatic diamine of the formula H₂N-A-NH₂, wherein A is C₂-C₈-alkylene; and
   iv) at least one protic acid;
   and optionally subjecting the reaction product to an anion exchange;
   where the protic acid is preferably selected from the group consisting of R—C(═O)OH, where R is hydrogen, C₁-C₁₀-alkyl or C₁-C₄-haloalkyl; sulfuric acid, hydrogensulfate salts, C₁-C₄-alkylsulfuric acid, nitric acid, phosphoric acid, dihydrogenphosphate salts, R—S(═O)₂OH, where R is C₁-C₈-alkyl, C₁-C₄-haloalkyl, phenyl or tolyl; HCl, H Br and HI; where the protic acid is more preferably R—C(═O)OH; and is specifically acetic acid;
(b) 0.0005 to 0.008% by weight (5 to 80 ppm), relative to the total weight of the composition, of an antimicrobial agent of the formula (I) as defined above, wherein R¹ is C₁₀-C₁₃-alkyl, R² is benzyl, R³ and R⁴ are methyl, and X^{p-} is chloride; or R¹ and R², independently of each other, are C₈-C₁₂-alkyl, R³ and R⁴ are methyl, and X^{p-} is a halide anion, preferably chloride;
where the polymeric ionic compound comprising imidazolium groups and the antimicrobial agent of the formula (I) are present in an overall weight ratio of from 1:1 to 1:30, preferably from 1:2 to 1:20.

More specifically, the above-described specific and more specific disinfectant or sanitizer ready-to-use compositions comprise
(a) 0.0001 to 0.001% by weight (1 to 10 ppm), relative to the total weight of the composition, of a polymeric ionic compound of the formula (III) as defined in claim 5, wherein A is —(CH₂)ₘ—, where m is 4 to 8, and specifically 6; E¹ is -A-NH₂ or -A-NH₃⁺(Y^{p-})_{1/p}, E² is hydrogen, -A-NH₂ or -A-NH₃⁺(Y^{p-})_{1/p}; Y^{p-} is a p-valent anion; p is 1, 2 or 3; and n is from 15 to 60;
(b) 0.0005 to 0.008% by weight (5 to 80 ppm), relative to the total weight of the composition, of an antimicrobial agent of the formula (I), wherein R¹ is C₁₀-C₁₈-alkyl, R² is benzyl, R³ and R⁴ are methyl, and X^{p-} is chloride; or R¹ and R², independently of each other, are C₈-C₁₂-alkyl, R³ and R⁴ are methyl, and X^{p-} is a halide anion, preferably chloride;
where the polymeric ionic compound comprising imidazolium groups and the antimicrobial agent of the formula (I) are used in an overall weight ratio of from 1:1 to 1:30, preferably from 1:2 to 1:20.

In another, more general specific embodiment, the composition is a ready-to-use aqueous composition comprising 1 to 10 ppm, relative to the total weight of the composition, of a polymeric ionic compound comprising imidazolium groups as defined above, and 5 to 80 ppm, relative to the total weight of the composition, of an antimicrobial agent of the formula (I) as defined above.

In another, more general specific embodiment, the composition is a ready-to-use aqueous composition comprising
(a) 0.0001 to 0.001% by weight (1 to 10 ppm), relative to the total weight of the composition, of a polymeric ionic compound comprising imidazolium groups obtainable by reacting
   i) glyoxal or a hemiacetal or acetal thereof;
   ii) formaldehyde;
   iii) an aliphatic diamine of the formula H₂N-A-NH₂, wherein A is C₂-C₈-alkylene; and
   iv) at least one protic acid;
   and optionally subjecting the reaction product to an anion exchange;
   where the protic acid is preferably selected from the group consisting of R—C(═O)OH, where R is hydrogen, C₁-C₁₀-alkyl or C₁-C₄-haloalkyl; sulfuric acid, hydrogensulfate salts, C₁-C₄-alkylsulfuric acid, nitric acid, phosphoric acid, dihydrogenphosphate salts, R—S(═O)₂OH, where R is C₁-C₈-alkyl, C₁-C₄-haloalkyl, phenyl or tolyl; HCl, H Br and HI; where the protic acid is more preferably R—C(═O)OH; and is specifically acetic acid; and
(b) 0.0005 to 0.008% by weight (5 to 80 ppm), relative to the total weight of the composition, of an antimicrobial agent of the formula (I) as defined above, wherein R¹ is C₁₀-C₁₃-alkyl, R² is benzyl, R³ and R⁴ are methyl, and X^{p-} is chloride; or R¹ and R², independently of each other, are C₈-C₁₂-alkyl, R³ and R⁴ are methyl, and X^{p-} is a halide anion, preferably chloride;
where the polymeric ionic compound comprising imidazolium groups and the antimicrobial agent of the formula (I) are present in an overall weight ratio of from 1:1 to 1:30, preferably from 1:2 to 1:20.

In another more general more specific embodiment, the composition is a ready-to-use aqueous composition comprising
(a) 0.0001 to 0.001% by weight (1 to 10 ppm), relative to the total weight of the composition, of a polymeric ionic compound of the formula (III) as defined in claim 5, wherein A is —(CH₂)ₘ—, where m is 4 to 8, and specifically 6; E¹ is -A-NH₂ or -A-NH₃⁺(Y^{p-})_{1/p}, E² is hydrogen, -A-NH₂ or -A-NH₃⁺(Y^{p-})_{1/p}; Y^{p-} is a p-valent anion; p is 1, 2 or 3; and n is from 15 to 60; and
(b) 0.0005 to 0.008% by weight (5 to 80 ppm), relative to the total weight of the composition, of an antimicrobial agent of the formula (I), wherein R¹ is C₁₀-C₁₈-alkyl, R² is benzyl, R³ and R⁴ are methyl, and X^{p-} is chloride; or R¹ and R², independently of each other, are C₈-C₁₂-alkyl, R³ and R⁴ are methyl, and X^{p-} is a halide anion, preferably chloride;
where the polymeric ionic compound comprising imidazolium groups and the antimicrobial agent of the formula (I) are used in an overall weight ratio of from 1:1 to 1:30, preferably from 1:2 to 1:20.

In ready-to-use compositions in which the combination of the imidazolium polymer and the compound of the formula (I) and/or (II) is to exert an antimicrobial effect, the imidazolium polymer and the compound of the formula (I) and/or (II) are of course contained in an antimicrobially-effective amount. This is an amount that is sufficient to reduce the cell population of an unwanted microorganism under a predetermined thresh-old value.

Thus, just by way of example, an “antimicrobially-effective amount” can be e.g. defined as an amount sufficient to reduce the cell population by, for example, at least one, preferably at least two, in particular at least three log orders of the at least one of following microorganisms: Salmonella enterica, Escherichia coli.

The composition of the invention has a pH of preferably from 2 to 11, more preferably from 4 to 10, and in particular from 4 to 9.

In the following, some exemplary formulations of the invention are listed to illustrate typical compositions.

Disclosed are in the following concentrated, water-dilutable formulations A1-BC2 (listed below table 1) for cleaning and/or disinfection of hard surfaces and tools/equipment in medical areas, in institutions, industry, in veterinary areas and on farms (also to treat and disinfect boots and claws or hoofs of animals), in the food & beverage industry and in (large) kitchens and canteens, in domestic settings and for outdoor hard surfaces. All formulations show good disinfection (killing) activity on microorganisms like gram+ and gram-bacteria, including mycobacteria, fungi, enveloped and non-enveloped viruses, bacterial spores, prions and algae. Killing of microorganisms is achieved within contact times typically between 10 sec and 120 min. The concentrated formulations are all stable and clear formulations. Also, upon dilution with water the formulations stay stable and clear and homogeneous. They have no unpleasant odour. The wetting and cleaning properties of all formulations are excellent. In table 1, the possible components of the concentrated formulations A1-BC2 are listed, each with the concentration range in which it is used in a given formulation.

TABLE 1

| Component | | | | Concentration |
|---|---|---|---|---|
| number | Component name | Function | CAS No. | [% by weight]* |
| 1 | Imidazolium polymer 1^{#} | Biocide | | 2-20 |
| 2 | N-Alkyl (C₈-C₁₈) | Biocide | 68391-01-5 | 2-15 |
| | dimethylbenzyl | | 68424-85-1 | |
| | ammonium chloride | | 85409-22-9 | |
| 3 | Didecyldimethylammonium | Biocide | 68424-95-3 | 2-15 |
| | chloride (DDAC (C₈-C₁₀)) | | | |
| 4 | D-gluconic acid, compound | Biocide | 18472-51-0 | 2-8 |
| | with N,N″-bis(4-chlorophenyl)- | | | |
| | 3,12-diimino-2,4,11,13- | | | |
| | tetraazatetradecanediamidine | | | |
| | (2:1) (CHDG) | | | |
| 5 | Glutaraldehyde | Biocide | | 5-20 |
| 6 | Glyoxal | Biocide | | 5-20 |
| 7 | Formaldehyde | Biocide | | 5-20 |
| 8 | Reaction products of glutam- | Biocide | 164907-72-6 | 1-20 |
| | ic acid and N-(C₁₂-C₁₄- | | | |
| | alkyl)propylenediamine | | | |
| | (Glucoprotamin) | | | |
| 9 | N-(3-aminopropyl)-N- | Biocide | 2372-82-9 | 1-20 |
| | dodecylpropane-1,3-diamine | | | |
| 10 | Amines, N-C₁₂-C₁₄(even | Biocide | 139734-65-9 | 1-20 |
| | numbered)- | | | |
| | alkyltrimethylenedi-, | | | |
| | reaction products with | | | |
| | chloroacetic acid | | | |
| | (Ampholyt 20) | | | |
| 11 | Bisphenyl-2-ol/Sodium 2- | Biocide | 90-43-7 | 2-15 |
| | biphenylate | | 132-27-4 | |
| 12 | Linear C₆-C₁₀ alcohol | Surfactant | | 1-15 |
| | ethoxylate | | | |
| 13 | Linear C₁₀-C₁₈ alcohol | Surfactant | | 1-15 |
| | ethoxylate | | | |
| 14 | Branched C₈-C₁₈ alcohol | Surfactant | | 1-15 |
| | ethoxylate | | | |
| 15 | C₈-C₁₀ alkylpolyglycoside | Surfactant | | 1-15 |
| 16 | C₁₂-C₁₄ alkylpolyglycoside | Surfactant | | 1-15 |
| 17 | Na₂CO₃ or K₂CO₃ | Alkali/pH | | 0.25-10 |
| | | regulator | | |
| 18 | Monoethanolamine | Alkali/pH | | 0.25-10 |
| | | regulator | | |
| 19 | Diethanolamine | Alkali/pH | | 0.25-10 |
| | | regulator | | |
| 20 | Triethaolamine | Alkali/pH | | 0.25-10 |
| | | regulator | | |
| 21 | Tetrahydroxypropylethylendiamine | Alkali/pH | | 0.25-10 |
| | | regulator | | |
| 22 | Phosphoric acid | Alkali/pH | | 0.2-5 |
| | | regulator | | |
| 23 | Sulphuric acid | Acid/pH | | 0.2-5 |
| | | regulator | | |
| 24 | Methane sulfonic acid | Acid/pH | | 0.2-5 |
| | | regulator | | |
| 25 | Any C₁-C₄ carboxylic acid, | Acid/pH | | 0.2-5 |
| | with 1-3 carboxyl groups and | regulator | | |
| | optionally substituted with | | | |
| | 1-3 hydroxyl groups | | | |
| 26 | Ethanol | Solvent/ | | 1-20 |
| | | biocide | | |
| 27 | Propan-1-ol | Solvent/ | | 1-20 |
| | | biocide | | |
| 28 | Propan-2-ol | Solvent/ | | 1-20 |
| | | Biocide | | |
| 29 | 2-Phenoxyethanol | Solvent/ | | 2-30 |
| | | Biocide | | |
| 30 | 2-Phenoxypropanol | Solvent | | 2-30 |
| 31 | Glycol | Solvent | | 1-20 |
| 32 | Propylenglycol | Solvent | | 1-20 |
| 33 | Butyldiglycol | Solvent | | 1-20 |
| 34 | 2-Butoxyethanol | Solvent | | 1-20 |
| 35 | Glycerol | Solvent | | 1-20 |
| 36 | Benzyl alcohol | Solvent | | 1-20 |
| 37 | n-Butanol | Solvent | | 1-20 |
| 38 | MGDA/Trilon M (acid or Na- | Chelating | | 0.1-3 |
| | salt) | agent | | |
| 39 | GLDA/Dissolvine GL (acid or | Chelating | | 0.1-3 |
| | NA-salt) | agent | | |
| 40 | EDTA (acid or Na-salt) | Chelating | | 0.1-5 |
| | | agent | | |
| 41 | Sodium Phosphates | Chelating | | 0.1-5 |
| | | agent | | |
| 42 | Phosphonate-type chelating | Chelating | | 0.1-5 |
| | agents (acid or Na-salt) | agent | | |
| 43 | NTA (Acid or Na-salt) | Chelating | | 0.1-5 |
| | | agent | | |
| 44 | Corrosion inhibitors | Corrosion | | 0.001-2 |
| | | inhibitor | | |
| 45 | Dyes/perfumes | Dyes/ | | 0.001-2 |
| | | perfumes | | |
| 46 | Monosodium-N-lauryl-B- | Surfactant | 14960-06-6 | 1-15 |
| | iminodipropionic acid | | | |
| 47 | Water | Solvent | | Up to 100% |

^{#}Imidazolium polymer 1 is obtainable by reacting glyoxal, formaldehyde, 1,6-diaminohexane and acetic acid in a molar ratio of 1:1:1:2 in water (resulting thus in a polymer of the formula (III), wherein A is —(CH₂)₆— and Y^{p-} is acetate); M_{w} = 42000 g/mol; Mₙ = 5950 g/mol; PDI = 7.1 (see example 1)
*Concentration range when used in a concentrated formulation; % by weight, relative to the total weight of the concentrated formulation

Following are examples for dilutable concentrated formulations composed of components according to Table 1:
A1: 1, 2, 12, 18, 28, 38, 44, 45, 47, pH=7-12 dilution rate 0.1%-10%*
A2: 1, 3, 12, 18, 28, 38, 44, 45, 47, pH=7-12 dilution rate 0.1%-10%
B1: 1, 2, 13, 18, 28, 38, 44, 45, 47, pH=7-12 dilution rate 0.1%-10%
B2: 1, 3, 13, 18, 28, 38, 44, 45, 47, pH=7-12 dilution rate 0.1%-10%
C1: 1, 2, 14, 18, 28, 38, 44, 45, 47, pH=7-12 dilution rate 0.1%-10%
C2: 1, 3, 14, 18, 28, 38, 44, 45, 47, pH=7-12 dilution rate 0.1%-10%
D1: 1, 2, 15, 18, 28, 38, 44, 45, 47, pH=7-12 dilution rate 0.1%-10%
D2: 1, 3, 15, 18, 28, 38, 44, 45, 47, pH=7-12 dilution rate 0.1%-10%
E1: 1, 2, 16, 18, 28, 38, 44, 45, 47, pH=7-12 dilution rate 0.1%-10%
E2: 1, 3, 16, 18, 28, 38, 44, 45, 47, pH=7-12 dilution rate 0.1%-10%
F1: 1, 2, 14, 17, 28, 38, 44, 45, 47, pH=7-12 dilution rate 0.1%-10%
F2: 1, 3, 14, 17, 28, 38, 44, 45, 47, pH=7-12 dilution rate 0.1%-10%
G1: 1, 2, 14, 18, 28, 38, 44, 45, 47, pH=7-12 dilution rate 0.1%-10%
G2: 1, 3, 14, 18, 28, 38, 44, 45, 47, pH=7-12 dilution rate 0.1%-10%
H1: 1, 2, 14, 19, 28, 38, 44, 45, 47, pH=7-12 dilution rate 0.1%-10%
H2: 1, 3, 14, 19, 28, 38, 44, 45, 47, pH=7-12 dilution rate 0.1%-10%
I1: 1, 2, 14, 20, 28, 38, 44, 45, 47, pH=7-12 dilution rate 0.1%-10%
I2: 1, 3, 14, 20, 28, 38, 44, 45, 47, pH=7-12 dilution rate 0.1%-10%
J1: 1, 2, 14, 21, 28, 38, 44, 45, 47, pH=7-12 dilution rate 0.1%-10%
J2: 1, 3, 14, 21, 28, 38, 44, 45, 47, pH=7-12 dilution rate 0.1%-10%
K1: 1, 2, 14, 20, 26, 38, 44, 45, 47, pH=7-12 dilution rate 0.1%-10%
K2: 1, 3, 14, 20, 26, 38, 44, 45, 47, pH=7-12 dilution rate 0.1%-10%
L1: 1, 2, 14, 20, 27, 38, 44, 45, 47, pH=7-12 dilution rate 0.1%-10%
L2: 1, 3, 14, 20, 27, 38, 44, 45, 47, pH=7-12 dilution rate 0.1%-10%
M1: 1, 2, 14, 20, 28, 38, 44, 45, 47, pH=7-12 dilution rate 0.1%-10%
M2: 1, 3, 14, 20, 28, 38, 44, 45, 47, pH=7-12 dilution rate 0.1%-10%
N1: 1, 2, 14, 20, 29, 38, 44, 45, 47, pH=7-12 dilution rate 0.1%-10%
N2: 1, 3, 14, 20, 29, 38, 44, 45, 47, pH=7-12 dilution rate 0.1%-10%
O1: 1, 2, 14, 20, 30, 38, 44, 45, 47, pH=7-12 dilution rate 0.1%-10%
O2: 1, 3, 14, 20, 30, 38, 44, 45, 47, pH=7-12 dilution rate 0.1%-10%
P1: 1, 2, 14, 20, 31, 38, 44, 45, 47, pH=7-12 dilution rate 0.1%-10%
P2: 1, 3, 14, 20, 31, 38, 44, 45, 47, pH=7-12 dilution rate 0.1%-10%
Q1: 1, 2, 14, 20, 32, 38, 44, 45, 47, pH=7-12 dilution rate 0.1%-10%
Q2: 1, 3, 14, 20, 32, 38, 44, 45, 47, pH=7-12 dilution rate 0.1%-10%
R1: 1, 2, 14, 20, 33, 38, 44, 45, 47, pH=7-12 dilution rate 0.1%-10%
R2: 1, 3, 14, 20, 33, 38, 44, 45, 47, pH=7-12 dilution rate 0.1%-10%
S1: 1, 2, 14, 20, 34, 38, 44, 45, 47, pH=7-12 dilution rate 0.1%-10%
S2: 1, 3, 14, 20, 34, 38, 44, 45, 47, pH=7-12 dilution rate 0.1%-10%
T1: 1, 2, 14, 20, 35, 38, 44, 45, 47, pH=7-12 dilution rate 0.1%-10%
T2: 1, 3, 14, 20, 35, 38, 44, 45, 47, pH=7-12 dilution rate 0.1%-10%
U1: 1, 2, 14, 20, 36, 38, 44, 45, 47, pH=7-12 dilution rate 0.1%-10%
U2: 1, 3, 14, 20, 36, 38, 44, 45, 47, pH=7-12 dilution rate 0.1%-10%
V1: 1, 2, 14, 20, 37, 38, 44, 45, 47, pH=7-12 dilution rate 0.1%-10%
V2: 1, 3, 14, 20, 37, 38, 44, 45, 47, pH=7-12 dilution rate 0.1%-10%
W1: 1, 2, 14, 20, 33, 38, 44, 45, 47, pH=7-12 dilution rate 0.1%-10%
W2: 1, 3, 14, 20, 33, 38, 44, 45, 47, pH=7-12 dilution rate 0.1%-10%
X1: 1, 2, 14, 20, 33, 39, 44, 45, 47, pH=7-12 dilution rate 0.1%-10%
X2: 1, 3, 14, 20, 33, 39, 44, 45, 47, pH=7-12 dilution rate 0.1%-10%
Y1: 1, 2, 14, 20, 33, 40, 44, 45, 47, pH=7-12 dilution rate 0.1%-10%
Y2: 1, 3, 14, 20, 33, 40, 44, 45, 47, pH=7-12 dilution rate 0.1%-10%
Z1: 1, 2, 14, 20, 33, 41, 44, 45, 47, pH=7-12 dilution rate 0.1%-10%
Z2: 1, 3, 14, 20, 33, 41, 44, 45, 47, pH=7-12 dilution rate 0.1%-10%
AA1: 1, 2, 14, 20, 33, 42, 44, 45, 47, pH=7-12 dilution rate 0.1%-10%
AA2: 1, 3, 14, 20, 33, 42, 44, 45, 47, pH=7-12 dilution rate 0.1%-10%
AB1: 1, 2, 14, 20, 33, 43, 44, 45, 47, pH=7-12 dilution rate 0.1%-10%
AB2: 1, 3, 14, 20, 33, 43, 44, 45, 47, pH=7-12 dilution rate 0.1%-10%
AC1: 1, 2, 14, 19, 33, 38, 44, 45, 47, pH=7-12 dilution rate 0.1%-10%
AD1: 1, 3, 14, 19, 33, 38, 44, 45, 47, pH=7-12 dilution rate 0.1%-10%
AE1: 1, 2, 4, 14, 19, 33, 38, 44, 45, 47, pH=7-12 dilution rate 0.1%-10%
AE2: 1, 3, 4, 14, 19, 33, 38, 44, 45, 47, pH=7-12 dilution rate 0.1%-10%
AF1: 1, 2, 8, 14, 19, 33, 38, 44, 45, 47, pH=7-12 dilution rate 0.1%-10%
AF2: 1, 3, 8, 14, 19, 33, 38, 44, 45, 47, pH=7-12 dilution rate 0.1%-10%
AG1: 1, 2, 9, 14, 19, 33, 38, 44, 45, 47, pH=7-12 dilution rate 0.1%-10%
AG2: 1, 3, 9, 14, 19, 33, 38, 44, 45, 47, pH=7-12 dilution rate 0.1%-10%
AH1: 1, 2, 10, 14, 19, 33, 38, 44, 45, 47, pH=7-12 dilution rate 0.1%-10%
AH2: 1, 3, 10, 14, 19, 33, 38, 44, 45, 47, pH=7-12 dilution rate 0.1%-10%
AI1: 1, 2, 11, 14, 19, 33, 38, 44, 45, 47, pH=7-12 dilution rate 0.1%-10%
AI2: 1, 3, 11, 14, 19, 33, 38, 44, 45, 47, pH=7-12 dilution rate 0.1%-10%
AJ1: 1, 2, 9, 29, 14, 19, 33, 38, 44, 45, 47, pH=7-12 dilution rate 0.1%-10%
AK2: 1, 3, 9, 29, 14, 19, 33, 38, 44, 45, 47, pH=7-12 dilution rate 0.1%-10%
AL1: 1, 2, 8, 9, 29, 14, 19, 33, 38, 44, 45, 47, pH=7-12 dilution rate 0.1%-10%
AL2: 1, 3, 8, 9, 29, 14, 19, 33, 38, 44, 45, 47, pH=7-12 dilution rate 0.1%-10%
AM1: 1, 2, 9, 29, 15, 19, 33, 38, 44, 45, 47, pH=7-12 dilution rate 0.1%-10%
AN1: 1, 3, 9, 29, 15, 19, 33, 38, 44, 45, 47, pH=7-12 dilution rate 0.1%-10%
AO1: 1, 2, 8, 9, 29, 16, 19, 33, 38, 44, 45, 47, pH=7-12 dilution rate 0.1%-10%
AO2: 1, 3, 8, 9, 29, 16, 19, 33, 38, 44, 45, 47, pH=7-12 dilution rate 0.1%-10%
AP1: 1, 2, 5, 6, 14, 22, 28, 38, 44, 45, 47, pH=1-6 dilution rate 0.1%-10%
AP2: 1, 3, 5, 6, 14, 22, 28, 38, 44, 45, 47, pH=1-6 dilution rate 0.1%-10%
AQ1: 1, 2, 5, 7, 14, 22, 28, 38, 44, 45, 47, pH=1-6 dilution rate 0.1%-10%
AQ2: 1, 3, 5, 7, 14, 22, 28, 38, 44, 45, 47, pH=1-6 dilution rate 0.1%-10%
AR1: 1, 2, 5, 14, 22, 28, 38, 44, 45, 47, pH=1-6 dilution rate 0.1%-10%
AR2: 1, 3, 5, 14, 22, 28, 38, 44, 45, 47, pH=1-6 dilution rate 0.1%-10%
AS1: 1, 2, 5, 6, 7, 14, 22, 28, 38, 44, 45, 47, pH=1-6 dilution rate 0.1%-10%
AS2: 1, 3, 5, 6, 7, 14, 22, 28, 38, 44, 45, 47, pH=1-6 dilution rate 0.1%-10%
AT1: 1, 2, 5, 6, 7, 14, 23, 28, 38, 44, 45, 47, pH=1-6 dilution rate 0.1%-10%
AT2: 1, 3, 5, 6, 7, 14, 23, 28, 38, 44, 45, 47, pH=1-6 dilution rate 0.1%-10%
AU1: 1, 2, 5, 6, 7, 14, 24, 28, 38, 44, 45, 47, pH=1-6 dilution rate 0.1%-10%
AU2: 1, 3, 5, 6, 7, 14, 24, 28, 38, 44, 45, 47, pH=1-6 dilution rate 0.1%-10%
AV1: 1, 2, 5, 6, 7, 14, 25, 28, 38, 44, 45, 47, pH=1-6 dilution rate 0.1%-10%
AV2: 1, 3, 5, 6, 7, 14, 25, 28, 38, 44, 45, 47, pH=1-6 dilution rate 0.1%-10%
AW1: 1, 2, 29, 12, 18, 33, 45, 47, pH=6-12 dilution rate 0.1%-10%
AW2: 1, 3, 29, 12, 18, 33, 45, 47, pH=6-12 dilution rate 0.1%-10%
AX1: 1, 2, 29, 13, 18, 33, 45, 47, pH=6-12 dilution rate 0.1%-10%
AX2: 1, 3, 29, 13, 18, 33, 45, 47, pH=6-12 dilution rate 0.1%-10%
AY1: 1, 2, 29, 14, 18, 33, 45, 47, pH=6-12 dilution rate 0.1%-10%
AY2: 1, 3, 29, 14, 18, 33, 45, 47, pH=6-12 dilution rate 0.1%-10%
AZ1: 1, 2, 29, 15, 18, 33, 45, 47, pH=6-12 dilution rate 0.1%-10%
AZ2: 1, 3, 29, 15, 18, 33, 45, 47, pH=6-12 dilution rate 0.1%-10%
BA1: 1, 2, 29, 16, 18, 33, 45, 47, pH=6-12 dilution rate 0.1%-10%
BA2: 1, 3, 29, 16, 18, 33, 45, 47, pH=6-12 dilution rate 0.1%-10%
BB1: 1, 2, 18, 28, 38, 44, 45, 46, 47, pH=7-12 dilution rate 0.1%-10%
BB2: 1, 3, 18, 28, 38, 44, 45, 46, 47, pH=7-12 dilution rate 0.1%-10%
BC1: 1, 2, 29, 18, 33, 45, 46, 47, pH=6-12 dilution rate 0.1%-10%
BC2: 1, 3, 29, 18, 33, 45, 46, 47, pH=6-12 dilution rate 0.1%-10%
* dilution rate 0.1%-10% means that before use the formulation is generally diluted with water in a ratio 1:10 to 1:1000.

All formulations A1 to BC2 are usually diluted at a rate of 0.1% up to 10% (i.e. dilution with water in a ratio 1:10 to 1:1000). The composition of the resulting solutions in dilution water can be calculated accordingly. Such diluted compositions (when diluted using deionized water) may also be used and marketed as ready-to-use disinfecting products. The latter can be applied as trigger sprays, aerosol sprays or wet wipes.

Formulations A1-a to BC2-a correspond to the above formulations A1 to BC2, where however instead of imidazolium polymer 1 an imidazolium polymer 2 is used in each case, which is a polymer obtainable by reacting 1 mol of glyoxal, 1 mol of formaldehyde, 1 mol of 1,6-diaminohexane and 2 mol of acetic acid in water (resulting thus in a polymer of the formula (III), wherein A is —(CH₂)₆— and Y^{p-} is acetate); M_{w}=14300; Mₙ=3620; PDI=4.0.

Formulations A1-b to BC2-b correspond to the above formulations A1 to BC2, where however instead of imidazolium polymer 1 an imidazolium polymer 3 is used in each case, which is a polymer obtainable by reacting 1 mol of glyoxal, 1 mol of formaldehyde, 1 mol of 1,6-diaminohexane and 2 mol of acetic acid in water (resulting thus in a polymer of the formula (III), wherein A is —(CH₂)₆— and Y^{p-} is acetate); M_{w}=28200; Mₙ=4910; PDI=5.7.

Formulations A1-c to BC2-c correspond to the above formulations A1 to BC2, where however instead of imidazolium polymer 1 an imidazolium polymer 4 is used in each case, which is a polymer obtainable by reacting 1 mol of glyoxal, 1 mol of formaldehyde, 1 mol of 1,6-diaminohexane and 2 mol of acetic acid in water (resulting thus in a polymer of the formula (III), wherein A is —(CH₂)₆— and Y^{p-} is acetate); M_{w}=43700; Mₙ=15700; PDI=2.8.

The following Table 2 compiles examples of dilutable concentrated disinfectant formulations (I-VIII). The Arabic numerals represent the concentrations in wt %, relative to the total weight of the composition; except for the penultimate line, where the Arabic numerals represent the pH.

TABLE 2

| Component name | I | II | III | IV | V | VI | VII | VIII |
|---|---|---|---|---|---|---|---|---|
| Imidazolium polymer 1 | 0.1 | 0.5 | 0.5 | 1 | 0.1 | 0.5 | 0.5 | 1 |
| N-Lauryl dimethylbenzyl | 1 | 1 | 10 | 10 | | | | |
| ammonium chloride | | | | | | | | |
| Didecyldimethylammonium | | | | | 1 | 1 | 10 | 10 |
| chloride (DDAC; C₈-C₁₀) | | | | | | | | |
| Lutensol XP 70 (C₁₀ | 2 | 5 | | | 3 | | | |
| Guerbet alcohol + 7EO) | | | | | | | | |
| Lutensol A7N (Linear | | | 5 | | | 10 | | |
| C₁₂-C₁₄ alcohol + 7EO) | | | | | | | | |
| Lutensol TO 10 (C₁₃ | | | | 5 | | | 5 | |
| oxo alcohol + 10 EO) | | | | | | | | |
| Cocoamidopropylbetaine | 1 | | | | | | | |
| Laurylamine oxide | | 0.5 | | | 1 | | | 10 |
| Sodiumcarbonate | 0.5 | 1 | | 3 | | | 2 | 1 |
| Monoethanolamine | | | 1 | | 0.5 | 2 | | |
| Propan-2-ol | | | 5 | | | | | 5 |
| Butyldiglycol | | | | 5 | | | 5 | |
| MGDA/Trilon M (active | 0.5 | | 1 | | | 0.2 | | 3 |
| Na3-salt) | | | | | | | | |
| EDTA (acid or active | | 0.2 | | 3 | 0.5 | | 1 | |
| Na4-salt) | | | | | | | | |
| Hydrochloric acid or | 8 | 10 | 9 | 11 | 8 | 11 | 11 | 9 |
| sodium hydroxide to | | | | | | | | |
| reach pH | | | | | | | | |
| Deionized water | Up to | Up to | Up to | Up to | Up to | Up to | Up to | Up to |
| | 100% | 100% | 100% | 100% | 100% | 100% | 100% | 100% |

A further series of examples for dilutable concentrated disinfectant formulations with numbers I-a to VIII-a is disclosed. They are prepared by using imidazolium polymer 2 instead of imidazolium polymer 1 in the same concentrations as shown in Table 2, and in the same order as in said table. All other components of Table 2, including their concentration, are unchanged.

A further series of examples for dilutable concentrated disinfectant formulations with numbers I-b to VIII-b is disclosed. They are prepared by using imidazolium polymer 3 instead of imidazolium polymer 1 in the same concentrations as shown in Table 2, and in the same order as in said table. All other components of Table 2, including their concentration, are unchanged.

A further series of examples for dilutable concentrated disinfectant formulations with numbers I-c to VIII-c is disclosed. They are prepared by using imidazolium polymer 4 instead of imidazolium polymer 1 in the same concentrations as shown in Table 2, and in the same order as in said table. All other components of Table 2, including their concentration, are unchanged.

The following Table 3 compiles examples of ready-to-use disinfectant formulations (IX-XVI) or disinfectant solutions prepared out of a dilutable concentrated product (exception: Formulation XVI, which cannot be prepared from a dilutable concentrate formulation). The Arabic numerals represent the concentrations in ppm (mg/kg) for the active substances imidazolium polymer and N-lauryl dimethylammonium chloride, and in wt %, relative to the total weight of the composition, for the others; except for the penultimate line, where the Arabic numerals represent the pH.

TABLE 3

| Component name | IX | X | XI | XII | XIII | XIV | XV | XVI |
|---|---|---|---|---|---|---|---|---|
| Imidazolium polymer 1 | 2.5 | 5 | 10 | 50 | 2.5 | 10 | 50 | 10 |
| N-Lauryl dimethylbenzyl | 25 | 50 | 100 | 500 | 25 | 100 | 100 | 100 |
| ammonium chloride | | | | | | | | |
| Lutensol XP 70 (C₁₀ | 0.5 | 1 | 0.5 | | 0.5 | | 1 | |
| Guerbet alcohol + 7EO) | | | | | | | | |
| Glucopon 215 UP | | | 0.5 | | | | | |
| (C₈-C₁₀ alkylpolyglycoside) | | | | | | | | |
| Cocoamidopropylbetaine | 0.5 | 0.5 | | | | | | |
| Laurylamine oxide | | | | 1 | 0.5 | 1 | | |
| Sodiumcarbonate | 0.5 | | 0.5 | | | | 0.5 | |
| Monoethanolamin | | 0.5 | | 0.5 | 0.5 | 0.5 | | |
| Propan-2-ol | | | | | | | | 30 |
| Ethanol | | | | | | | | 30 |
| MGDA/Trilon M (active | 0.25 | | 0.25 | | 0.25 | | 0.25 | |
| Na₃-salt) | | | | | | | | |
| EDTA (acid or active | | 0.25 | | 0.25 | | 0.25 | | |
| Na₄-salt) | | | | | | | | |
| Hydrochloric acid or | 10 | 11 | 10 | 9 | 10 | 9 | 11 | 8 |
| sodium hydroxide to | | | | | | | | |
| reach pH | | | | | | | | |
| Water | Up to | Up to | Up to | Up to | Up to | Up to | Up to | Up to |
| | 100% | 100% | 100% | 100% | 100% | 100% | 100% | 100% |

A further series of examples for ready-to-use formulations or disinfectant solutions with numbers IX-a to XVI-a made out of a dilutable concentrate is disclosed. They are prepared by using imidazolium polymer 2 instead of imidazolium polymer 1 in the same concentrations as shown in Table 3, and in the same order as in said table. All other components of Table 3, including their concentration, are unchanged.

A further series of examples for ready-to-use formulations or disinfectant solutions with numbers IX-b to XVI-b made out of a dilutable concentrate is disclosed. They are prepared by using imidazolium polymer 3 instead of imidazolium polymer 1 in the same concentrations as shown in Table 3, and in the same order as in said table. All other components of Table 3, including their concentration, are unchanged.

A further series of examples for ready-to-use formulations or disinfectant solutions with numbers IX-c to XVI-c made out of a dilutable concentrate is disclosed. They are prepared by using imidazolium polymer 4 instead of imidazolium polymer 1 in the same concentrations as shown in Table 3, and in the same order as in said table. All other components of Table 3, including their concentration, are unchanged.

A further series of examples for ready-to-use formulations or disinfectant solutions with numbers XVII to XX(IV made out of a dilutable concentrate is disclosed. They are prepared by using didecyldimethylammonium chloride (DDAC; C₈-C₁₀) instead of N-lauryl dimethylbenzyl ammonium chloride in the same concentrations as shown in Table 3, and in the same order as in said table. All other components of Table 3, including their concentration, are unchanged.

A further series of examples for ready-to-use formulations or disinfectant solutions with numbers XVII-a to XXIV-a made out of a dilutable concentrate is disclosed. They are prepared by using imidazolium polymer 2 instead of imidazolium polymer 1 and by using didecyldimethylammonium chloride (DDAC; C₈-C₁₀) instead of N-lauryl dimethylbenzyl ammonium chloride in the same concentrations, respectively, as shown in Table 3, and in the same order as in said table. All other components of Table 3, including their concentration, are unchanged.

A further series of examples for ready-to-use formulations or disinfectant solutions with numbers XVII-b to XXIV-b made out of a dilutable concentrate is disclosed. They are prepared by using imidazolium polymer 3 instead of imidazolium polymer 1 and by using didecyldimethylammonium chloride (DDAC; C₈-C₁₀) instead of N-lauryl dimethylbenzyl ammonium chloride in the same concentrations, respectively, as shown in Table 3, and in the same order as in said table. All other components of Table 3, including their concentration, are unchanged.

A further series of examples for ready-to-use formulations or disinfectant solutions with numbers XVII-c to XXIV-c made out of a dilutable concentrate is disclosed. They are prepared by using imidazolium polymer 4 instead of imidazolium polymer 1 and by using didecyldimethylammonium chloride (DDAC; C₈-C₁₀) instead of N-lauryl dimethylbenzyl ammonium chloride in the same concentrations, respectively, as shown in Table 3, and in the same order as in said table. All other components of Table 3, including their concentration, are unchanged.

The invention is now illustrated by the following examples.

### EXAMPLES

For biological activity testing, the following microorganisms were used:
Escherichia coli(E. coli DSM 682)
Salmonella enterica subsp. enterica (S enterica ATCC 10708)

Benzalkonium chloride (lauryl dimethyl benzyl ammonium chloride) was used as antimicrobial agent of the formula (I).

### 1. Preparation of the Imidazolium Polymer (Imidazolium Polymer 1)

5 mol of acetic acid (300.25 g) and 125 g of water were placed in a flask. A mixture of 2.5 mol of formaldehyde (75 g, as a 49% aq. solution) and 2.5 mol of glyoxal (145 g, as a 40% aq. solution) was added via a dropping funnel to the solution. In parallel, a mixture of 2.5 mol of 1,6-diaminohexane (290 g) in 62.5 g water was added to the solution via a separate dropping funnel. During addition of the monomers the reaction mixture was held at room temperature by ice bath cooling. Addition of both solutions was done over a period of 3 hours. After completion of the addition, the reaction mixture was heated to 100° C. for one further hour. The obtained polymer (which can be described as a polymer of the formula (III), wherein A is —(CH₂)₆— and Y^{p-} is acetate) has following properties:
M_{w} 42000 g/mol
Mₙ 5950 g/mol
PDI 7.1
pH 5.4
Species with less than 2,000 g/mol: 5.59% of total polymer

### 2. Bactericidal Activity of Combinations of Antimicrobial Agents (I) and Imidazolium Polymer

### 2.1 Evaluation of Bactericidal Activity of Combinations of Benzalkonium Chloride and Imidazolium Polymer in Cleaner/Disinfecting Formulations.

The imidazolium polymer of example 1 (imidazolium polymer 1) and benzalkonium chloride (BAC) were formulated into various dilutable concentrated hard-surface cleaners. The composition of the cleaners is given in the table below. The finished formulations were pre-dissolved 1:200 in standardized hard water (DIN EN 1276-2010) and then diluted to 80% by adding 1 ml of the inoculate and 1 ml of bovine albumin solution to 8 ml of the pre-dissolved cleaner, so that in-test a dilution of 1:250 was obtained. The concentrations in the final test formulations are also given in the following table. The amounts relate to active substance.

| | Cleaner | Concentration in- |
|---|---|---|
| | composition before | test after 1:250 |
| Ingredients | dilution [% w/w] | dilution [mg/L = ppm] |
| Lutensol ® XP 70 | 5 | 200 |
| Dehyton K | 0.75 | 30 |
| (Cocoamidopropylbetain, | | |
| 30% a.s.) | | |
| Sodium bicarbonate | 3 | 120 |
| Trilon ® BX powder (Na₄- | 0.15 | 6 |
| EDTA, 85% a.s.) | | |
| Imidazolium polymer | 0.0625 or 0.125 | 2.5 or 5 |
| Benzalkonium chloride | 0.5 or 1.0 | 20 or 40 |
| (“BAC”) | | |
| HCl/NaOH | Add to pH = 8.7 | (pH after |
| | | dilution = ca. 7-8) |
| Deionized water | add to 100 | |

Lutensol® XP 70 is a non-ionic surfactant (alcohol ethoxylate; C10-Guerbet alcohol+7 EO) from BASE.

Dehyton® K is an amphoteric surfactant (cocoamidopropylbetain) from BASE Benzalkonium chloride (BAC; lauryl dimethyl benzyl ammonium chloride) is available from various suppliers as 50% or 80% solutions, e.g. from Lonza as Barquat LB 50.

Antimicrobial testing of the above formulations in 1:250 dilution was done according to European Standard (DIN EN 1276-2010) under dirty conditions, i.e. additional soiling of 0.3% bovine albumin at 35° C. and 5 min contact time. Neutralization was done using the Saponin-containing neutralizer as described in DIN EN 1276 (30 g/l Polysorbate 80+30 g/l Saponin+3 g/l Lecithin). Results are documented in the table below as logarithmic reduction (Ig R) in comparison to the number of microorganisms used for the test.

| | | S. | E. |
|---|---|---|---|
| | | enterica | coli |
| | | [lg R] | [lg R] |
| 1 | BAC (40 ppm) | 0.5 | 2.7 |
| 2 | BAC (20 ppm) | n.d. | 0.5 |
| 3 | imidazolium polymer 1 (5 ppm) | 2.8 | 4.9 |
| 4 | imidazolium polymer 1 (2.5 ppm) | n.d. | 2.6 |
| 5 | BAC (40 ppm) + imidazolium polymer 1 (5 ppm) | 4.4 | n.d. |
| 6 | BAC (40 ppm) + imidazolium polymer 1 (2.5 ppm) | n.d. | 6.5 |
| 7 | BAC (20 ppm) + imidazolium polymer1 (5 ppm) | n.d. | 6.2 |
| 8 | BAC (20 ppm) + imidazolium polymer 1 (2.5 ppm) | n.d. | 3.5 |
| 9 | Reference (without BAC and imidazolium polymer) | 0 | 0 |

n.d. not determined

Surprisingly, the data show that for the test on S. enterica, the combination of 40 ppm BAC and 5 ppm imidazolium polymer (entry 5) gives a higher log reduction (Ig R=4.4) than expected based on the individual results for 40 ppm BAC (entry 1, Ig R=0.5) and 5 ppm imidazolium polymer (entry 3, Ig R=2.8), thus proving a synergistic bactericidal effect of the 2 substances.

Likewise, for the experiment on E. coli the combination of 20 ppm BAC and 5 ppm imidazolium polymer is synergistic as the performance of this combination (entry 7, Ig R=6.2) is higher than expected based on the individual performances of 20 ppm BAC (entry 2, Ig R=0.5) and 5 ppm imidazolium polymer (entry 3, Ig R=4.9).

Further, for the experiment on E. coli the combination of 40 ppm BAC and 2.5 ppm imidazolium polymer is synergistic as the performance of this combination (entry 6, Ig R=6.5) is higher than expected based on the individual performances of 40 ppm BAC (entry 1, Ig R=2.7) and 2.5 ppm imidazolium polymer (entry 4, Ig R=2.6).

Further, for the experiment on E. coli the combination of 20 ppm BAC and 2.5 ppm imidazolium polymer is synergistic as the performance of this combination (entry 8, Ig R=3.5) is higher than expected based on the individual performances of 20 ppm BAC (entry 2, Ig R=0.5) and 2.5 ppm imidazolium polymer (entry 4, Ig R=2.6).

### 2.2 Evaluation of Bactericidal Activity of Combinations of Didecyldimethylammonium Chloride and Imidazolium Polymer in Cleaner/Disinfecting Formulations.

The imidazolium polymer of example 1 (imidazolium polymer 1) and didecyldimethylammonium chloride (DDAC) were formulated into various dilutable concentrated hard-surface cleaners. The composition of the cleaners is given in the table below. The finished formulations were pre-dissolved 1:200 in standardized hard water (DIN EN 1276-2010) and then diluted to 80% by adding 1 ml of the inoculate and 1 ml of bovine albumin solution to 8 ml of the pre-dissolved cleaner, so that in-test a dilution of 1:250 was obtained. The concentrations in the final test formulations are also given in the following table. The amounts relate to active substance.

| | Cleaner | Concentration in- |
|---|---|---|
| | composition before | test after 1:250 |
| Ingredients | dilution [% w/w] | dilution [mg/L = ppm] |
| Lutensol ® XP 70 | 5 | 200 |
| Dehyton K | 0.75 | 30 |
| (Cocoamidopropylbetain, | | |
| 30% a.s.) | | |
| Sodium bicarbonate | 3 | 120 |
| Trilon ® BX powder (Na₄- | 0.15 | 6 |
| EDTA, 85% a.s.) | | |
| Imidazolium polymer | 0.0625 | 2.5 |
| Didecyldimethylammonium | 0.25 or 0.5 | 10 or 20 |
| chloride (“DDAC”) | | |
| HCl/NaOH | Add to pH = 8.7 | (pH after |
| | | dilution = ca. 7-8) |
| Deionized water | add to 100 | |

Lutensol® XP 70 is a non-ionic surfactant (alcohol ethoxylate; C10-Guerbet alcohol+7 EO) from BASE.

Dehyton® K is an amphoteric surfactant (cocoamidopropylbetain) from BASE Didecyldimethylammonium chloride (DDAC) is available from various suppliers, e.g. as Acticide DDQ 40 with 40% DDAC.

Antimicrobial testing of the above formulations in 1:250 dilution was done according to European Standard (DIN EN 1276-2010) under dirty conditions, i.e. additional soiling of 0.3% bovine albumin at 35° C. and 5 min contact time. Neutralization was done using the Saponin-containing neutralizer as described in DIN EN 1276 (30 g/l Polysorbate 80+30 g/I Saponin+3 g/I Lecithin). Results are documented in the table below as logarithmic reduction (Ig R) in comparison to the number of microorganisms used for the test.

| | | E. coli |
|---|---|---|
| | | [lg R] |
| 10 | DDAC (20 ppm) | 1.2 |
| 11 | DDAC (10 ppm) | 0.2 |
| 12 | imidazolium polymer 1 (2.5 ppm) | 2.6 |
| 13 | DDAC (20 ppm) + imidazolium polymer 1 (2.5 ppm) | >6.9 |
| 14 | DDAC (10 ppm) + imidazolium polymer 1 (2.5 ppm) | 3.8 |
| 15 | Reference (without DDAC and imidazolium polymer) | 0 |

Surprisingly, the data show that for the test on E. coli, the combination of 20 ppm DDAC and 2.5 ppm imidazolium polymer (entry 13) gives a higher log reduction (Ig R=>6.9) than expected based on the individual results for 20 ppm DDAC (entry 10, Ig R=1.2) and 2.5 ppm imidazolium polymer (entry 12, Ig R=2.6), thus proving a synergistic bactericidal effect of the 2 substances.

Likewise, for the experiment on E. coli the combination of 10 ppm DDAC and 2.5 ppm imidazolium polymer is synergistic as the performance of this combination (entry 14, Ig R=3.8) is higher than expected based on the individual performances of 10 ppm DDAC (entry 1, Ig R=0.2) and 2.5 ppm imidazolium polymer (entry 12, Ig R=2.6).

1. A method for enhancing antimicrobial activity of an antimicrobial agent, comprising:
employing, in combination, the antimicrobial agent and a polymeric ionic compound comprising imidazolium groups;
wherein:
the polymeric ionic compound is obtained by reacting;
i) at least one α-dicarbonyl compound;
ii) at least one aldehyde;
iii) at least one amino compound having at least two primary amino groups;
iv) at least one protic acid; and
v) optionally an amino compound having only one primary amino group; and
optionally subjecting the reaction product to an anion exchange;
in components i) and ii) aldehyde carbonyl groups may be present as hemiacetal or acetal and ketone carbonyl groups may be present as hemiketal or ketal;
the polymeric ionic compound comprises 4 to 150 imidazolium groups; and
the antimicrobial agent is a compound according to at least one of formula (I) or (II): 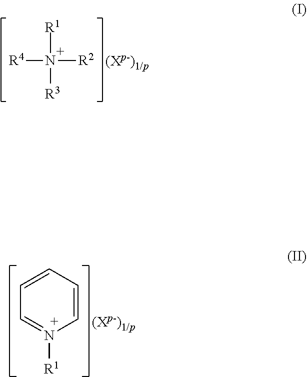
wherein:
R¹ is an aliphatic, aromatic or mixed aliphatic-aromatic radical with 6 to 26 carbon atoms, where the radical may be substituted by one or more halogen atoms, where the aliphatic radical and the aliphatic moiety in the mixed aliphatic-aromatic radical may be interrupted by one or more non-adjacent ether groups —O—, ester groups —C(═O)O— and/or amide groups —N(R⁵)—; and/or the aliphatic and the aromatic moiety in the mixed aliphatic-aromatic radical may be bound to each other via an ether group —O—, an ester group —C(═O)O— or an amide group —N(R⁵)—;
R², R³ and R⁴, independently of each other, are C₁-C₄-alkyl or independently have one of the meanings given above for R¹;
R⁵ is hydrogen or C₁-C₄-alkyl;
X^{p-} is a p-valent anion; and
p is 1, 2 or 3.

2. The method according to claim 1, wherein a mixture comprising the polymeric ionic compound and the antimicrobial agent are applied to combat microbes.

3. (canceled)

4. The method according to claim 1, wherein the amino compound having only one primary amino group v) is not reacted.

5. The method according to claim 1, wherein:
the polymeric ionic compound is obtained by reacting;
i) glyoxal or a hemiacetal or acetal thereof;
ii) formaldehyde;
iii) an aliphatic diamine of the formula H₂N-A-NH₂, wherein A is C₂-C₈-alkylene; and
iv) at least one protic acid;
and
optionally subjecting the reaction product to an anion exchange; and
the protic acid is selected from the group consisting of R—C(═O)OH, where R is hydrogen, C₁-C₁₀-alkyl or C₁-C₄-haloalkyl; sulfuric acid, a hydrogensulfate salt, a C₁-C₄-alkylsulfuric acid, nitric acid, phosphoric acid, a dihydrogenphosphate salt, R—S(═O)₂OH, where R is C₁-C₈-alkyl, C₁-C₄-haloalkyl, phenyl or tolyl; HCl, HBr and HI.

6. The method according to claim 5, wherein the polymeric ionic compound is a compound according to formula (III): 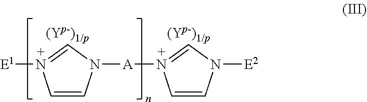
wherein:
A is C₂-C₈-alkylene;
E¹ is -A-NH₂ or -A-NH₃⁺(Y^{p-})_{1/p};
E² is hydrogen, -A-NH₂ or -A-NH₃⁺(Y^{p-})_{1/p};
Y^{p-} is a p-valent anion;
n is from 5 to 100; and
p is 1, 2 or 3.

7. The method according to claim 6, wherein one or both of conditions (i) and (ii) apply:
(i) A is —(CH₂)ₘ—, where m is 2 to 8;
(ii) Y^{p-} is selected from the group consisting of R—C(═O)O—, where R is hydrogen, C₁-C₁₀-alkyl or C₁-C₄-haloalkyl; hydrogensulfate, sulfate, C₁-C₄-alkylsulfate, nitrate, dihydrogenphosphate, hydrogenphosphate, phosphate, R—S(═O)₂O—, where R is C₁-C₈-alkyl, C₁-C₄-haloalkyl, phenyl or tolyl; Cl⁻, Br⁻ and I⁻.

8. The method according to claim 1, wherein in compounds (I) and (II):
R¹ is C₆-C₂₆-alkyl, phenyl-C₁-C₄-alkyl, phenyl substituted with a C₆-C₂₀-alkyl, C₆-C₂₀-haloalkyl, C₆-C₂₀-alkoxy or C₆-C₂₀-haloalkoxy group; benzyl substituted with a C₆-C₂₀-alkyl, C₆-C₂₀-haloalkyl, C₆-C₂₀-alkoxy or C₆-C₂₀-haloalkoxy group; octyl-phenyl-O—CH₂CH₂—O—CH₂CH₂—; or C₁₁H₂₃—C(═O)—O—CH₂CH₂—NH—C(═O)—CH₂—;
R² has independently one of the meanings given above for R¹;
R³ and R⁴, independently of each other, are C₁-C₄-alkyl; and
X^{p-} is a halide, sulfate or methosulfate anion.

9.-10. (canceled)

11. The method according to claim 1, wherein the polymeric ionic compound and the antimicrobial agent are used in an overall weight ratio of 100:1 to 1:100.

12. The method according to claim 11, wherein the polymeric ionic compound and the antimicrobial agent are used in an overall weight ratio of 1:1 to 1:30.

13. The method according to claim 5, wherein the antimicrobial agent is a compound according to formula (I) wherein;
R¹ is C₁₀-C₁₈-alkyl,
R² is benzyl,
R³ and R⁴ are methyl, and
X^{p-} is chloride;
or
R¹ and R², independently of each other, are C₅-C₁₂-alkyl,
R³ and R⁴ are methyl, and
X^{p-} is a halide anion.

14. The method according to claim 5, wherein:
the antimicrobial agent is a compound of the formula (I), wherein:
R¹ is C₁₀-C₁₈-alkyl,
R² is benzyl,
R³ and R⁴ are methyl, and
X^{p-} is chloride;
or
R¹ and R², independently of each other, are C₅-C₁₂-alkyl,
R³ and R⁴ are methyl, and
X^{p-} is a halide anion; and
the polymeric ionic compound and the antimicrobial agent are used in an overall weight ratio of 1:1 to 1:30.

15. The method according to claim 13, wherein the polymeric ionic compound is a compound according to formula (III): 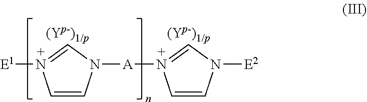
wherein;
A is —(CH₂)ₘ—, where m is 4 to 8;
E¹ is -A-NH₂ or -A-NH₃⁺(Y^{p-})_{1/p},
E² is hydrogen, -A-NH₂ or -A-NH₃⁺(Y^{p-})_{1/p};
Y^{p-} is a p-valent anion;
p is 1, 2 or 3; and
n is from 15 to 60.

16.-17. (canceled)

18. The method according to claim 1, comprising:
combining the antimicrobial agent and the polymeric ionic compound in a dilutable concentrate or ready-to-use composition for disinfecting or sanitizing hard or soft surfaces, spaces, areas, process water, human or animal skin or keratinous material, or an oral cavity of a human or animal.

19. A composition, comprising:
(a) a polymeric ionic compound comprising imidazolium groups, wherein:
the polymeric ionic compound is obtained by reacting:
i) at least one α-dicarbonyl compound;
ii) at least one aldehyde;
iii) at least one amino compound having at least two primary amino groups; and
iv) at least one protic acid; and
optionally subjecting the reaction product to an anion exchange; and
(b) an antimicrobial agent according to at least one of formula (I) or (II): 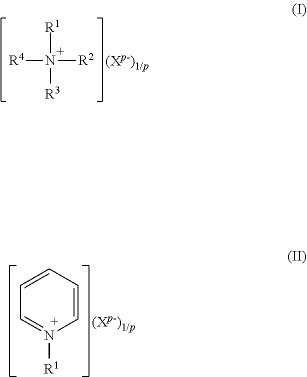
wherein
R¹ is an aliphatic, aromatic or mixed aliphatic-aromatic radical with 6 to 26 carbon atoms, where the radical may be substituted by one or more halogen atoms, where the aliphatic radical and the aliphatic moiety in the mixed aliphatic-aromatic radical may be interrupted by one or more non-adjacent ether groups —O—, ester groups —C(═O)O— and/or amide groups —N(R⁵)—; and/or the aliphatic and the aromatic moiety in the mixed aliphatic-aromatic radical may be bound to each other via an ether group —O—, an ester group —C(═O)O— or an amide group —N(R⁵)—;
R², R³ and R⁴, independently of each other, are C₁-C₄-alkyl or independently have one of the meanings given above for R′;
R⁵ is hydrogen or C₁-C₄-alkyl:
X^{p-} is a p-valent anion; and
p is 1, 2 or 3; and
an overall weight ratio of the polymeric ionic compound and the antimicrobial agent is 100:1 to 1:100.

20. The composition according to claim 19, where the overall weight ratio of the polymeric ionic compound and the antimicrobial agent is 1:1 to 1:30.

21. The composition according to claim 19, wherein:
(a) the polymeric ionic compound is obtained by reacting:
i) glyoxal or a hemiacetal or acetal thereof;
ii) formaldehyde;
iii) an aliphatic diamine of the formula H₂N-A-NH₂, wherein A is C₂-C₈-alkylene; and
iv) at least one protic acid; and
optionally subjecting the reaction product to an anion exchange; and
the protic acid is selected from the group consisting of R—C(═O)OH, where R is hydrogen, C₁-C₁₀-alkyl or C₁-C₄-haloalkyl; sulfuric acid, a hydrogensulfate salt, a C₁-C₄-alkylsulfuric acid, nitric acid, phosphoric acid, a dihydrogenphosphate salt, R—S(═O)₂OH, where R is C₁-C₈-alkyl, C₁-C₄-haloalkyl, phenyl or tolyl; HCl, HBr and HI; and
(b) the antimicrobial agent is a compound according to at least one of formula (I) or (II): 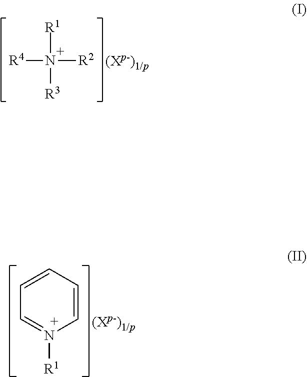
wherein;
R¹ is C₁₀-C18-alkyl,
R² is benzyl,
R³ and R⁴ are methyl, and
X^{p-} is chloride;
or
R¹ and R², independently of each other, are C₅-C₁₂-alkyl,
R³ and R⁴ are methyl, and
X^{p-} is a halide anion; and
the polymeric ionic compound and the antimicrobial agent are present in an overall weight ratio of 1:1 to 1:30.

22. The composition according to claim 19, which is a dilutable concentrate or ready-to-use composition for disinfecting or sanitizing hard or soft surfaces, spaces, areas, process water, human or animal skin or keratinous material, or an oral cavity of a human or animal.

23. (canceled)

24. The composition according to claim 22, comprising:
(a) 0.0001 to 90% by weight, relative to a total weight of the composition, of the polymeric ionic compound;
(b) 0.0001 to 90% by weight, relative to the total weight of the composition, of the antimicrobial agent;
(c) 0 to 60% by weight, relative to the total weight of the composition, of one or more surfactants;
(d) 0 to 99.9998% by weight, relative to the total weight of the composition, of at least one C₂-C₃-alkanol;
(e) 0 to 20% by weight, relative to the total weight of the composition, of at least one organic solvent different from component (d);
(f) 0 to 20% by weight, relative to the total weight of the composition, of at least one sequestrant;
(g) 0 to 50% by weight, relative to the total weight of the composition, of one or more further additives; and
(h) 0 to 99.9998% by weight, relative to the total weight of the composition, of water;
wherein:
components (a) to (h) add to 100% by weight; and
an overall weight ratio of the polymeric ionic compound to the antimicrobial agent is 1:1 to 1:50.

25. (canceled)

26. The composition according to claim 19, wherein
the polymeric ionic compound in present in an amount of 0.0001 to 0.002% by weight, relative to the total weight of the composition, and
the antimicrobial agent is present in an amount of 0.0005 to 0.05% by weight, relative to the total weight of the composition.

27. (canceled)

28. The composition according to claim 19, comprising
(a) 0.0001 to 0.001% by weight, relative to the total weight of the composition, of the polymeric ionic compound;
(b) 0.0005 to 0.008% by weight, relative to the total weight of the composition, of the antimicrobial agent of the formula (I), wherein:
R¹ is C₁₀-C₁₈-alkyl,
R² is benzyl,
R³ and R⁴ are methyl, and
X^{p-} is chloride;
or
R¹ and R², independently of each other, are C₈-C₁₂-alkyl,
R³ and R⁴ are methyl, and
X^{p-} is a halide anion;
wherein the polymeric ionic compound and the antimicrobial agent are present in an overall weight ratio of 1:1 to 1:30.

29. (canceled)
